(19) United States
(12) Patent Application Publication
(10) Pub. No.: US 2026/0161627 A1
(43) Pub. Date: Jun. 11, 2026

(54) KEY-SPACE DATA STORAGE AND RETRIEVAL

(71) Applicant: Starcounter AB, STOCKHOLM (SE)

(72) Inventors: Joachim Wester, Vaxholm (SE); Martin Törnwall, Uppsala (SE)

(73) Assignee: STARCOUNTER AB, STOCKHOLM (SE)

(21) Appl. No.: 19/408,867

(22) Filed: Dec. 4, 2025

Related U.S. Application Data
(60) Provisional application No. 63/727,961, filed on Dec. 4, 2024.

(51) Int. Cl. G06F 16/22; G06F 16/23

(52) U.S. Cl. CPC G06F 16/2264; G06F 16/2379

(57) ABSTRACT

One example method for key-space data storage and retrieval includes executing, by a computing system, a database engine, said database engine storing semantic propositions using hyperrectangles as its fundamental unit of data storage; storing, by said database engine, a set of stored hyperrectangles in a database memory, each of said stored hyperrectangles spanning at least two dimensions sharing a common coordinate domain; wherein each of said dimensions includes at least one symbolic component; and one quantitative component; receiving a plurality of data object property reads, each for an object value; processing said data object property reads, the processing includes determining, for each of said data object property reads, a first intersection between said stored hyperrectangles; and a set of at least one hyperrectangle obtained from said data object property read for an object value; and responding with object values each including the hyperrectangles from said first intersection corresponding to each of said data object property reads wherein a plurality of said data object property reads each reference an object that was included in one of said responses; receiving a plurality of numeric data object property reads, each for a numeric value; and responding to said numeric property reads with a response including a measure of at least one interval of intervals received in response to a data object property read.

### FIELD

The present disclosure describes a database device comprising a general-purpose database management system (DBMS) engine that addresses technical limitations of database devices and technologies such as relational, graph, object, key/value and constraint-based database engines, including limitations in performance, energy consumption and schema change resilience.

### SUMMARY

The present disclosure describes a general purpose database engine (e.g. for storing business data, like orders, supply-chain, customers, suppliers, organisations, people, transactions, ledgers, etc) that does not use discrete nodes, tuples or other discrete records as its fundamental building block. We call it a KEY-SPACE database engine.

We will start this summary by describing a preferred embodiment. This embodiment takes the notion of ranges, spaces, and intervals to the extreme and does away with discrete records like tuples or rows as the primary unit of storage. This embodiment makes no distinction between 5 tuples, and a field containing the number 5. In a key-space, they are all the same.

In a preferred embodiment there is only hyperrectangles, in the same there is only nodes and edges in a graph database, and only tables and rows in a relational database. Numeric fields are not stored in containers (as there are no containers), but are instead measures of hyperrectangles along one or more axes. Keys (both primary and foreign) are no longer discrete or atomic; they are set of intervals, and can overlap. There is no difference between fungible objects (like a hundred dollars) and non-fungible objects (such as 10 customer records). The set of primary keys is unbounded, as a given key can be recursively subdivided into subsets, or combined into supersets, or partially overlap with other keys. The use of hyperrectangles as the fundamental and only means of storing data makes the storage cost and processing time proportional to the heterogenity of the data, rather than the number of identified objects contained therein.

The table below shows an example of the kinds of data commonly found in business databases. When represented in the key-space paradigm, the numbers are measures of intervals, and strings are derived from interval endpoints.

Order for customer John Smith:

| Product | Quantity | Currency | Amount |
|---|---|---|---|
| Orange Soft Drink Can | 20 | USD | 48 |
| Bicycle | 1 | USD | 123 |

The number 20, 2.4 and 24 does not come from a member of a tuple/object/node/edge but is the measure of the foreign key of product and money, respectively. The effect of which that I can reference a single product, half a product (good for selling beer) and one of the dollar and paint its hyperrectangle with other overlapping hyperectangles to give rise to all values. Thus there are only only two fundamental constructs from which all properties, objects, fields and values arises, one is the hyper rectangles and the other is the measure to foreign keys (also hyperrectangles). No other vehicle of information is needed or even preferred. The lack if discrete objects and “fields” means that we can don't need to decide on normalisation or fight the granularity-dilemma. If you see a number, is a measure of a space and if you reference that space you have an “object” (the number of object is unbounded as there are no tuples, so a refence of half of the 48 dollars is as good as a reference to the customer).

Order for customer John Smith←interval

| Product | Quantity | Currency | Amount |
|---|---|---|---|
| Orange Soft | its measure → | USD ← | measure → |
| Drink Can ← | 20 | interval | 48 |
| interval | | | |
| Bicycle ← | its measure → | USD ← | measure → |
| interval | 1 | interval | 123 |

Not even “Orange Soft Drink Can”, “Bicycle” and “John” are “fields” from discrete records (tuples, nodes, rows, etc.)

The effect is maximum normalization (each cent of the dollar is “an object”) and faster databases. Reduced power consumption and increased performance.

### BRIEF DESCRIPTION OF THE DRAWINGS

These and other features, aspects, and advantages of the present invention are better understood when the following Detailed Description is read with reference to the accompanying drawings, wherein:

FIG. 1 shows a computing system comprising a plurality of devices;

FIG. 2 shows a computing system comprising a single device;

FIG. 3A-3F shows legacy discrete records vs key-space volumes;

FIG. 4 shows examples of spatial descriptors of key-spaces in various dimensionalities, each key-space having the shape of a k-interval;

FIG. 5 shows examples of 1 dimensional key-spaces;

FIG. 6 shows examples of well known set operators on spaces;

FIG. 7 shows an example of a statement in 3-space and how it relates to 1-spaces;

FIG. 8 shows a database with accumulated stored statements in 3-space;

FIG. 9 shows an example of a statement in 3-space to be used as a query;

FIG. 10 shows how a query statement intersects with the database;

FIG. 11 shows the result of the query performed on the database; and

FIG. 12 shows an example of computing intersections, differences and unions using intervals and other k-intervals.

FIG. 13 shows an example method for database management.

### BRIEF DESCRIPTION OF THE PROBLEM

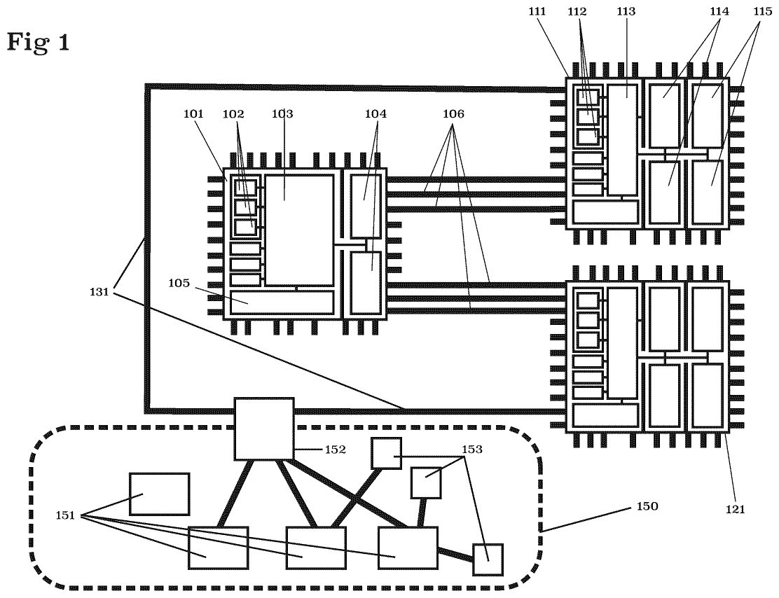

Referring now to FIG. 1 through 3.

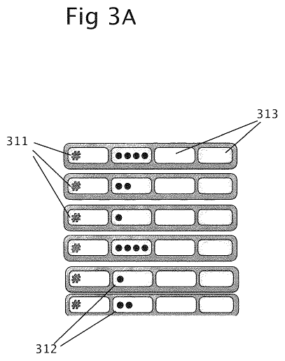

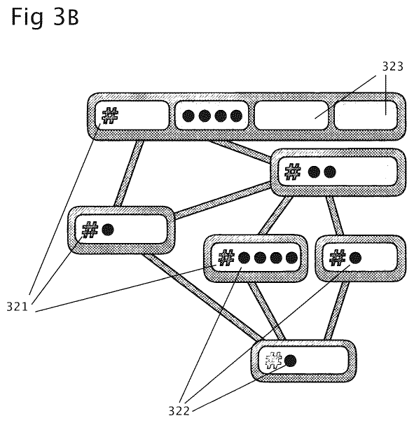

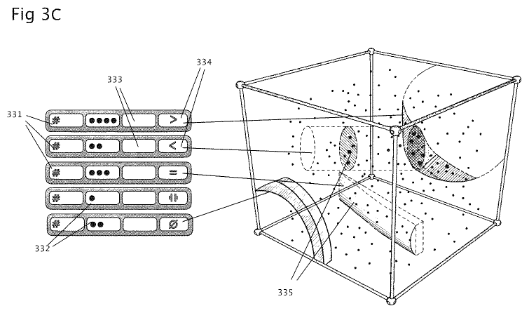

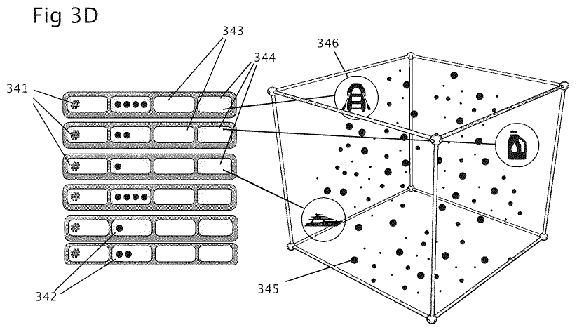

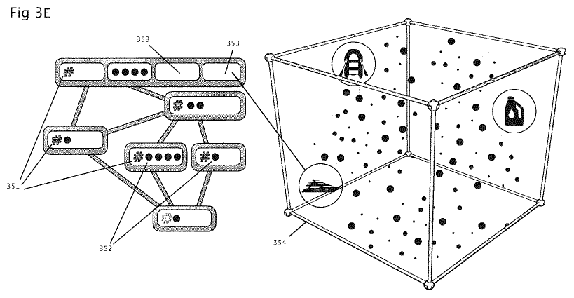

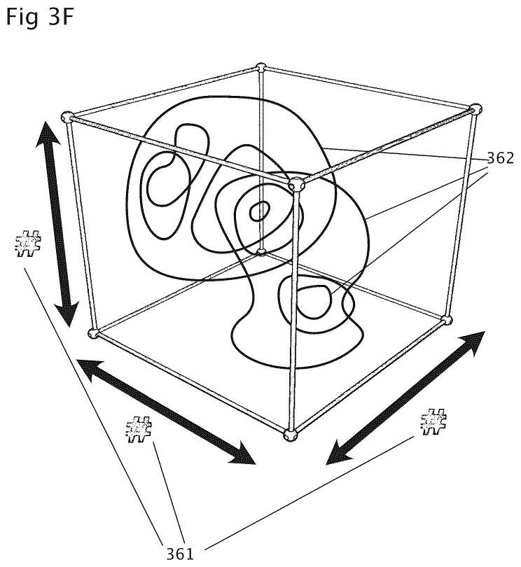

In many database devices and the services and methods they provide, properties such as values or constraints are assigned to keyed entities such as tuples, nodes, objects, records or other discrete keyed objects. Although the properties themselves can take the form of constraints, ranges, intervals or spaces, the entities they are associated with are typically treated as distinct and discrete, as illustrated by rows 311-316 and nodes 321-326 in FIG. 3.

Traditionally database engines require you to map your information to these constructs. To illustrate what problems might arise we can use a simple example. Let's assume that we manufacture or buy some products. We want to keep track of the weight and the owner of the products. Let's say we keep adding new types of products over time.

We start with submarines. We have manufactured five of them. In the database, our scheme would probably have been construed to store five entries (tuples, rows, objects, nodes), one for each submarine. The entries could be five rows in a table or five nodes in a graph, five entities in a constraint database or five entries in a value store. So, in this example, we use a relational database. We use five tuples/nodes. Each row has a numeric weight attribute or constraint and a reference to the owner by an edge, a foreign key or a constraint.

Later, we find that we will manufacture a lot of bearings. Our database schema will still work, not very efficiently as storing a million rows to represent a million bearings is not preferred. We previously had to make a choice of the value 5 being represented as a count of rows or a numeric value. This choice was not only influenced by ontology of submarines and physical weight, but also on the expected heterogeneity and non-fungibility of them and their likely quantities.

Now we introduce turbine oil. Given that we want it also to fit in our product database, we may no longer be able to rely on the earlier choice of “one row per physical item”. To represent 5½ liters of turbine oil we generally would not create “5½ rows”, so a common design choice is to add a numeric column to the product table and change any software assuming that a row represents one product instance. Under such a design, a single row might represent 5½ liters of turbine oil, with a numeric field indicating the quantity.

In designs of this kind, later changes that affect only part of the quantity may lead to further structural changes. For example, if ¼ liter of the turbine oil is sold to a new owner, one modelling approach is to replace the single row for 5½ liters with two rows whose numeric quantities sum to 5½, one row for the remaining oil and one for the transferred part. Any other rows or application logic that previously referenced the original row then need to decide which of the new rows to refer to, and repeated partial transfers may cause repeated splitting and merging of rows that all conceptually describe different portions of the same oil.

It is not that turbine oil, owners, or weights behave in an unusual way, but that the chosen representation ties ownership information to whole rows rather than to arbitrary portions of the quantity. When only a subset of the turbine oil changes owner, the schema and application code may therefore need to be adapted to keep track of which part of the original row each reference is meant to follow. What if I sell a quarter liter of turbine oil out of the 5½ liters? Now a subset of the oil has a different owner. This dilemma is a direct limitation of how we mapped products, owners and weights to tables, not a constraint we choose for products, owners and weights on a principle intrinsic to those concepts. Due to the inherent limitations of pen and paper based methods, we have to opt out of constraints with great effort rather than opt in on them.

While sold turbine oil maintains its weight over time, cats sold by a pet store do not. In some database paradigms we would have to map things very differently for the properties that we want to track over time, and the schema might have to accommodate this.

Referring now to FIGS. 3A, 3B, 3C and 3E. A foreign key 314 typically points to a row, an edge 324 points to a node, a reference points to an object, and a constraint is attached to an entity. In the turbine-oil example, however, what we wish to refer to is “some of that turbine oil” rather than an entire row. When a subset of the oil is sold, questions arise about how to point to or from just that subset. One possible response is to introduce additional tables, columns or mapping conventions and to migrate existing data about the submarines and bearings into this refined schema, so that different portions of the original oil quantity can be tracked separately.

The present disclosure further describes a database device comprising a general purpose database engine that can represent semantic data and queries as spaces (multi-dimensional regions) in a semantic coordinate system, improving database device performance and power efficiency. The present disclosure may in some embodiments replace all discrete records and all attributes contained in discrete records with a high dimensional datastore storing only spatial descriptors, representing a departure from the relational, object, graph, and constraint database paradigms, wherein nodes, tuples, records, and objects have distinct, discrete countable primary keys.

In one embodiment of a key-space DBMS, data objects are implemented as spatial descriptors forming references to subspaces of a semantic multi-dimensional partitioned space. Data object fields are in this embodiment resolved by the measures (lengths) of said subspaces or the spatial descriptor (e.g. the end-points of said subspaces), thus removing the need for discrete containers such as tuples, nodes or records and values or constraints as members of said discrete containers.

Vector databases and key-space databases, unlike relational, graph, object, constraint databases, may operate without discrete entities (i.e. records, tuples, nodes, objects etc.) and without storing attributes as fields or constraints attached to discrete containers or disjoint discrete keys. The benefits of both are representation invariance and flexibility.

### Database Device Shortcomings

Consider the following four examples of data represented in a database, each describing an exchange between two sets of objects:

Table Exchange 1 (student exchange: 1 student for 1 student)
Student_Exchange

| StudentA | StudentB |
|---|---|
| JOHN | MARY |

Table Objects

| Key | FirstName | LastName |
|---|---|---|
| JOHN | John | Smith |
| MARY | Mary | Svanson |

Table Exchange 2 (goods exchange: 40 phones for 1240.80 USD)
Store_Purchases

| Object | Qty | Currency | Amount |
|---|---|---|---|
| PHONE | 40 | USD | 1240.80 |

Table Products

| Key | Name |
|---|---|
| PHONE | Mobile Phone |

Table Exchange 3 (1 non-fungible house for 10 million USD)
House_Exchanges

| House | Currency | Amount |
|---|---|---|
| WMANOR | USD | 10,000,000 |

Table Houses

| House | Street | City |
|---|---|---|
| WMANOR | Wayne Manor 1007 Mountain Drive | Gotham |

Table Exchange 4 (2.1 dollars for 19.4 kronor)
Currency_Exchange

| Currency1 | Amount1 | Currency2 | Amount2 |
|---|---|---|---|
| USD | 2.1 | SEK | 19.4 |

If these propositions were represented in a neural network, all four examples could be embedded into a single model, and an AI agent could answer the question “What got exchanged for what?” across them. Vector databases, backed by such models, therefore excel at keeping combinatorial regularities invariant across very different surface representations. The four exchange tables above, despite their different column structures, can all be mapped into a single feature space where “what got exchanged for what” is a stable question.

A combinatorial type system in this context means that higher-level concepts such as “exchange”, “party”, “amount” and “instrument” are assembled from more primitive building blocks, and that a single row in a structured database may simultaneously be an instance of several such types. For example, the row “Soft Drink 2 USD 123.45” is at the same time an instance of a purchase, a transfer of inventory, an obligation to pay, and an exchange between two parties. The soft drink is both a product and a liquid. In a vector database these combinatorial types show up as shared directions and neighborhoods in embedding space: statements that all share the trait of being an exchange get mapped to a region of vectors whose relative positions encode how the roles (who, what, how much, in which currency) combine.

What is missing is a way to normalize quantitative entities (such as “how many phones” or “how many dollars”) for precise, high-performance queries over billions of exchanges, without losing this invariance when requirements change (as illustrated by the exchange use cases). Structured features may remain necessary for precise, non-approximate queries.

The choice of how to represent these propositions in a structured way—using tuples, graphs, object databases or constraint databases—has more to do with expectations about homogeneity, fungibility and efficiency than with pure ontology. A generalized schema might look as follows:

Table Exchanges

| Object1 | Quantity1 | Object2 | Quantity2 |
|---|---|---|---|
| JOHN | 1 | MARY | 1 |
| WMANOR | 1 | USD | 10,000,000 |
| USD | 2.1 | SEK | 19.4 |
| PHONE | 40 | USD | 1240.80 |

Table Objects

| Key | Name |
|---|---|
| WMANOR | Wayne Manor 1007 Mountain Drive |
| JOHN | John Smith |
| MARY | Mary Svanson |
| PHONE | Mobile Phone |
| USD | US dollar |
| SEK | Swedish krona |

This schema already assumes, in advance, what granularity to use for each object: individual students, a specific house, a product type (“PHONE”), and currencies (“USD”, “SEK”). That assumption would have to hold across all future use cases to keep the representation invariant. But even that is not enough.

Consider properties that stop being homogeneous at a later time. Suppose we sell 1 of the 40 mobile phones, and that phone later gets its own serial number or owner. The original node or tuple representing “40 phones” is already referenced; to introduce the new heterogeneity we must split that reference into two, causing a cascade of side effects in the schema and in any software that depends on it. Or consider propositions about ontological concepts that can be formulated in an invariant latent model: for example, “Mary used to have the name Anne”. The underlying concept “Mary” remains the same, but structured schemas must decide which row, which version and which key represent her at which time.

The moral is that structured schemas are brittle: they are primarily about how to represent concepts in an ontology, rather than about what concepts there are in the ontology. To some degree this brittleness reflects a trade-off between the efficiency that comes with a simplistic view of propositions and the flexibility or invariance that comes with a more expressive paradigm. A SQL database or a spreadsheet can answer queries very quickly when data is aligned, but it sacrifices invariant representation of commonalities across use cases.

As AI agents become increasingly capable of generating computer programs, an ever-growing number of use-case-specific data models are being created, and those same agents are increasingly asked to answer questions spanning multiple data sets. The methods employed by technologies such as relational databases, object databases, key-value stores and constraint databases will typically represent “1 student”, “40 phones” and “2.1 USD” in different ways. Queries must therefore be federated across multiple representations with disjoint indices (such as B-trees, R-trees and other index structures), because the representations of both sides of the exchange are neither symmetric nor invariant across the above cases.

In some embodiments, a DBMS according to this disclosure is implemented as a Key-space Database (KSDB) that stores and manipulates information as regions in a continuous semantic space rather than as discrete records with primary keys. The disclosed techniques may reduce energy consumption, increase performance and provide schema change resilience with respect to changing application use cases.

In contrast to relational, graph and constraint databases that attach values or constraints to discrete records with keys, this disclosure describes database engines that store facts as multi-dimensional space descriptors of regions (“chunks”) of continuous semantic space. In lower-dimensional projections these regions form keys; in higher-dimensional projections they represent relationships. Quantitative properties such as “how many” or “how much” are obtained by measuring the extent of the space rather than by reading numeric attributes on a fixed record.

A KSDB may in one embodiment store all facts and propositions as a single global key-space unifying quantities, identifiers, and relationships.

An object-relational mapping framework and its associated database engine typically let programming-language objects keep primary keys and resolve property access by reading a value in a tuple or column store in association with said primary key.

An object-to-graph mapping framework typically lets programming-language objects keep node references and resolve property access as edges between two nodes, where numeric values are stored directly as attributes on said edge or on one of said nodes.

A KSDB may in one embodiment replace an object-relational mapping framework and its associated database engine with an object-key-space mapping framework where programming-language objects keep a spatial descriptor of a low-dimensional projection of a global key-space, property access is resolved using high-dimensional projections of said key-space, numeric property access is resolved by measuring distance in lower-dimensional projections of said key-space, and non-numeric value property access is resolved by converting a spatial descriptor of a low-dimensional projection to a value.

A KSDB may, using the above method, replace an object-to-graph mapping framework and its associated database.

A KSDB may in one embodiment use a global space where subject, predicate, object and time make up the axes of said global space, wherein the coordinate system comprises both a partitioning and a numeric component where all quantities are measures of distances in said coordinate system and no data object properties are direct members of records, nodes, edges or tuples, and object keys are regions in said space where keys are supersets or subsets of other keys.

### The Problem

In a structured database, such as a relational, graph, object or constraint database, the difference in representation poses a problem. You may represent 5 of something as 5 tuples or 5 of something as the number 5 as a member inside a tuple (i.e. in a column). You could normalize the objects getting exchanged into such that a mix of multiple tuples/nodes, each with a quantity such that you get both referenceable, non-fungible objects like the mansion while retaining the possibility to deal with larger quantities or quantities with fractions:

Since the introduction of word embeddings and other AI-related representations such as Sparse Distributed Representations, it has been known how to create a combinatorial type system to create an expressive and rich type system. In latent-space AI models such combinatorial types take the form of spatial dimensions where distance between points encodes similarities. When turned into labeled features and binary weights, we get a type system akin to a sparse distributed vector, such as a binary version of the famous king−male+female=queen example wherein each concept is typed as a (sparse) bitmap where each bit represents a labeled feature.

These learned or hand-crafted combinatorial types work well as long as the operations performed on them are approximate: nearest-neighbor search, clustering or analogical reasoning over concepts. They provide a powerful way to say that “student exchange”, “house purchase” and “currency swap” are all related instances of an abstract EXCHANGE type. But when a business system must settle accounts to the cent, ensure that “2 dinghies plus 10 dinghies minus 3 dinghies” really equals 9 dinghies, or compute tax across millions of such events, approximate similarity alone is not sufficient.

However, this does not solve the invariance problem for structured and exact knowledge representation and processing. The same combinatorial type “exchange” must repeatedly be re-encoded into many different schemas, persistence layers and index structures, and every such encoding makes slightly different decisions about which quantities are explicit, which are implicit, and which roles are represented at all.

Database devices rely on technologies that have evolved over decades but continue to rely on information pertaining to a discrete entity with a primary key as a central construct-for example a row in a table, a tuple in a constraint database or a node in a graph. To this discrete entity we attach attributes, like constraints in a constraint database or plain fields in a relational database or an edge to another discrete object in a graph database. While this concept was practical when pen and paper were a requirement for representation, it comes with severe consequences for performance, expressiveness and schema change resilience.

When an engineer designs a schema using such a discrete construct, a large number of early design decisions must be made, for example:
While “five customers” should probably be represented as five tuples, what about “five smartphones” or “five million golf balls” ? Should they be represented as five tuples, or as one tuple row with a numeric field equal to 5 or 5 million, or should we split the rows as data about them gets heterogeneous?
Where and how do we store attributes such as the physical weight of something? Let's take an example of golf balls, yachts and dogs. For the golf balls, it might be natural to store the weight once for all golf balls, for the yachts once per individual yacht and for the dogs, who may vary in weight, once per dog and time.

The database schema is not merely a reflection of the ontology at hand, but also needs to detail which propositions to support, all of which are to do with requirements and use cases rather than the ontology of physical weight itself.

Decisions have to be made about normalization, fungibility, granularity and identity, etc. Changing them later can require significant re-engineering effort, including schema migrations and application changes. You need to cater for any needs up front or accept expensive and destabilizing refactoring later on. This is not only hard, it also has a huge impact on performance for capabilities never used. These difficulties stem from forcing continuous, divisible realities into discrete, pen-and-paper style records with primary keys, instead of representing them directly as parts of a continuous space.

For changes that affect only part of a numeric quantity (for example, transferring some but not all of a stock item, balance or volume), some database schemas may respond by splitting or merging rows or nodes to track the new portions. Over time this can increase the number of keyed entities and the amount of application-level bookkeeping needed to describe what is conceptually the same underlying quantity.

### BRIEF DESCRIPTION

Instead of discrete tuples (e.g. records, rows, nodes, or objects with atomic keys), the entities in a Key-space database are at the storage level stored as sets of intervals within a semantic coordinate system. In a Key-space database, the primary keys and foreign keys themselves comprise intervals or sets of intervals in this coordinate system, replacing the tuple as a component of the database. In other words, instead of a fixed set of tuples with primary keys, there is a non-discrete universal space out of which there is an unbounded set of primary or foreign keys to reference. E.g. 1 person, 9000 people or ¼ of a person are equally valid references or keys, making a discussion about the “number” of primary keys or “tuples” not applicable to a Key-space database as opposed to aforementioned database paradigms.

In contrast, relational, graph and constraint databases center everything on discrete records—rows, nodes or tuples with atomic keys—and then attach numbers and constraints to those records as attributes. In a Key-space Database (KEY-SPACE DB), the roles may be flipped: the keys themselves are intervals or sets of intervals in a semantic coordinate system, and quantities like “5 submarines”, “3 000 bearings” or “5½ liters of turbine oil” are represented by the length of those intervals rather than by numeric fields. Where such databases would typically store “5½ liters of turbine oil” as one record with a numeric attribute and struggle to represent selling ¼ liter of that same oil, a KEY-SPACE DB may simply reference a part of the original oil and assign that space a new owner, with no splitting of records or adjusted schema.

Thus the engine does not separate numbers from entities as “values in a field” versus “records in a container”: quantity and entity are two views of the same space. To obtain a number you measure the extent of an entity's space, and to obtain an entity you allocate it some extent in space. In that sense the engine treats all information items uniformly; it does not fundamentally distinguish between “a hundred customer records”, “a hundred dollars” or “a hundred liters of milk”, and it no longer even makes sense to count the number of primary keys, because any sub-interval can itself serve as a key, giving an effectively unbounded key space. In a subject, predicate and object scenario, for example, both the subject and the object have an interval or a set of intervals as their primary and foreign keys, and any sub-interval of those spaces can also act as a primary or foreign key.

The disclosed techniques may reduce energy consumption and increase performance, as storage and processing cost depend primarily on semantic heterogeneity rather than on the number of items or schema features. As will be described in this disclosure, information stored is invariant to normalization, fungibility, time and granularity; schema design does not require ahead-of-time decisions on these matters. Thus database schemas do not need to evolve nearly as much with new application requirements, leaving old applications and new applications with new requirements compatible and potentially avoiding expensive rewrites.

Returning to the Exchange1-Exchange4 examples, we can now phrase the invariance problem more precisely. Vector databases keep the combinatorial type “something is exchanged for something” stable across wildly different table layouts and even across natural-language descriptions, but they do so in a latent space that is hard to query exactly and hard to align with financial ledgers or inventory counts. Traditional structured databases, on the other hand, support exact arithmetic and indexing but fracture the exchange type into many unrelated schemas and indices, each making its own non-invariant representational choices.

A Key-space Database may combine the invariance of the vector representation with exact, transactional operations by treating each exchange as a region in a shared semantic coordinate system—spanning, for example, subject, object, consideration, quantity, currency and time axes. The four exchanges above are then simply different slices through the same global exchange key-space. Queries such as “What got exchanged for what?”, “How many dinghies were traded for how much USD last week?” or “Which student-for-student exchanges involved more than one currency?” become operations over one unified space rather than federated lookups across incompatible schemas.

In that sense, the KSDB may provide the needed invariance: once the combinatorial type “exchange” (and similar types) has been given a home in the global key-space, subsequent applications may no longer need to reinvent their own partial, schema-specific encodings of it. They may instead reuse and refine the same spatial regions. The invariance that vector databases discover statistically may become a stable, first-class construct of the runtime itself, available both to AI agents and to traditional transactional workloads.

### DETAILED DESCRIPTION

Information objects may not have atomic, discrete keys, but instead keys comprising space descriptors being indefinitely divisible into subkeys, or in itself be a subkey of a key of a bigger spatial descriptor.

Instead of storing numeric attributes or constraints, objects may not have attributes, such as numeric attributes directly. Instead, they may require to measure the spatial descriptors to retrieve a quantity. I.e. representing 4 dollars or 4 submarines is both done by measuring a space representing their existence in the database as non-discrete objects in a symmetric way, i.e. there are not objects and fields where are just spatial descriptors.

Thus, in one embodiment, there would be no architectural difference in how the submarines, the bearings, the turbine oil or the cats are stored in the database. In a key-space settings, there would be no need to map their representation to any variation of how their quantitative existence is represented.

In such an arrangement, a quantity such as “5½ liters of turbine oil” may be represented by in interval whose measure is 5½, for example as a single interval on a semantic “turbine_oil” axis. If ¼ liter of that oil is later transferred to another owner, the transfer can be represented by forming subspaces that correspond to sub-intervals of the same interval: one sub-interval for the part that changes owner and another for the remaining part. References that already point to the original interval remain valid, and additional propositions can be attached to the sub-intervals as needed. Thus, partial transfers and similar updates may be handled by operations on intervals rather than by splitting and re-keying discrete rows or objects.

A key-space uses a semantic coordinate system that is in part numeric. For example, while a geometric space may have the dimensions x, y, z and time as Euclidean axes, a key-space database may have the five dimensions, time, subject, object, predicate and version in a mixed coordinate system with a numeric part to allow measuring their existence as a quantity.

An interval on a semantic axis may have a numeric distance whose measure represents the quantity of the semantic object represented on said axis. Examples of such measurable coordinate distances can be a hundred dollars, two persons or 3 12 liters of turbine oil.

Techniques according to the present disclosure avoid many severe technical limitations of classical database devices and technologies such as
greatly reducing hardware resources needed to store, process and retrieve database information;
replacing the need for engineering effort by automating concerns that are otherwise typically implemented in application software;
removing limitations of services provided by the database device such as allowing different statements pertaining to different times, versions and subsets of information elements; and
reducing engineering efforts needed to use the technology as for example requiring less foresight in future use cases of the databases created.

Referring now to FIG. 1 through 11.

The present disclosure marks a departure from the tradition of using discrete records as discussed above:
Relational databases, depicted in FIG. 3A, use discrete records in the form of rows, identified by discrete primary keys 311 (e.g. 12035), storing numeric values 312 and non-numeric values 313 in cells organized into columns.
Graph databases, depicted in FIG. 3B, use discrete records such as nodes identified by discrete keys 321, with discrete edges (e.g. “likes”) connecting nodes to each other, and often support node attributes such as the numeric node attributes 322 and non-numeric node attributes 323.
Constraint databases, depicted in FIG. 3C, may allow non-discrete, unbounded sets of values 335 to be defined through constraints 334, but typically require an auxiliary traditional database storing discrete records, identified by discrete keys 331, to connect these constraints and values to symbolic information such as numeric attributes 332 (e.g. a price “$5”) and non-numeric attributes 333 (e.g. the string “John”).
Vector databases, depicted in FIGS. 3D and 3E, likewise contain non-discrete elements such as vector embeddings 345 and labelled neighborhoods 346, but also typically require an auxiliary traditional database, such as a relational database as depicted in FIG. 3D or graph database as depicted in FIG. 3E, to store symbolic information that may include primary keys 341, numeric values 342, and non-numeric values 343.

The present disclosure, instead, introduces KEY-SPACE databases, depicted in FIG. 3F. Key-space databases use key-spaces 362, capable of storing information in a multi-dimensional, semantic coordinate system, where keys 361 may be overlapping intervals along the coordinate axes, and numeric values may be expressed as the measures (lengths) of such intervals.

The present disclosure, instead, introduces key-spaces as a basic construct of data processing in database devices or in database engines that may be used as embedded technology in other devices or computing systems.

Just like the nodes and edges of a graph database, rows and columns of a relational database, or objects and attributes in an object-oriented database, key-spaces may be used to represent semantic propositions, such as product.name=‘turbine oil’ or likes(abe_lincoln,maple_syrup).

Similar to the primitives of geographical or physical object databases like those used in GIS, CAD/CAM, CGI, construction, simulators, games etc., key-spaces 330 may be of arbitrary extent. Unlike geographical or physical objects, however, key-spaces may, at least in some dimensions, be defined by reference to a semantic coordinate system rather than a spatial coordinate system. Such semantic coordinate systems will be disclosed for various embodiments below.

In the interest of brevity, we sometimes refer to key-spaces simply as spaces, and to a database device or a database engine embedded in other devices implementing the methods of the present invention by means of a computing system as a Key-space Database or KEY-SPACE DB.

Key-spaces have dimensions (1 or more), have a measure (length in one dimension, area in two and volume in higher dimensions). They are set-like, in that a space can be divided into subspaces, key-spaces can overlap, etc. In the present disclosure, key-spaces may be used to describe non-spatial objects and concepts such as organizations, predicates (e.g., having a color, or being owned by someone), colors (e.g. amber), statements (e.g., “Maple syrup has the color amber”) or a period of time (2nd of May 1970) etc.

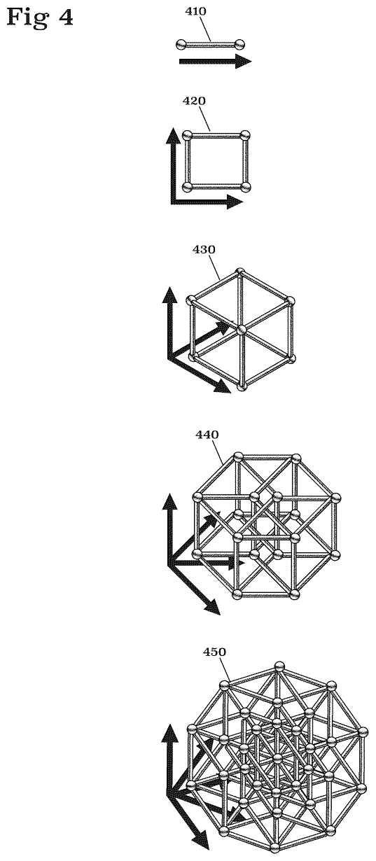

A key-space has an associated dimensionality, and we shall refer to them as 1-spaces 410, 2-spaces 420, 3-spaces 430, 4-spaces 440, 5-spaces 450, . . . , etc (and generally as k-spaces) depending on this dimensionality, as shown in FIG. 4. Spaces of lower dimensionality, such as 1-spaces, may be used to represent entities in some domain of discourse, and these lower dimensionality spaces may then be combined into spaces of higher dimensionality that describe propositions involving those entities. For example, a 1-space could represent entities such as 3 12 liters of turbine oil, one (1) person, 500 bearings, etc. Similarly, a 3-space could represent an entity such as a trichromatic color, with the three dimensions corresponding to the red, green and blue values, respectively. In the following examples, we will use quotes and italics to describe spaces.

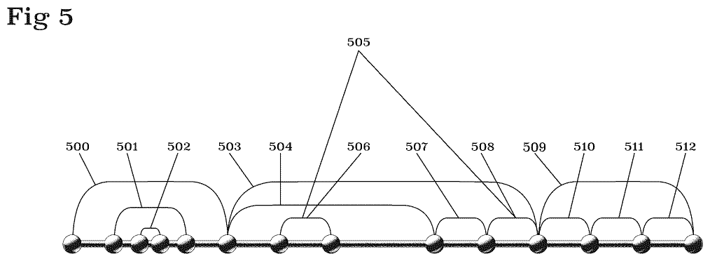

The measure of a space may describe the size, quantity, mass, length, volume, or some other quantifiable characteristic of the entity which is represented by the space. For example, in the case of the 1-space “some_syrup” 502 shown in FIG. 5, the measure ¼ describes the volume—¼ liters—of maple syrup.

Some spaces may overlap other spaces. For instance, if the 1-space “mary_lincoln” 508 of measure 1 represents one person, the 1-space “abe_lincoln” of measure 1 represents another person, and the 1-space “presidents” 504 of measure 46 represents the first 46 presidents of the United States, the 1-space “lincoln_couple” 505, of measure 2, may partially overlap the “presidents “504 space, with “abe_lincoln” being a subspace of both “lincoln_couple” and “presidents.”

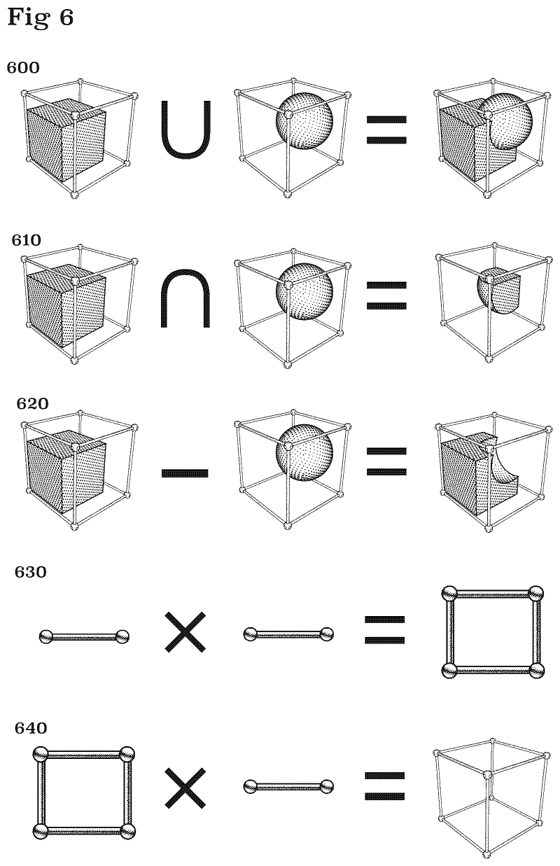

Spaces may be manipulated using set operations—the union 600, intersection 610, and difference 620 of two spaces is itself a space, as shown in FIG. 6. For example, if the 1-space “lincoln_couple” 505 is the union of “mary_lincoln” 508 and “abe_lincoln” 506, it will share the intersection space “abe_lincoln” 506 with the “presidents” 504 space. If we remove, using the difference operation, the space “abe_lincoln” 506 from the “presidents” 504 space, we will end up with a space of measure 45. We would have the exact same space of measure 45 if we instead subtracted “lincoln_couple” 505 from “presidents” 504 because, although “lincoln_couple” 505 is of measure 2, the overlap only is of measure 1.

We may use the Cartesian product operator to combine spaces of lower dimensionality into spaces of higher dimensionality. For example, as shown in FIG. 6, the Cartesian product of a pair of 1-spaces is the 2-space 630, and the Cartesian product of a 2-space with a 1-space is the 3-space 640. More generally, the Cartesian product of an n-space with an m-space is an (n+m)-space.

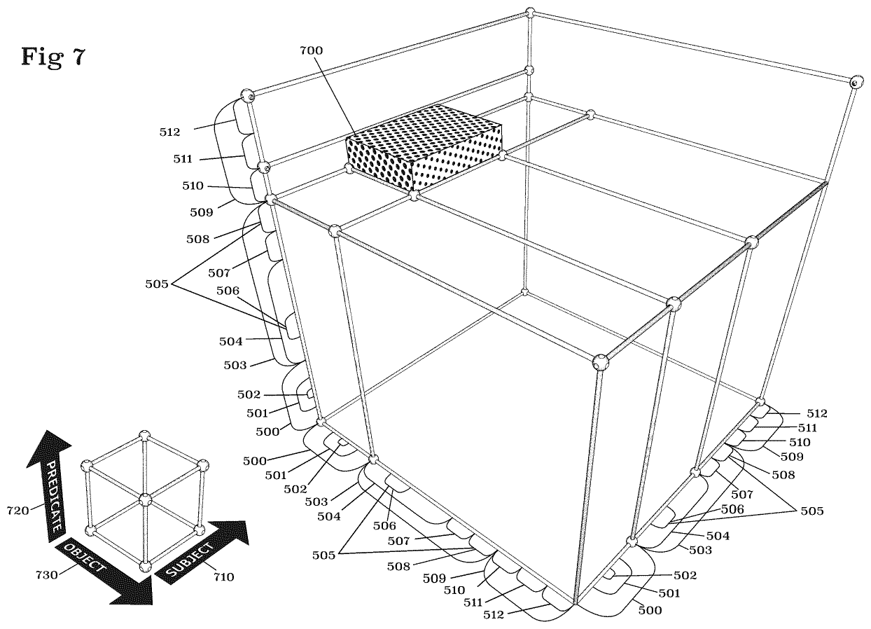

When combining spaces using the Cartesian product, we may assign a semantic role to one or more of the dimensions of the resulting space. FIG. 7. shows an example wherein the 1-space “presidents” 504 is combined with the 1-space “like” 510 and the 1-space “maple_syrup” 500. In this example, the three dimensions of the resulting space correspond to the semantic roles subject 710, predicate 720, and object 730, respectively. Thus, the resulting 3-space “presidents like maple_syrup” 700 may be interpreted as saying that the first 46 presidents (the subject) all like (the predicate) maple syrup (the object).

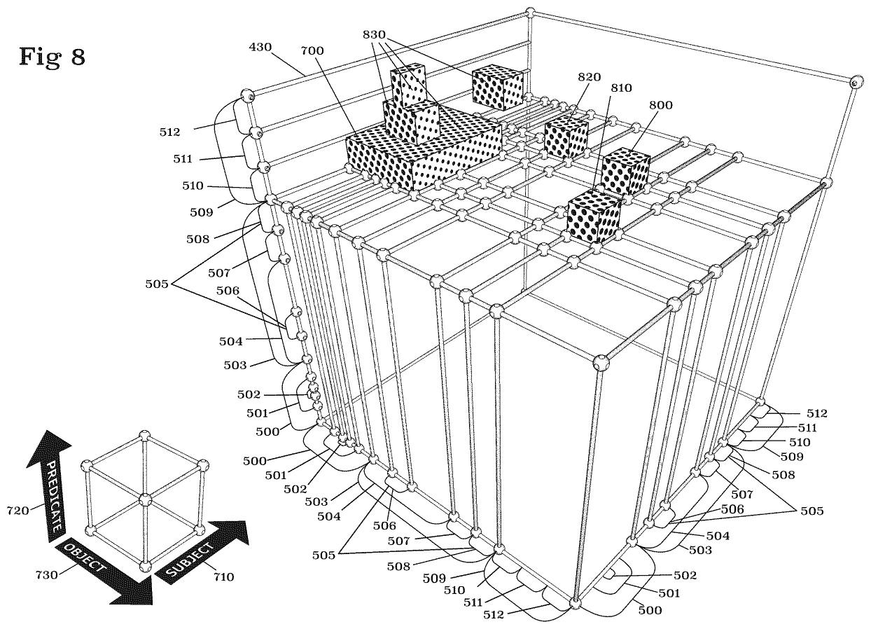

In some embodiments, the same 1-space may appear in multiple dimensions of a higher-dimensional space. This is important for reflexive statements such as “julius_caesar like s julius_caesar” 800 where “julius_caesar” 507 appears in both the subject dimension 710 and the object dimension 730, as shown in FIG. 8. It also provides directionality. For example, the 3-space “abe_lincoln like s mary_lincoln” 810 is distinct from the 3-space “mary_lincoln like s abe_lincoln” 820, since they represent distinct propositions.

In the following examples, we will occasionally use square brackets combining spaces using and and except, denoting the union and difference set operators, respectively. For example the space “[abe_lincoln and mary_lincoln]” is the exact same space as “lincoln_couple” 505.

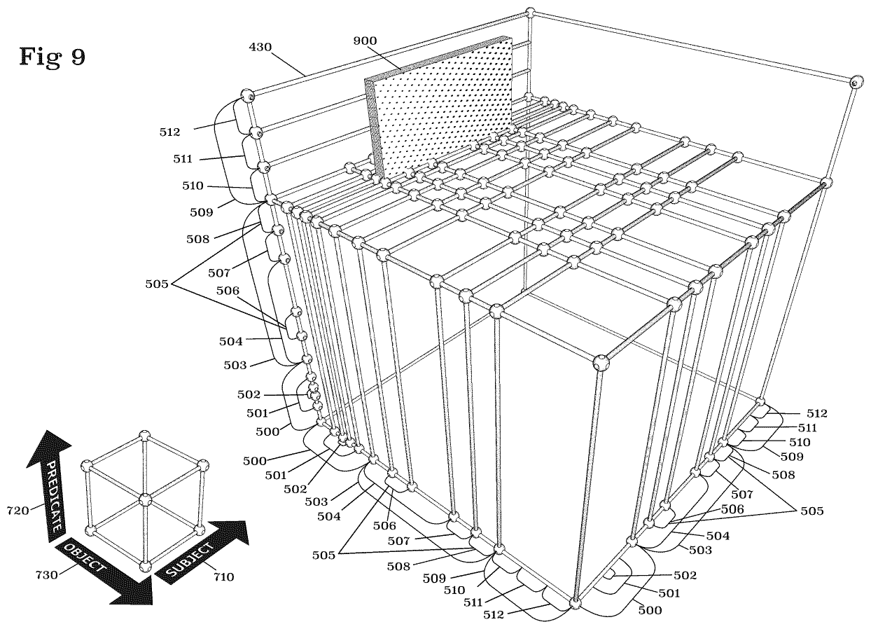

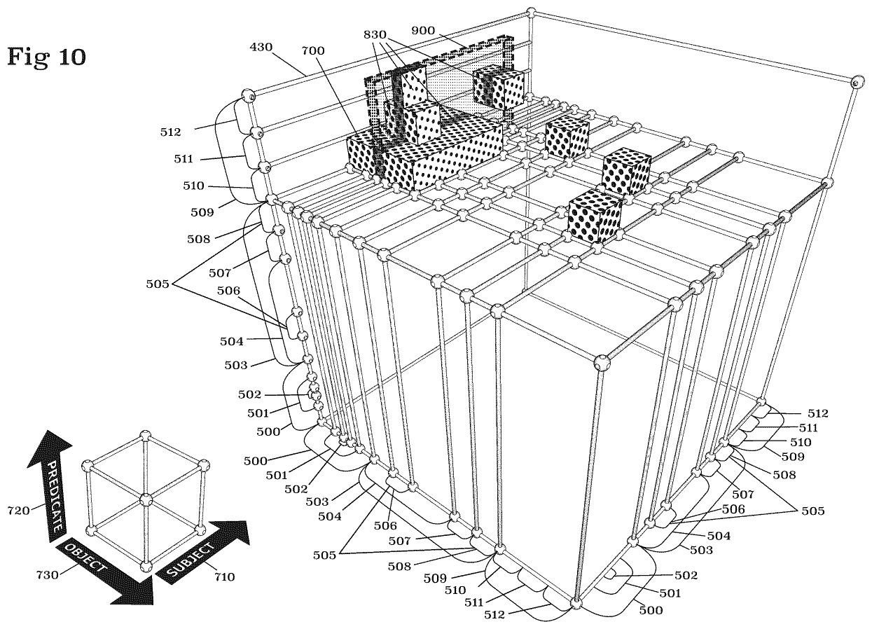

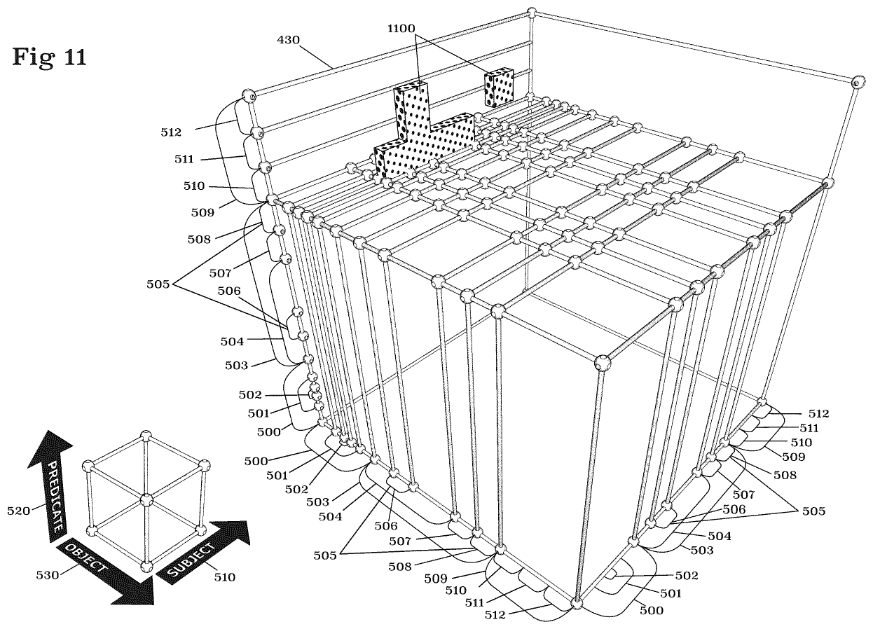

Now that we have established how key-spaces may be used to represent propositions (e.g. facts, hypotheses, etc.), we will explore how to answer questions about them. Referring again to FIG. 8, we see a depiction of a key-space representing a multitude of propositions, such as “[presidents like maple_syrup; lincoln_couple made batch_of_syrup; and abe_lincoln ate some_syrup]” 830, “able_lincoln likes mary_lincoln” 810 and “julius_caesar likes julius_caesar” 800. If we are interested in making an inquiry about this key-space, e.g. to answer the question “Who likes, made, or ate some maple syrup?”, we may construct a query space representing a hypothesis covering everything that could be true within the confines of our question. In this case, the hypothesis would be that “all_people like, made and ate some maple syrup”. To form this space, we combine the 1-space “all_people” 503 with the 1-space “[likes; made; and ate]” 509 and the 1-space “some syrup” 502. The result, shown in FIG. 9, is the query 3-space 900. We may then take the intersection of the query space 900 representing our hypothesis with the space 800-830 representing the propositions which we consider to be true. This process, illustrated in FIG. 10, results in the space “presidents like maple_syrup; and lincoln_couple made batch_of_syrup; and abe_lincoln ate some_syrup” 1100 shown in FIG. 11. Notice that this space includes all propositions relevant to answering our question, while omitting all other propositions (e.g. those about Julius Caesar liking himself, or Mary and Abe liking each other).

In the above example, we say that the query space 900 represents a hypothesis, and that space 800-830 represents that which is known to be true (i.e. facts). It is worth noting that these are merely interpretations, not intrinsic properties, of the spaces. Indeed, it would be perfectly valid to switch the roles, so that space 900 represents that which is known to be true, and 800-830 represents the hypothesis that we wish to test. With that being said, some embodiments according to this disclosure may opt to label the spaces explicitly, so that it is possible to determine whether a given space represents an enquiry or a hypothesis, a known fact, or even a known falsehood (i.e. something known not to be true).

When two spaces overlap they partially represent the same entity. For example, given the two 3-spaces “lincoln_couple made batch_of_syrup” and “abe_licoln ate some_syrup” we may project their respective third dimension resulting in the 1-spaces “batch_of_syrup” and “some_syrup”. By taking the intersection of these two spaces, we can determine how much of the maple syrup Abe Lincoln ate was made by him and his wife.

The fact that key-spaces may be non-discrete blurs the distinction between a single space and multiple spaces. As seen above, the 1-space “lincoln_couple” 505 can either be regarded as a single space of measure 2, or, equivalently, as the union of the two 1-spaces “abe_lincoln” 506 and “mary_lincoln” 508, each with a measure of 1; or the union of the three 1-spaces “mary_lincoln”, “first_third_of_abe_lincoln” with a measure of ⅓, and “second_two_thirds_of_abe_lincoln” with a measure of ⅔; or four 1-spaces, or 1 million 1-spaces of small fractions of the couple, and so forth. Although dealing with fractions of a person doesn't make much sense, the number of spaces that can be referenced is not limited by the number of spaces that have been described. That is, a database storing a single space is also storing many spaces, and vice versa. Consequently, the cost of storing a space representing propositions about submarines or bearings may be determined by how heterogeneous the submarines and bearings turn out to be, and not their quantity. Taken to the extreme, the 3-space “everything everything everything” may simultaneously represent all statements that could possibly be represented as 3-spaces, with the same storage cost as a single statement. This has profound implications for the problems of heterogeneity and referential granularity described above. A data model in a KEY-SPACE DB generally does not need to make the choice described in the submarine, bearing, spindle-oil and cat example.

Thus far, we have limited ourselves to representing statements using 3-spaces, primarily because they are easy to illustrate. However, statements of greater nuance and complexity may comprise many more semantic roles than the three we have used thus far. One common and useful semantic role is time, i.e. when that which is expressed by the statement is true. For example, the statement “Abe Lincoln ate some syrup between 3 pm and 4 pm Jan. 15 1860” expresses four semantic roles: subject (Abe Lincoln), predicate (ate), and object (some syrup) and time (between 3 pm and 4 pm Jan. 15 1860). In order to represent this statement as a space, we may combine the 3-space “abe_lincoln ate some_syrup” with the 1-space “3-4 pm Jan. 15 1860” to form the 4-space” abe_lincoln ate some_syrup 3-4 pm_Jan_15_1860”.

Another useful semantic role is perspective, i.e., in whose subjective opinion the statement is true. For example, we may extend the above statement to read “Abe Lincoln ate some syrup between 3 μm and 4 pm Jan. 15 1860, according to Mary Lincoln”. By combining the 4-space “abe_lincoln ate some_syrup 3-4 pm_Jan_15_1860” with the 1-space “mary_lincoln”, we may obtain the 5-space “abe_lincoln ate some_syrup 3-4 pm_Jan_15_1860 according to mary_lincoln”.

While subject, predicate, object, time, and perspective are examples of practically useful semantic roles, the number of conceivable roles is virtually endless. Consequently, embodiments according to this disclosure may use spaces of whatever dimensionality is needed to satisfy their requirements for nuance and complexity in the statements they represent. Indeed, in some embodiments, the user of a KEY-SPACE DB may be able to define new dimensions on the fly, much like creating a new table in an RDBMS.

For some statements and contexts, a particular dimension may be essential, while in others it may be superfluous. For example, we may want to keep track of how our inventory of turbine oil has changed over time, but only care about the current name of a person. When a particular dimension is superfluous, or adds complexity that is not justified in a given context, it may be ignored by setting it to the universal (all-encompassing) space. Suppose, for instance, that we want to represent the statement “Abe Lincoln likes maple_syrup” as a 5-space on the form “[subject][object][predicate][time][perspective]”, but we neither know nor care when or according to whom he likes maple syrup. By setting the time and perspective dimensions to the 1-spaces encompassing all time and all people respectively, we obtain the 5-space “abe_lincoln like s maple_syrup always according to all_people”.

In the previous examples, each semantic role has corresponded to a single dimension, and consequently its value has been represented as a 1-space. However, in some instances, it may be useful for a semantic role to be represented by a space of higher dimensionality. For example, we may represent the second-order proposition “Mary Lincoln likes that Abe Lincoln ate some syrup” as the 5-space “mary_lincoln like s abe_lincoln ate some_syrup”, where the 1-space “mary_lincoln” represents the subject, the 1-space “like s” represents the predicate, and the 3-space “abe_lincoln ate some_syrup” represents the object.

Whereas a relational database 310 stores tables, and a graph database 320 stores graphs, a Key-Space Database (KEY-SPACE DB) 330 stores key-spaces representing semantic propositions. While some embodiments may store a single key-space of a fixed dimensionality, corresponding to predetermined semantic roles (e.g. subject, predicate, and object), others may store a plurality of key-spaces with different dimensionalities and semantic roles.

In order to distinguish spaces stored in a KEY-SPACE DB from transient spaces that arise during the execution of some operation, query spaces participating in queries, etc., we will refer to them as “stored key-spaces”. While the examples herein focus on stored key-spaces representing semantic propositions that are considered true (i.e. facts), embodiments according to this disclosure may store key-spaces representing semantic statements that are considered false, or whose truth value is unknown or otherwise indeterminate. Moreover, the truth value may be an intrinsic property of key-spaces in some embodiments, such that each key-space carries its truth value with it.

Whereas a traditional DBMS may receive instructions (e.g. in the form of procedure calls, network requests, etc.) to read and write their respective kinds of discrete records (e.g. rows, cells, nodes, edges, etc.), a KEY-SPACE DB may receive instructions to read and write key-spaces. For example, if a KEY-SPACE DB storing the 3-space “presidents like maple_syrup” 700 receives a data-update instruction instructing it to add the 3-space “abe_lincoln ate some_syrup”, it may update its stored space so as to reflect the union of the original stored 3-space with the 3-space being added, resulting in “presidents likes maple_syrup; and abe_lincoln ate some_syrup”. Similarly, if it later receives a data-update instruction instructing it to remove the 3-space “abe_lincoln likes maple_syrup”, it may again update its stored space so as to reflect the difference between the stored 3-space and the 3-space being removed, resulting in “[presidents; except abe_lincoln] likes maple_syrup; and abe_lincoln ate some_syrup”.

As discussed above, and illustrated in FIG. 9, FIG. 10 and FIG. 11, a data-retrieval instruction may comprise a query expressed as a query space, representing propositions whose truth value the reader wishes to determine. For example, to determine who likes syrup (maple or corn) one may issue a data-retrieval instruction for the hypothesis 3-space “all_people like syrup”, where “all_people” is the 1-space encompassing all persons. In one embodiment, a database device or database engine may process this instruction by finding the subset of its stored space which intersects the query space, which—after the above data-update instructions have been handled—would be the 3-space “[presidents except abe_lincoln]like maple_syrup”.

The resulting space can then be used to return a query result in some format requested by the caller. For example, the output may comprise an instance object representing the space (as is the case with many Object/Relational Mappers). Such an instance object may encapsulate the 1-space projected as the subject dimension 710 from the 3-space 1100 to represent an identity (a key) for the returned object. The 1-space projected as the predicate dimension 720 from the 3-space 1100 could be used to set attributes (also known as properties or fields) of said instance object having the values taken from the 1-space projected as the object dimension 730 from the 3-space 1100.

### Coordinate System

A key-space logically exists within a coordinate system, whether it be explicitly or implicitly defined. There are many different kinds of coordinate systems, such as Cartesian (x, y, z, . . . ), polar, cylindrical, spherical, geodetic (longitude, latitude), etc. While geometric and spatial databases typically use a spatial or geodetic coordinate system, such as x, y, z or longitude and latitude, key-space databases may instead use a semantic coordinate system that allows for the storing, retrieving and processing of the kinds of data typically found in relational databases, graph databases, and the like. For example, semantic coordinate systems may allow for the natural expression of non-spatial concepts, such as organizations, manufacturing orders, or amounts of currency.

We will focus on semantic coordinate systems of the Cartesian variety, as they simplify the implementation of the key-space algorithms and data structures described below. However, embodiments according to this disclosure may represent key-spaces by reference to any suitable coordinate system. Some embodiments may allow users of the database engine to define their own coordinate axes, and may allow storing spaces referencing several different, user-defined coordinate systems, each with its own set of user-defined axes.

Recall that a Cartesian coordinate system comprises one or more orthogonal axes, with the most common example being the “x” and “y” axes first encountered in elementary school. Just like spaces, coordinate systems have a dimensionality, which is equal to the number of axes in the system. For example, the Cartesian (x,y) coordinate system is two-dimensional, because it has two axes. Generally, an n-dimensional Cartesian coordinate system may be decomposed into n 1-dimensional coordinate systems (i.e. the individual axes).

The dimensionality of a coordinate system may correspond directly to the dimensionality of the key-spaces existing therein, such that a 1-space exists within a 1-dimensional coordinate system (a single axis), a 2-space exists within a 2-dimensional coordinate system (two axes), and so forth. Thus, we will use “axis” and “dimension” interchangeably throughout this text.

Unlike the traditional Cartesian coordinate system, the semantic coordinate systems used in key-space databases may comprise quantitative components, such as numbers representing a count, size, length, etc.; symbolic components, such as character strings, bit sequences, numbers representing indices in a lookup table, etc.; or a mix thereof. For a real-world example of a mixed coordinate system, consider the street numbering conventions used in many US cities: a building number (quantitative component) followed by a street name (symbolic component), e.g. “105 Water Street”.

Symbolic components may comprise: categorical components, which classify or qualify the semantic entity (e.g., “syrup”, “corn_syrup”, “people”); partitional components, which reserve regions of the coordinate space for allocation (e.g., UUIDs like “136b6c4d-97ab-449c-a430-c8c559dcdc83”); and literal components (e.g., “John”, “ACME Corp.”). Embodiments according to this disclosure may use these or other kinds of symbolic components as appropriate for their application domain.

Key-space coordinate systems may also have 1-dimensional coordinates comprising multiple components. For example, a 1-dimensional coordinate could be defined by the slash-delimited component sequence “strings/John” (two symbolic components), “time/gregorian/America/New_York/1991/July/16/13/15/0” (five symbolic components and five quantitative components), or “purchase_orders/acme/18”. Such sequences may be arbitrarily long, and different coordinates along the same axis may comprise different numbers and types of components. Note that the use of a forward slash as a component delimiter is for readability only, and not meant to suggest any particular way of representing coordinates comprising multiple components.

In some embodiments, some or all of the coordinate system's axes may be identical, i.e., comprise the same sequence of values. The traditional Cartesian coordinate system is an example of this, since the x and y axes are identical save for their orientation. Thus, any coordinate on the x axis (e.g. 5) occupies the same position on the y axis. In a key-space coordinate system, this property may allow the same 1-space to appear in multiple dimensions of a space of higher dimensionality, paving the way for statements such as “julius_caesar likes julius_caesar” (where the 1-space “julius_caesar” appears in both the subject and object dimensions), or “abe_lincoln likes mary_lincoln according to mary_lincoln” (in which the 1-space “mary_lincoln” appears in both the object and perspective dimensions). However, other embodiments may use axes that are partially or entirely different from one another. For example, one embodiment uses a single symbolic component for coordinates along the predicate axis (e.g. “likes”, “ate”, and “made”), and a specific sequence of symbolic and quantitative components for coordinates along the time axis, e.g. “time/gregorian/1991/July/16/13/45”. Such embodiments may still permit predicates or temporal values to appear in the subject or object dimensions, but may preclude some 1-spaces (such as those representing persons) from appearing in the predicate or time dimensions.

Some coordinate axes may be ordered, either totally or partially. On a totally ordered axis, we can determine, for any pair of coordinates, which one sorts before the other. For example, on the Cartesian x axis, we know that 5 sorts before 8, but after 3. By contrast, a partially ordered axis allows us to make this determination for some, but not all, pairs of coordinates. For example, in a mixed coordinate system which uses both symbolic and numeric components, numbers may be ordered in relation to other numbers, and symbols in relation to other symbols, but numbers and symbols may not be ordered in relation to each other. In that case, we can determine that 1 sorts before 5, but not whether “string/John” sorts before or after 3.

Ordered axes allow us to express intervals, which is a compact way of describing all coordinates that fall within a given range. For example, we may write [1; 3) instead of enumerating all of the (infinitely many) real numbers from 1 up to but excluding 3. Intervals are not restricted to numeric components. For example, it is perfectly valid to express the intervals [“A”; “F”) to refer to the letters “A”, “B”, “C”, “D”, and “E”; or [“time/gregorian/1900/1/1”; “time/gregorian/1910/1/1”) to refer to all time between 1/1 1900 and 1/1 1910 in the Gregorian calendar, provided the intervals' endpoints are ordered with respect to one another.

Under the assumption of ordering, a 1-space may be expressed as a set of disjoint (non-overlapping) intervals. For example, 3½ liters of turbine oil could be expressed as the interval set {[“turbine_oil/2024/8”; “turbine_oil/2024/11.5”)}. Similarly, the 1-space “lincoln_couple” could be expressed as the interval set: {[“people/8”; “people/9”), [“people/11”; “people/12”)}

In the above example, there is a “gap” between the 1-spaces corresponding to Abe and Mary. That is, they do not form a contiguous 1-space. Due to this gap, their union is represented by an interval set comprising two intervals. Generally, an interval set may comprise any number of disjoint intervals, and it is not uncommon in practice for interval sets to comprise hundreds or even thousands of intervals.

Given two 1-spaces which can both be expressed as sets of disjoint intervals, their Cartesian product can be expressed as a set of disjoint rectangles. If we take the Cartesian product with another such 1-space, the result can be expressed as a set of disjoint rectangular cuboids (informally referred to as “boxes”). This generalizes to arbitrary dimensionality such that, for example, the Cartesian product of a 5-space with a 7-space can be expressed as a set of disjoint 12-dimensional hyperrectangles.

Recognizing that intervals, rectangles, rectangular cuboids, and 4-dimensional hyperrectangles may be decomposed into 1, 2, 3, and 4 intervals, respectively (one per dimension), we use the term “interval” as a basis for generalization and define the following:
A 1-interval is a conventional, one-dimensional interval;
A 2-interval is a two-dimensional rectangle;
A 3-interval is a three-dimensional rectangular cuboid;
A 4-interval, 5-interval, 6-interval, etc., is a hyperrectangle of the respective dimensionality—for example, a 5-interval is a five-dimensional hyperrectangle, and a 23-interval is a 23-dimensional hyperrectangle; and
k-interval generally refers to any interval having k dimensions, such as the examples above.

We will use hyperrectangle and k-interval interchangeably for the purpose of this disclosure. For the avoidance of doubt, we shall understand hyperrectangle as including 1-dimensional intervals, 2-dimensional rectangles, and 3-dimensional rectangular cuboids.

Although a higher-dimensional space formed by taking the Cartesian product of 1-spaces may be expressed as a set of disjoint k-intervals, spaces of dimensionality 2 and above, which are constructed by other means, may not be perfectly described by k-intervals. For example, consider a 2-space in the shape of a circle—clearly, there is no 2-interval (rectangle) whose shape is identical to that of the circle. Embodiments according to this disclosure may permit such “non-rectangular” spaces to be formed, and may in some cases inscribe them within a bounding k-interval (often referred to as a “bounding box” in computer graphics and physics simulation).

A k-interval is one example of what is known as a connected space. Informally, a connected space is one where there is a path along which you could move between any pair of coordinates in the space without leaving the space. Naturally, there are many other kinds of connected spaces besides k-intervals. For example, hexagons, spheres, and pretzel-like shapes may all be examples of connected spaces. Sometimes, a non-connected space may comprise one or more subspaces which are connected, which are generally referred to as connected components. For example, consider a key-space represented as a set of two disjoint k-intervals—clearly, this space is not connected, because if the intervals were connected, they would form a single interval. However, while the space as a whole may not be connected, each of the intervals form connected components thereof. Since the word “component” sees frequent use in other contexts within this disclosure, we will generally use the term “connected body” to mean “connected component”.

It may be desirable to keep spaces representing similar things contiguous whenever possible. To see why, suppose we have sold 1,000,000,000 bearings. If the bearings are represented by a contiguous 1-space (i.e. a single 1-interval), propositions about their make and model (which we assume are identical for all bearings) may be represented by contiguous 3-spaces (i.e. a single 3-interval). Taken to the other extreme, if the 1,000,000,000 bearings were represented by a maximally discontiguous 1-space (i.e. mutually discontiguous intervals for each of the 1,000,000 bearings), we would end up with 1,000,000,000 3-intervals for each stored proposition. Since the memory required to store spaces, and the time required to process them, may depend on the number of k-intervals they comprise, it should be apparent that there may be a dramatic benefit to maintaining contiguous spaces.

In some embodiments, categorical components may be qualitative in nature, while quantitative components may represent numeric properties. For example, a 1-space representing a single person may be expressed by the interval set {[“people/3”; “people/4”)} with the categorical component “people” signifying that we are within the subrange of coordinates corresponding to people, while the difference between the quantitative components 3 and 4 signifies that the interval represents a single person. Similarly, a 1-space representing 3½ liters of maple syrup may be represented by the interval set {[“maple_syrup/3”; “maple_syrup/6.5”)}.

Some embodiments may allow numeric components to take on the value ∞. For example, a 1-space representing an unbounded number of liters of maple syrup may be expressed using the interval set {[“maple_syrup/0”; “maple_syrup/∞”)}. This provides a virtually endless supply of new 1-spaces representing maple syrup, while still allowing us to compactly refer to all maple syrup using the aforementioned interval. Interestingly, a fact such as “abe_lincoln likes maple_syrup” may remain true even for future (i.e. as of yet unobserved) 1-spaces representing maple syrup, provided they are drawn from this range, e.g. {[“maple_syrup/1393580000.0”, “maple_syrup/1393580050.3”)}.

Some embodiments may use symbolic components to define hierarchies. For example, the 1-space representing all corn syrup could be defined by the interval set {[“syrup/corn_syrup/0”; “syrup/corn_syrup/∞”)}, and the 1-space representing all maple syrup could be defined by the interval set {[“syrup/maple_syrup/0”; “syrup/maple_syrup/∞”)}. If coordinates are ordered lexicographically, the 1-space representing all syrup (corn or maple) could then be defined by the interval [“syrup/”; “syrup/□”), where the special symbol “□” sorts after every other symbol in the ordering. Other examples of using symbolic components to define hierarchies include “strings/iso-codes/iso4217-codes/USD”, “genders/female”, or “animals/ . . . /vertebrates/ . . . /hominids/humans/ . . . ”.

Just as relational databases may use natural keys (for example, a ‘patient’ table may use the patient's social security number as a natural primary key), key-space databases may deterministically map some entities to spaces defined by coordinates calculated from some characteristics of the entity. For example, a string S could be deterministically mapped to a 1-space defined by the interval set {[“strings/S/0”; “strings/S/1”)}, such that the string “John” is mapped to the 1-space {[“strings/John/0”; “strings/John/1”)}. Other examples of entities which may occupy a deterministic space include trichromatic (RGB) colors, which could be deterministically mapped to a 1-space defined by the interval set {[“colors/rgb/R/G/B/0”; “colors/rgb/R/G/B/1”)}.

In some embodiments, symbolic components (e.g. a randomly generated UUID) may be used to create partitions of a coordinate axis, within which spaces representing entities lacking a deterministic mapping may be allocated. For example, there may not be a deterministic way to map any given person to a 1-space. In that case, a 1-space representing the person may instead be allocated from such a partition, and be assigned a 1-space defined by a set of intervals such as:
{[“136b6c4d-97ab-449c-a430-c8c559dcdc83/23”; “136b6c4d-97ab-449c-a430-c8c559dcdc83/24”)}

Some coordinate systems allow a distance function to be defined. Informally, a distance function takes two coordinates and returns the distance between them as a number (which may include infinity). In a coordinate system that only uses quantitative components, such as the traditional Cartesian (x,y) plane, the distance between a pair of coordinates A and B may be trivially computed by |A-BI (i.e. the absolute value of their difference). By contrast, in a symbolic or mixed coordinate system, there may not be an obvious definition of distance. However, embodiments according to this disclosure may provide their own definitions. For example, in a mixed coordinate system wherein a coordinate comprises a sequence of quantitative and symbolic components, the distance between a pair of coordinates A and B may be defined according to the following rules: a. the distance is o unless A and B have the same number of components; b. the distance is o unless the final components of both A and B are quantitative; c. the distance is o unless the components of A and B are identical up to (but excluding) the final component; and d. if none of the above cases are true, the distance is the absolute value of the difference between the final (quantitative) components of A and B.

In a coordinate system with a defined distance function, we may compute the measure of a 1-interval as the distance between the endpoints of the interval. For example, under the above definition of distance, the measure of the interval [“persons/8”; “persons/12”) would be 4, i.e. the absolute value of the difference between their final quantitative components, 8 and 12. Similarly, provided distance is defined on all axes, we may compute the measure of a k-interval as the product of the measures of the constituent 1-intervals. In embodiments where k-spaces are represented as sets of disjoint k-intervals, we may then compute the measure of a k-space as the sum of the measures of the constituent k-intervals.

### Examples of Data Structures and Methods

We will use the term “key-space descriptor” (sometimes shortened to “space descriptor” or simply “descriptor”) to refer to a data structure used to encode or otherwise describe a key-space.

Although key-spaces may generally take on any shape (e.g. a 1-dimensional line-segment or interval, a 2-dimensional polygon, a 3-dimensional torus, a 4-dimensional hypersphere, etc.), embodiments according to this disclosure may choose to constrain the shapes that key-spaces are permitted to take on in order to achieve some benefit, such as greater computational efficiency, lower memory usage, etc.

A particularly advantageous constraint may be to only permit key-spaces to take on shapes that can be defined as a set of disjoint k-intervals. This includes shapes such as 1-dimensional intervals, 2-dimensional rectangles, 3-dimensional rectangular cuboids, and hyperrectangles of arbitrarily high dimensionality. The benefits include:
Compact representation: a k-interval may be defined by one minimum and one maximum coordinate per dimension, as noted above, for a total of 2 k coordinates.
Easily combined and decomposed: k-intervals may be combined using the Cartesian product to form k-intervals of higher dimensionality; similarly, a k-interval of lower dimensionality may be obtained by projecting one or more dimensions from a k-interval of higher dimensionality.

Embodiments according to this disclosure may use various data structures as key-space descriptors. When key-spaces are constrained to sets of disjoint k-intervals, there are many well-known algorithms and data structures that may be used. Without limiting the scope of the disclosure, we shall assume that such a data structure provides five basic operations:
add( ), which adds a k-interval to the set;
remove( ), which removes a k-interval from the set;
find( ), which finds k-intervals in the set that overlap a given k-interval;
copy( ), which creates a copy of the set, producing a new set that uses the same data structure and contains the same intervals; and
enumerate( ), which returns all k-intervals in the set.

In an object-oriented language, such a data structure may implement the following interface:

```
interface KIntervalSet {
  add(ki: KInterval): void;
  remove(ki: KInterval): void;
  find(ki: KInterval): KInterval[ ];
  copy( ): KIntervalSet;
  enumerate( ): KInterval[ ];
}
```

A common example of a space descriptor is a description or encoding of a k-interval (also referred to as a hyperrectangle) or k-interval set (also referred to as a hyperrectangle set).

The type Kinterval, representing a k-interval, may be defined as follows:
type KInterval={min: SemanticCoordinate[ ]; max: SemanticCoordinate[ ];}

Here, min and max represent the minimum and maximum coordinates for each of the k dimensions. For example, min[0] refers to the start coordinate of the first-dimension interval, and max[3] refers to the end coordinate of the fourth-dimension interval.

In this example, we use a mixed coordinate system wherein a single coordinate may comprise a sequence of symbolic and quantitative components. Accordingly, we define the SemanticCoordinate type as follows:

```
type SemanticCoordinate = SemanticCoordinateComponent[ ];
type SemanticCoordinateComponent =
  | string // symbolic component (e.g. categorical, partitional, or literal)
  | number // quantitative component
  ;
```

In a first embodiment, key-spaces are encoded as an array of Kinterval. The KIntervalSet interface could then be implemented as follows:

```
class ArrayKIntervalSet implements KIntervalSet {
  private intervals: KInterval[ ];
  constructor(intervals: KInterval[ ] = [ ]) {
    this.intervals = [...intervals];
  }
  find(queryKi: KInterval): KInterval[ ] {
    let result: KInterval[ ] = [ ];
    for (let ki of this.intervals) {
      if (kIntervalIntersection(ki, queryKi) != null) {
        result.push(ki);
      }
    }
    return result;
  }
  add(ki: KInterval): void {
    this.intervals.push(ki);
  }
  remove(ki: KInterval): void {
    let index = this.intervals.indexOf(ki);
    if (index != −1) {
      this.intervals.splice(index, 1);
    }
  }
  copy( ): KIntervalSet {
    return new ArrayKIntervalSet(this.intervals);
  }
  enumerate( ): KInterval[ ] {
    return this.intervals;
  }
}
```

The ArrayKIntervalSet implementation shown above makes use of the following auxiliary k-interval functions:

```
// Finds the intersection of the given k-intervals, if any
function kIntervalIntersection(
  a: KInterval,
  b: KInterval
): KInterval | null {
  let k = kIntervalDims(a);
  assert(k == kIntervalDims(b));
  let result: KInterval = { min: [ ], max: [ ] };
  for (let i = 0; i < k; i++) {
    let min = SemanticCoordinate.max(a.min[i], b.min[i]);
    let max = SemanticCoordinate.min(a.max[i], b.max[i]);
    // If min>=max in this dimension, there is no overlap.
    if (SemanticCoordinate.compare(min, max) >= 0) {
      return null;
    }
    result.min.push(min);
    result.max.push(max);
  }
  return result;
}
// Returns the dimensionality of the given k-interval
function kIntervalDims(ki: KInterval): number {
  assert(ki.min.length === ki.max.length);
  return ki.min.length;
}
```

In a second embodiment, key-spaces are encoded as a binary tree (which may be a balanced tree, such as a Red-Black tree, T-tree, or AVL tree). When storing a multi-dimensional key-space, one dimension is designated as the ordering dimension. Then, the key becomes the start coordinate of each k-interval in this dimension. The add(and remove( ) operations work as a regular addition or removal in a binary tree, though the remove( ) operation may need to compare all dimensions of both the start and end coordinate to be sure it is removing the correct k-interval. The find(operation starts at the first node whose key is greater than or equal to the start coordinate in the ordering dimension of the given k-interval, and stops at the first node whose key is greater than or equal to the end coordinate in the ordering dimension, comparing each k-interval encountered along the way for overlap with the given k-interval. The efficiency of this data structure largely hinges on the choice of the ordering dimension. For example, if the third dimension is selected as the ordering dimension, but most find(operations search for k-intervals which have a very large extent in the third dimension, it may not be very efficient.

In a third embodiment, key-spaces are encoded as a multi-way tree (e.g. a B+ tree). As with the binary tree representation, one dimension may be designated as the ordering dimension. The add(, remove( ) and find( ) operations are implemented similarly, with the primary difference being that nodes contain more than one key, and consequently may branch off in more than one direction. While the asymptotic complexity of this data structure is the same as that of the binary tree, it may benefit from a lower memory footprint and better cache locality.

In a fourth embodiment, key-spaces are represented using a skip list. Again, one dimension is designated as the ordering dimension, and the implementation and asymptotic complexity is similar to that of the binary tree or multi-way tree embodiments.

In a fifth embodiment, key-spaces are encoded as a spatial index structure (e.g. an R-tree, kD-tree, BSP-tree, etc.). Unlike binary trees and B+-trees, such data structures may not require an ordering dimension, as their balancing algorithm seeks a compromise whereby any dimension can be queried with reasonable efficiency. Some spatial index structures, such as R-trees, require a notion of distance between two coordinates in order for their balancing algorithm to produce an efficient hierarchy of bounding rectangles. For details on how a distance function may be defined, refer to the discussion above. Other embodiments may employ a process known as tokenization (also defined below) to convert mixed coordinates into numeric (integer) coordinates, for which the distance may be found using the Pythagorean theorem as noted above. As one of ordinary skill in the art realizes, these data structures natively operate on k-intervals; so their add( ), remove( ) and find(operations correspond directly to native operations provided by the structures in question.

It should be noted that embodiments according to this disclosure may use any suitable data structure for encoding key-spaces, and may use different data structures, or combinations of data structures, for different purposes. For example, one embodiment uses arrays for encoding small key-spaces (those comprising few k-intervals), and a pair of B+ trees, ordered by the two most commonly queried dimensions, for encoding larger key-spaces (those comprising many k-intervals).

### Implementing Key-space Operations

Having discussed some options for key-space data structures, we shall now introduce the basic key-space operations provided by some embodiments according to this disclosure. These operations, which are depicted in FIG. 6, are: union( ) 600, intersection( ) 610, and difference( ) 620, which compute the corresponding set operation on two key-spaces of equal dimensionality; product( ) 630, 640, which combines two key-spaces to produce a new key-space of higher dimensionality; and project(, which extracts one or more dimensions from a key-space, producing a key-space of lower dimensionality. Additionally, we define the measure( ) operation, which computes a number representing the volume of the given key-space as described above.

It should be noted that these operations are merely examples, and that embodiments according to this disclosure may provide a subset of these operations, or provide different operations which achieve similar results. Moreover, some operations that are “fundamental” in this example may be derived from other operations in some embodiments, and vice versa.

In order to simplify the example implementation of these operations, we shall first define a few auxiliary operations. As noted above, some embodiments according to this disclosure may have different fundamental operations, or may implement the same fundamental operations in a different way than in the example presented here. In such cases, these auxiliary operations may not be required at all.

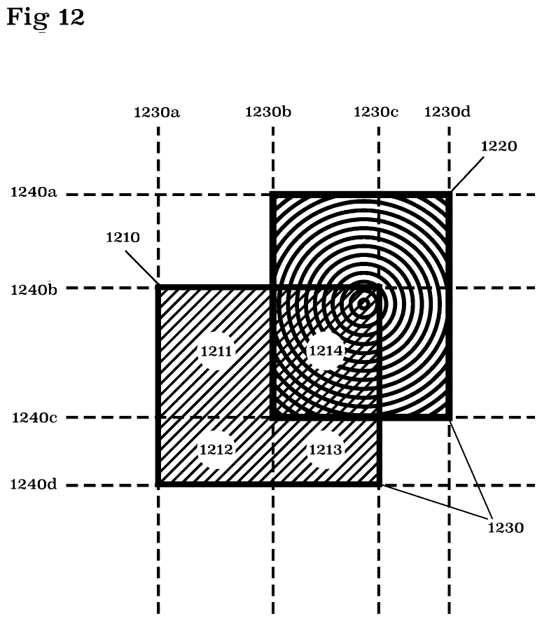

The first auxiliary operation, kIntervalDifference( ) computes the difference between two k-intervals of equal dimensionality. FIG. 12 shows an example of applying the kIntervalDifference( ) operation to a pair of two-dimensional k-intervals 1210 and 1220. In this example, the algorithm is as follows: first, we compile a list of the start and end coordinates of each rectangle, in each dimension, resulting in the grid formed by the lines 1230a-d and 1240a-d; then, we test each rectangle delineated by the grid to see whether it is contained within the input rectangles 1210 and 1220, respectively. The rectangles which are contained within 1210, but not within 1220 (which in this example would be 1211, 1212, and 1213) are added to the result set. As can be seen from the figure, these rectangles cover exactly the part of rectangle 1210 which does not overlap with rectangle 1220. One of ordinary skill in the art realizes how this algorithm may be generalized to higher dimensionality.

The second auxiliary operation, kIntervalIntersection( ), computes the intersection between two k-intervals. Referring again to FIG. 12, the intersection between k-intervals 1210 and 1220 is computed by finding the smallest and largest coordinate, per axis, which is contained within both k-intervals. In this case, we find 1230b and 1230c to be the smallest and largest coordinates, respectively, on the horizontal axis, and 1240b and 1240c to be the smallest and largest coordinates, respectively, on the vertical axis. The rectangle defined by these coordinates is 1214, which is the result of the operation.

The third auxiliary operation, excavate( ), removes any overlap from a set of disjoint k-intervals with the given k-interval. An example implementation is described below:

```
function excavate(set: KIntervalSet, ki: KInterval): void {
  let overlapping = set.find(ki);
  for (const overlapKi of overlapping) {
    set.remove(overlapKi);
    let shards = kIntervalDifference(overlapKi, ki);
    for (let shard of shards) {
      set.add(shard);
    }
  }
}
```

The union( ) operation 600 can be intuitively understood as producing the space which contains everything contained by either of its arguments. It may be defined as follows:

```
function union(left: KIntervalSet, right: KIntervalSet): KIntervalSet {
  let result = left.copy( );
  for (let ki of right.enumerate( )) {
    excavate(result, ki);
    result.add(ki);
  }
  return result;
}
```

The intersection(operation 610 can be understood as producing the space which contains everything contained by both of its arguments. It may be defined as follows:

```
function intersection(
  left: KIntervalSet,
  right: KIntervalSet
): KIntervalSet {
  let result = new ArrayKIntervalSet( );
  for (let leftKi of left.enumerate( )) {
    for (let rightKi of right.enumerate( )) {
      let ki = kIntervalIntersection(leftKi, rightKi);
      if (ki != null) {
        result.add(ki);
      }
    }
  }
  return result;
}
```

The difference( ) operation 620 can be understood as producing the space containing everything contained by its left argument, but not by its right argument. It may be defined in pseudocode as follows:

```
function difference(
  left: KIntervalSet.
  right: KIntervalSet
): KIntervalSet {
  let result = left.copy( );
  for (let ki of right.enumerate( )) {
    excavate(result, ki);
  }
  return result;
}
```

The product( ) operation 640 takes two spaces (which may be of different dimensionality) and produces a new space whose dimensionality is the sum of the dimensionalities of the argument spaces. It accomplishes this by finding each pair of k-intervals in the two spaces, and forming a new k-interval by concatenating their start and end coordinates. It may be implemented as follows:

```
function product(
  left: KIntervalSet,
  right: KIntervalSet
): KIntervalSet {
  let result = new ArrayKIntervalSet( );
  for (let leftKi of left.enumerate( )) {
    for (let rightKi of right.enumerate( )) {
      // Concatenate dimensions.
      let prodKi: KInterval = {
        min: [...leftKi.min, ...rightKi.min],
        max: [...leftKi.max, ...rightKi.max]
      };
      result.add(prodKi);
    }
  }
  return result;
}
```

One way the product(operation may be used in key-space databases is to construct spaces representing semantic propositions from lower-dimensional spaces representing the components of the fact. For example, if we want to store the statement that “Abe Lincoln likes Mary's maple syrup”, we may begin by identifying the semantic roles that appear in the statement: “Abe Lincoln” is the subject, “likes” is the predicate, and “Mary's maple syrup” is the object. If we take abe_lincoln to be a 1-space representing Abe, likes to be a 1-space representing the “likes” predicate, and marys_maple_syrup to be a 1-space representing the maple syrup made by Mary, we may form a 3-space representing the statement using: product(product(abe_lincoln, likes), marys_maple_syrup).

The project) operation may be considered almost an inverse of product(, in that it extracts a lower-dimensional space from a higher-dimensional space. It may do so by discarding all but one (or a few) coordinates from each k-interval in the higher-dimensional space, forming a new lower-dimensional space from the “clipped” k-intervals. We may implement it as follows:

```
function project(
  set: KIntervalSet,
  dimensions: number[ ]
): KIntervalSet {
  let result = new ArrayKIntervalSet( );
  for (let ki of set.enumerate( )) {
    let min: SemanticCoordinate[ ] = [ ];
    let max: SemanticCoordinate[ ] = [ ];
    for (let dim of dimensions) {
      min.push(ki.min[dim]);
      max.push(ki.max[dim]);
    }
    let projKi: KInterval = { min, max };
    excavate(result, projKi);
    result.add(projKi);
  }
  return result;
}
```

The project(operation may be useful, for example, when one has a 3-space representing a semantic fact, and wants to extract (isolate) one of the semantic roles, such as the subject (the first dimension in this example). It could then be accomplished like so: project(semanticFact, [0]).

The measure( ) operation may be used to determine the quantity or magnitude represented by a given key-space. In a numeric coordinate system, the measure may be trivially computed by taking the product of the absolute differences between the minimum and maximum coordinates along an axis. However, in a mixed coordinate system, it may be necessary to define the notion of distance between non-numeric coordinates. For example, in a mixed coordinate system where coordinates are represented as sequences of symbolic and quantitative components, one possible definition of distance is as follows. If two coordinates share a common prefix of identical coordinate components, and both end in a quantitative component, then the distance between them is equal to the absolute value of the difference between their final quantitative components. Otherwise, the distance is considered “infinite”. This example logic is implemented in the auxiliary SemanticCoordinate.distance( ) function, which may be defined as follows:

```
namespace SemanticCoordinate {
  function distance(
    a: SemanticCoordinate,
    b: SemanticCoordinate
  ): number {
    // Must have same length.
    if (a.length != b.length) {
      return Infinity;
    }
    // Empty coordinates have distance 0.
    if (a.length == 0) {
      return 0;
    }
    // Check that last components are numbers.
    let aLast = a[a.length − 1];
    let bLast = b[b.length − 1];
    if (typeof aLast !== “number” || typeofbLast !== “number”) {
      return Infinity;
    }
    // Check that all preceding components are identical.
    for (let i = 0; i < a.length − 1; i++) {
      if (a[i] != b[i]) {
        return Infinity;
      }
    }
    // Return absolute difference of last components.
    return Math.abs(bLast − aLast);
  }
}
```

Using this auxiliary function, we may define measure( ) by summing the measures of the k-intervals in the set:

```
function measure(set: KIntervalSet, dimension: number): number {
  let result = 0;
  for (let ki of set.enumerate( )) {
    result += SemanticCoordinate.distance(
      ki.min[dimension],
      ki.max[dimension]
    );
  }
  return result;
}
```

As noted above, the measure( ) operation may be used to answer questions like “how much” or “how many” about a space. For example, consider the 3-space from the example above, representing the fact that Abe Lincoln likes Mary's maple syrup. If we want to know how much maple syrup (measured in liters) Abe likes, we may apply the measure( ) operation to the object dimension (which has index 2), like so: measure(semanticFact, 2).

Although the measure( ) operation described above works with one dimension at a time, some embodiments may allow a measure to be computed for one or more dimensions at once. For example, in some embodiments, the measure of a k-dimensional space is the product of the measures along each of the k dimensions—that is, the “volume” of the space. In addition, some embodiments may choose to forgo the concept of measure altogether.

One benefit that the key-space paradigm may have over traditional database paradigms, is that it may allow both discrete and non-discrete objects to be represented in an invariant way. For example, a single person (a discrete object) may be represented by a 1-space of measure 1; similarly, 3.25 liters of maple syrup (a non-discrete object) may be represented by a 1-space of measure 3.25. However, it may sometimes be useful to be able to partition a key-space representing discrete objects into subspaces of a particular measure, e.g. to enable iteration over “each item on the order”, “each user in the group”, etc. To this end, some embodiments according to this disclosure may provide a slice( ) operation, which “slices” a key-space, along a given dimension, into disjoint sub-spaces, each of the same measure, whose union equals the sliced space. This operation requires that the min and max coordinates share a common prefix, both end with numeric values, the max is finite, and the interval's extent is evenly divisible by the slice measure.

```
function slice(set: KIntervalSet, dimension: number, measure: number):
KIntervalSet[ ] {
  assert(measure > 0);
  const results: KIntervalSet[ ] = [ ];
  for (const ki of set.enumerate( )) {
    const minCoord = ki.min[dimension], maxCoord =
    ki.max[dimension];
    const minLast = minCoord[minCoord.length − 1];
    const maxLast = maxCoord[maxCoord.length − 1];
    assert(typeof minLast === “number”);
    assert(typeof maxLast === “number”);
    assert(isFinite(maxLast as number));
    const minNum = minLast as number;
    const maxNum = maxLast as number;
    const minPrefix = minCoord.slice(0, −1);
    const maxPrefix = maxCoord.slice(0, −1);
    assert(
      minPrefix.length === maxPrefix.length &&
      minPrefix.every((c, i) => c === maxPrefix[i])
    );
    const dist = maxNum − minNum;
    assert(dist % measure === 0);
    for (let pos = minNum, idx = 0; pos < maxNum; pos += measure,
    idx++) {
      const slicedKi: KInterval = {
        min: ki.min.map((c, i) => i === dimension ? [...minPrefix,
        pos] : c),
        max: ki.max.map((c, i) => i === dimension ? [...minPrefix,
        pos + measure] : c)
      };
      while (results.length <= idx) results.push(new ArrayKIntervalSet(
      ));
      results[idx].add(slicedKi);
    }
  }
  return results;
}
```

For example, slice({[“Person”, 0 . . . 3]}, 0, 1) produces three key-space descriptors: {[“Person”, 0 . . . 1]}, {[“Person”, 1 . . . 2]}, and {[“Person”, 2 . . . 3]}.

### Key-Space Databases

A Key-space Database (KEY-SPACE DB) stores one or more key-spaces, and provides means by which an application or user of the KEY-SPACE DB may read and/or write the stored spaces. They may take various forms, including but not limited to database management systems (DBMS) which interact with client applications over a network connection, software libraries which may be embedded within applications (e.g. running on a mobile device), hardware devices specialized for storing key-spaces (e.g. a PCIe card); or distributed database systems comprising a plurality of homogeneous or heterogeneous components spanning a plurality of servers in a cluster.

A KEY-SPACE DB may use a variety of data structures for storing and manipulating key-spaces, including but not limited to arrays, binary trees, B-trees, skip lists, R-trees, etc., as described above. Some embodiments may use one data structure for each stored key-space, while other embodiments may use a plurality of structures. For example, some embodiments may use one data structure for primary storage of a key-space, but maintain auxiliary data structures (often referred to as indexes) to improve performance for certain access patterns or types of operations. Generally, any suitable data structure or combination of data structures may be used in various embodiments.

Some embodiments are transactional, meaning that the stored key-spaces may be read from and written to in the context of a database transaction. Such embodiments may achieve one or more of the ACID (Atomicity, Consistency, Isolation and Durability) properties, which one of ordinary skill in the art will be well acquainted with, or may use some other framework for transactional correctness.

Some embodiments feature persistence, meaning that the stored key-spaces, or some information which may be used to recover them, are recorded in non-volatile memory. For example, one embodiment periodically saves a snapshot of the stored key-spaces in files stored on an NVMe SSD. Another embodiment appends to a write-ahead log (WAL), kept on a cloud storage service, from which the stored key-spaces may be reconstructed.

Distributed embodiments according to the present disclosure may strike various balances with respect to Consistency, Availability and Partition tolerance (known from the CAP theorem). For example, one embodiment offers availability even in the face of partitions (i.e. an AP system), adopting eventual consistency (EC) to ensure that the state of the stored key-spaces eventually converges across the nodes that make up the system. Another embodiment provides strong consistency, but sacrifices availability in the event of a network partition (i.e. a CA system). Such embodiments may also achieve some or all of the ACID properties referenced above.

A KEY-SPACE DB may provide various mechanisms through which applications and users of the KEY-SPACE DB may access or manipulate the stored spaces, manage transactions, perform administrative tasks, etc. Depending on the kind of KEY-SPACE DB, these mechanisms may be invoked in various ways, including but not limited to local procedure calls, system calls, network requests (such as HTTP requests, UDP datagrams, remote procedure calls, etc.), file transfers, commands sent over a data bus (e.g. a USB or PCIe bus), or Inter-Process Communication mechanism (e.g. named pipes, shared memory, UNIX sockets, etc.). Recognizing that such mechanisms may eventually result in a procedure call being made, whether in the KEY-SPACE DB itself or in a supporting library, we shall refer to them collectively as “instructions” throughout this disclosure. For example, when we say that the KEY-SPACE DB “receives a data-retrieval instruction”, it could refer to a local readSpace( ) procedure call, a system call to a kernel-integrated KEY-SPACE DB, a network message containing a read instruction, a deposited query file, data sent on a named pipe, etc.

Users of a KEY-SPACE DB, such as applications and database administrators, may have various ways to access the database. In some embodiments, the KEY-SPACE DB provides a query language which can be used to read, and sometimes write, the stored key-spaces.

For example, a query such as SELECT MEASURE(p.made) FROM Person p, MapleSyrup s WHERE p.lastName=“Lincoln” AND p.made=s might be used to find out how much maple syrup was made by people whose last name is Lincoln.

Some embodiments may also allow using the query language to update the stored key-spaces. For example, a query such as INSERT INTO Person(firstName, lastName) VALUES(“Julius”, “Caesar”) might be used to update a stored key-space to reflect the fact that there is a person named Julius Caesar. Similarly, if we want to update a stored key-space to reflect the fact that all presidents like maple syrup, it might be accomplished with a query such as UPDATE Person SET likes=maple_syrup WHERE occupation=“President”.

The query language may also feature a syntax for managing transactions, such as allowing a transaction to be started using BEGIN TRANSACTION, committed using COMMIT TRANSACTION, or rolled back (canceled) using ROLLBACK TRANSACTION, etc.

In the above query examples, the symbols Person, MapleSyrup, etc., represent types, which may exist in some embodiments. 1-spaces may be instances of such types—for example, the 1-space “abe_lincoln” may be an instance of the Person type, while the 1-space “some_syrup” may be an instance of the MapleSyrup type. There are many different ways in which it may be determined whether a 1-space is an instance of a type. In one example, types correspond to semantic coordinate intervals, such as [“syrup/maple_syrup/”; “syrup/maple_syrup/□”) in which case a 1-space may be an instance of the type if it is contained within this interval, as is the case with e.g. the 1-space encoded as the 1-interval set {[“syrup/maple_syrup/3”; “syrup/maple_syrup/6.5”)}, but not the 1-space encoded as {[“persons/3”; “persons/4”)}. In another example, instances are associated with their type using a predicate such as ofType, by storing the 3-space “some syrup ofType maple syrup type “. It should be noted that some embodiments may have a different notion of types than that which is described in the above example, or have no notion types at all.

It should be noted that the syntax used for the queries above is simply an example. As one of ordinary skill in the art realizes, there are many different styles of query languages, some of which may be specialized for a particular database paradigm, while others may be adaptable for use in several different database paradigms. Generally, embodiments according to the present disclosure may use any suitable query language, or may forgo the use of a query language altogether.

### Processing Data-Retrieval and Data-Update Instructions

In the above examples, we have seen how query languages and software libraries may be used to issue data-retrieval and data-update instructions to a KEY-SPACE DB. For example, we have seen that a data-retrieval instruction may be issued using a query, such as SELECT firstName FROM Person WHERE lastName=“Lincoln”, or using an attribute access expression in an object-oriented language, such as print(p.firstName) (where p is an instance of class Person). Similarly, we have seen how data-update instructions may be issued using queries like UPDATE MapleSyrup SET color=yellow, or attribute assignment expressions, such as syrup.color=new Color(“Yellow”).

Upon receiving a data-retrieval instruction, a KEY-SPACE DB may generate one or more query spaces, which are to be intersected with the stored key-space, from the instruction. The process of generating these query spaces may be quite different depending on the form of the data-retrieval instruction. For example, if the data-retrieval instruction comprises a database query, the KEY-SPACE DB may first parse the query, potentially run it through a query optimizer, and finally execute it. While the execution of a database query may be very complex and involve a wide variety of different operations (such as filtering, joining, sorting, aggregation, etc.), it may ultimately involve intersecting one or more query spaces with the stored key-space. By contrast, if the data-retrieval instruction is issued by an Object/Key-space Mapper software library, it may already comprise one or more query spaces, as seen in the example above. Generally, embodiments according to this disclosure may receive data-retrieval instructions comprising any kind of data from which query spaces may be generated.

Once one or more query spaces have been generated from a data-retrieval instruction, a simple, non-transactional embodiment may use a function like the one illustrated below to carry out the intersections:

```
function read(
  querySpace: KIntervalSet
): KIntervalSet {
  // Compute the intersection of the query space
  // with the stored space.
  return intersect(
    querySpace,
    storedSpace
  );
}
```

The process of generating a response to the instruction may vary depending on the form of the instruction. For example, if the instruction comprises a database query, the intersections computed with the function above may participate in a larger computation—e.g. involving filtering, joining, sorting, etc.—before the final result may be determined and a response to the instruction generated. By contrast, if the instruction simply comprises one or more query spaces to intersect with the stored space, the response may simply comprise the resulting intersection spaces, or some projection from them (e.g. to extract the object dimension as seen in the OKSM example above). The foregoing examples shall not be construed as limiting the scope of the disclosure.

Upon receiving a data-update instruction, a KEY-SPACE DB may generate one or more key-spaces which are to be added to, or removed from, the stored key-space. As with data-retrieval instructions, the process of generating these spaces may vary depending on the form of the instruction. If the instruction comprises a query, such as UPDATE Person SET likes=maple_syrup WHERE occupation=“President”, additional computations, such as filtering and joining, may be required in order to determine which spaces are to be added or removed. By contrast, if the data-update instruction is issued by an OKSM library, it may already comprise one or more spaces to be added or removed (as is the case in the firstName example given above), in which case the process of generating them may simply involve extracting them from the arguments to the instruction. Generally, embodiments according to this disclosure may receive data-update instructions comprising any kind of data from which spaces to be added or removed can be generated.

Once one or more spaces to be added to or removed from the stored key-space have been generated from a data-update instruction, a simple, non-transactional embodiment may use functions like the ones illustrated below to carry out the additions and removals:

```
function add(space: KIntervalSet): void {
  // Update the stored space to reflect the union
  // of the initial stored space with the given space.
  storedSpace = union(storedSpace, space);
}
function remove(space: KIntervalSet): void {
  // Update the stored space to reflect the difference
  // between the initial stored space and the given space.
  storedSpace = difference(storedSpace, space);
}
```

As noted above, some embodiments according to this disclosure may comprise transactional KEY-SPACE DBs. In a transactional KEY-SPACE DB, the read and write procedures described in the examples above may not be appropriate, as they provide direct access to the stored key-spaces, making it difficult to achieve properties such as atomicity, isolation and consistency. Consequently, a transactional KEY-SPACE DB may involve different procedures, structured around a concurrency control mechanism.

Briefly, a concurrency control mechanism allows concurrently executing transactions to interact with the database safely, managing conflicts in a way that preserves data integrity during simultaneous access. Various types of concurrency control mechanisms may be used in different embodiments, including but not limited to:
Two-phase locking (2PL), which ensures transaction serializability by regulating the acquisition and release of locks in two phases. In the first phase, known as the growing phase, a transaction acquires all necessary locks but does not release any. Once all locks are obtained, the transaction moves to the shrinking phase, where it releases locks but cannot acquire new ones. While 2PL prevents certain types of conflicts, it can also lead to issues like deadlocks, where transactions are indefinitely waiting on each other to release locks.
Multi-Version Concurrency Control (MVCC), which maintains multiple versions of data to allow transactions to operate on consistent snapshots of the database without locking. Each transaction sees a version of the data as it existed at the time the transaction started, enabling reads to proceed without being blocked by writes. Once a transaction is ready to commit, MVCC may check for conflicts with other transactions that have committed in the meantime. While MVCC may reduce contention and improve performance for read-heavy workloads, it can increase storage overhead due to maintaining multiple data versions.
Optimistic Concurrency Control (OCC), which assumes conflicts between transactions are rare, allowing transactions to execute without acquiring locks during the initial read and computation phases. At the end of the transaction, during the commit phase, OCC may check for conflicts by validating that no other transaction has modified the data it read. If conflicts are detected, the transaction is rolled back and may be retried. OCC can work well in low-contention environments but may lead to high rollback rates and wasted work in systems with frequent conflicts.

In the following example, we will show how a hybrid concurrency control mechanism, incorporating aspects of both OCC and MVCC, may be used to implement transactions in a KEY-SPACE DB, and explain how it achieves the properties of atomicity, consistency, isolation and durability.

In this example, data-retrieval and data-update instructions are handled within a transactional context (the details of which will be outlined below). When a transaction starts, it records the current database generation number. The generation number starts at 0, and is incremented every time a transaction successfully commits. This number will be used during commit validation, as explained below. Each transaction in this example also maintains a read list, which collects all query spaces used in data-retrieval instructions, as well as a write list comprising an added space (that which has been added during the transaction) and a removed space (that which has been removed during the transaction) which together collect the results of data-update instructions issued within the context of the transaction. The read space may be used for transaction validation, while the write list's added and removed spaces may be thought of as a private workspace where the transaction's changes are recorded and kept until the transaction is committed. This allows the transaction to observe the consequences of its own changes during reads, while keeping those changes isolated from other transactions. In one example, the transaction data type may be defined as follows:

```
type Transaction = {
  startGeneration: number;
  readList: KIntervalSet;
  writeList: {
    added: KIntervalSet;
    removed: KIntervalSet;
  };
}
```

In order to provide each transaction with a view of the committed database state as of the generation in which the transaction started (its snapshot), the key-space database in this example uses a multi-versioned implementation of the KIntervalSet interface for its stored key-spaces. It stores k-intervals augmented with a range of generations during which they are visible/valid. When enumerating k-intervals, or searching for k-intervals overlapping another interval, it excludes k-intervals which aren't visible in the context generation (as determined by the contextGeneration property). When a k-interval is added, it is marked as valid from the context generation, and until Infinity. Conversely, when a k-interval is removed, it is simply marked as valid until the context generation. It may be implemented as follows:

```
type VersionedInterval = {
  // Minimum generation (inclusive) where this interval is visible.
  validFrom: number;
  // Maximum generation (exclusive) where this interval is visible.
  validUntil: number;
  // The interval itself.
  interval: KInterval;
}
class MultiversionedKIntervalSet implements KIntervalSet {
private versionedIntervals: VersionedInterval[ ] = [ ];
// The current generation context for read/write operations.
public contextGeneration: number;
find(queryKi: KInterval): KInterval[ ] {
    let gen = this.contextGeneration;
    let result: KInterval[ ] = [ ];
    for (let vi of this.versionedIntervals) {
      if (vi.validFrom <= gen && gen < vi.validUntil) {
        if (kIntervalIntersection(vi.interval, queryKi) != null) {
          result.push(vi.interval);
        }
      }
    }
    return result;
  }
  add(ki: KInterval): void {
    this.versionedIntervals.push({
      interval: ki,
      validFrom: this.contextGeneration,
      validUntil: Infinity
    });
  }
  remove(ki: KInterval): void {
    let gen = this.contextGeneration;
    for (let vi of this.versionedIntervals) {
      if (vi.interval == ki) {
        assert(vi.validFrom <= gen && gen < vi.validUntil);
        vi.validUntil = gen;
      }
    }
  }
}
```

In this example of a transactional key-space database, the read(operation first computes the intersection of the query space with the transaction's snapshot of the stored key-space. In order for the transaction to observe the consequences of its own writes, the additions and removals from its write list are then overlaid onto the intermediate result to produce the final intersection. It may be implemented as follows:

```
function read(
  txn: Transaction,
  querySpace: KIntervalSet
): KIntervalSet {
  // Record this read for conflict detection.
  txn.readList = union(txn.readList, querySpace);
  // Read from the database at the transaction's snapshot generation.
  storedSpace.contextGeneration = txn.startGeneration;
  let snapshotIntersect = intersection(storedSpace, querySpace);
  // Account for pending writes in this transaction.
  let addedIntersect = intersection(
    txn.writeList.added,
    querySpace
  );
  let removedIntersect = intersection(
    txn.writeList.removed,
    querySpace
  );
  // Result = (snapshot + added) − removed.
  let combined = union(snapshotIntersect, addedIntersect);
  let result = difference(combined, removedIntersect);
  return result;
}
```

The add( ) and remove( ) operations may also be replaced with transaction-aware implementations. In this example, they do not update the stored space directly; instead, they record the changes generated from the data-update instruction in the added and removed spaces of the transaction's write list. This may benefit atomicity, because there may not be any need to undo changes to primary storage structures when a transaction is rolled back. It may also benefit isolation, by keeping a transaction's changes in a separate data structure not visible to other transactions. The operations may be implemented as follows:

```
function add(txn: Transaction, space: KIntervalSet): void {
  // Record the addition in the transaction's added space.
  txn.writeList.added = union(txn.writeList.added, space);
  // Ensure that it isn't in the removed space if previously removed.
  txn.writeList.removed = difference(txn.writeList.removed, space);
}
function remove(txn: Transaction, space: KIntervalSet): void {
  // Record the removal in the transaction's removed space.
  txn.writeList.removed = union(txn.writeList.removed, space);
  // Ensure that it isn't in the added space if previously added.
  txn.writeList.added = difference(txn.writeList.added, space);
}
```

In this example, the commit process comprises the following steps:
1. detecting any conflicts that may prevent the transaction from committing;
2. recording the effects of the transaction in the transaction log;
3. incrementing the database generation number;
4. updating the stored space to reflect the effects of the transaction; and
5. signaling that the commit was successful.

It may be implemented as follows:

```
function commitTransaction(txn: Transaction): boolean {
  // Validate the transaction for conflicts.
  let hasConflicts = detectConflicts(txn);
  if (hasConflicts) {
    // Commit failed due to conflicts.
    return false;
  }
  // Calculate the new commit generation.
  let newGeneration = getLastGeneration( ) + 1;
  // Apply the transaction's changes to the stored space
  // at the new generation.
  storedSpace.contextGeneration = newGeneration;
  // First execute removals ...
  for (let interval of txn.writeList.removed.enumerate( )) {
    excavate(storedSpace, interval);
  }
  // ... then execute additions.
  for (let interval of txn.writeList.added.enumerate( )) {
    excavate(storedSpace, interval);
    storedSpace.add(interval);
  }
  // Record the transaction in the durable transaction log.
  writeTransactionToLog(txn, newGeneration);
  // Commit succeeded.
  return true;
}
```

The conflict detection step may be implemented by comparing the read space of the committing transaction with the write list (added and removed spaces) of each transaction which has committed after the committing transaction started, and signaling a conflict if an overlap is found. The intuition is that the changes made by a transaction may be based on what it read, so if a concurrent transaction has changed something that was read by the committing transaction, the committing transaction's changes may have been made based on assumptions that are no longer valid. A typical example of this involves a banking application tasked with transferring money from one account to another. First, the application checks to see whether the source account has sufficient balance for the transfer to proceed (a read). If so, it decreases the balance of the source account (a first write), and increases the balance of the destination account (a second write), by the transferred amount. Clearly, if some concurrent transaction managed to change the balance of the source account (and commit) prior to the former transaction committing, the commit should be rejected, lest the source account become overdrawn. With this in mind, the conflict detection procedure may be implemented as follows:

```
function detectConflicts(txn: Transaction): boolean {
  // Check all transactions committed after the transaction started.
  for (
    let gen = txn.startGeneration + 1;
    gen < transactionLog.length;
    gen++
  ) {
    let committedTxn = transactionLog[gen];
    // Combine added and removed regions - both represent writes.
    let writtenSpace = union(
      committedTxn.writeList.added,
      committedTxn.writeList.removed
    );
    // Check for intersection with txn's read list.
    let conflicts = intersection(writtenSpace, txn.readList);
    if (!isEmpty(conflicts)) {
      // Conflict detected - transaction read stale data.
      return true;
    }
  }
  // No conflicts detected.
  return false;
}
```

We may now consider how this example key-space database achieves the ACID properties.

Atomicity is achieved because (a) the transaction keeps its changes in a private workspace until it is ready to commit; (b) the stored data is updated only once the transaction is committed; and (c) all changes are applied at once, in an uninterruptible manner. This ensures that either all changes are successfully applied or none at all.

Consistency is achieved through a combination of Atomicity, Isolation, and application-defined constraints. Even without constraint mechanisms built into the database, the application may enforce consistency by checking constraints eagerly during the execution of each transaction. Atomicity ensures that changes are applied in a complete and indivisible manner, while Isolation ensures that no other transaction interferes, allowing any constraint violations to be detected and handled immediately as the transaction progresses.

Isolation is achieved to a high degree because transactions cannot observe the effects of concurrent transactions, regardless of whether those transactions have been committed. Additionally, transactions are only allowed to commit if none of the data they have read has been modified by a concurrent, committed transaction. As a result, the interleaved execution of multiple concurrent transactions produces the same outcome as if the transactions had been executed serially. This satisfies the criteria for serializable isolation.

Durability is ensured by recording the effects of a committing transaction in the transaction log before signaling the commit as successful. Since the transaction log is stored in non-volatile memory, the database state can be recovered, including the effects of all committed transactions, by replaying the transaction log.

It is important to note that the example above illustrates just one way transactions might be implemented in a KEY-SPACE DB. Generally, any suitable technique may be used to achieve transaction atomicity, consistency, isolation and durability. Additionally, some embodiments described in this disclosure may not provide transactional support at all.

### Object/Key-Space Mapper

In some embodiments, the KEY-SPACE DB may be accessed using a software library that adapts the key-space paradigm to an object-oriented (OO) language. In relational databases, such software libraries are often referred to as “Object/Relational Mappers” (ORMs), so we use the term “Object/Key-space Mapper” (OKSM) for a corresponding key-space software library. In some embodiments, an OKSM may access the KEY-SPACE DB indirectly using a query language, while in others it may make direct calls to read and write stored key-spaces. As noted above, the KEY-SPACE DB may take various forms, including a database management system running on a separate server, a software library embedded within the application, or other configurations. Consequently, communication between the OKSM and the database engine may occur via network requests, local procedure calls, or any other suitable mechanism.

### Base Class and Type Definitions

Embodiments featuring an OKSM may allow types to be defined using classes. A base class may serve as a common ancestor for user-defined types, containing a reference to the key-space that the object encapsulates:

```
// Base class for all database-mapped classes.
class DbObject {
  // The key-space (described by a k-interval set) that may serve as
  // the primary key for this data object.
  primaryKey: KIntervalSet;
  constructor(measure: number) {
    // The type path may be inferred from the class hierarchy.
    let typePath = inferTypePath(this);
    this.primaryKey = allocateSpace(typePath, measure);
  }
}
function inferTypePath(obj: DbObject): string[ ] {
  // Walks the prototype chain to collect type names.
  // For example, a MapleSyrup instance may yield [“Syrup”,
  “MapleSyrup”].
  let path: string[ ] = [ ];
  let proto = Object.getPrototypeOf(obj);
  while (proto && proto.constructor !== DbObject) {
    path.unshift(proto.constructor.name);
    proto = Object.getPrototypeOf(proto);
  }
  return path;
}
function allocateSpace(typePath: string[ ], measure: number):
KIntervalSet {
  // Generates or retrieves a partitional component for this
  allocation context.
  let partition = getPartitionForCurrentContext( );
  // Finds the next available numeric range within this partition.
  let start = getNextAvailableOffset(typePath, partition);
  let end = start + measure;
  // Returns the allocated k-interval set.
  return new KIntervalSet([{
    min: [...typePath, partition, start],
    max: [...typePath, partition, end]
  }]);
}
```

User-defined types may extend this base class and declare properties using decorators or similar mechanisms:

```
@DbType
class Person extends DbObject {
  @DbProperty
  firstName: string;
  @DbProperty
  lastName: string;
  @DbProperty
  spouse: Person;
}
@DbType
class Syrup extends DbObject {
}
@DbType
class MapleSyrup extends Syrup {
}
```

In some embodiments, type hierarchies may be encoded in the corresponding k-intervals. In other embodiments, types may be attached as properties instead, allowing a single k-interval set to simultaneously satisfy multiple types.

### Space Allocation

Application code may use new expressions to create data objects:

| | |
|---|---|
| let person = new Person(1); | // Creates 1 person. |
| let people = new Person(100); | // Creates 100 persons. |
| let syrup = new MapleSyrup(3.5); | // Creates 3.5 liters |
| | of maple syrup. |

The OKSM library may handle such expressions by allocating a 1-dimensional key-space of the appropriate measure. In embodiments where type hierarchies are encoded in k-intervals, new Person(1) may result in the allocation of the k-interval set {[“Person”, “a3f7b2”, 1042 . . . 1043]}, wherein:
The prefix, comprising the symbolic component “Person”, may indicate the type of the object.
The partitional symbolic component “a3f7b2” may be used to partition the space representing persons into different parts. This partitioning may allow multiple concurrently executing transactions to allocate new, unrelated persons without causing a conflict by drawing them from the same numeric range. It may also relieve the application from having to communicate with the database server when allocating new spaces.
The numeric component range 1042 . . . 1043 may serve to distinguish the newly created person from other persons in the same partition and determines the measure of the allocated space (1).

Similarly, new MapleSyrup(3.5) may result in the allocation {[“Syrup”, “MapleSyrup”, “f7c2d1”, 500 . . . 503.5}.

### Key-Space Utility Methods

In some embodiments, the OKSM library may provide utility methods for working with data objects as key-spaces:

// Get a subset of the given measure, starting at the given offset.
let subset = dataObject.subset(offset, measure);
// Iterate over each discrete (measure 1) subset of the data object.
// Uses slice(dataObject.primaryKey, 0, 1).
for (let item of dataObject.oneByOne( )) {
// ...
}
// Get the measure of a data object.
let m1 = dataObject.measure( );
// Alternative way to get the measure, as a property accessor.
let m2 = dataObject.quantity; // same as dataObject.measure( )

These methods may enable subdivision of data objects into smaller parts, iteration over discrete units within a data object, and retrieval of the measure (quantity) represented by a data object. Embodiments according to this disclosure may implement various similar utility methods, or may forgo such methods altogether if the application does not require them.

### Types as Properties

In embodiments where types are attached as properties, new Person(1) may instead allocate a type-agnostic k-interval set such as {[“a3f7b2”, 1042 . . . 1043]}, and separately store a type assertion as a property referencing a type object:

```
class DbObject {
  primaryKey: KIntervalSet;
  constructor(measure: number) {
    this.primaryKey = allocateSpace(measure);
  }
}
class Person extends DbObject {
  constructor(measure: number) {
    super(measure);
    // Stores a type assertion for this class.
    db.writeProperty(currentTxId, this.primaryKey,
    “isA”, PersonType.primaryKey);
  }
}
```

Each class in the hierarchy may store its own type assertion, linking the data object to the corresponding type object via the isA property. This approach may allow a single data object to satisfy multiple unrelated types, which may be useful when modeling concepts that do not fit neatly into a single inheritance hierarchy.

### Property Accessor Expansion

The OKSM library may intercept reads and writes of properties and transform them into corresponding data-retrieval and data-update instructions to the database engine. In one embodiment, the OKSM may use dynamic code generation to expand @DbProperty declarations into explicit accessor methods.

For example, given the following class definition:

```
@DbType
class Person extends DbObject {
  @DbProperty
  firstName: string;
  @DbProperty
  spouse: Person;
}
```

The OKSM may expand it into:

```
class Person extends DbObject {
  get firstName( ): string {
    return spaceToString(db.readProperty(currentTxId,
    this.primaryKey, “firstName”));
  }
  set firstName(value: string) {
    db.writeProperty(currentTxId, this.primaryKey,
    “firstName”, stringToSpace(value));
  }
  get spouse( ): Person {
    return Person.fromPrimaryKey(db.readProperty(currentTxId,
    this.primaryKey, “spouse”));
  }
  set spouse(value: Person) {
    db.writeProperty(currentTxId, this.primaryKey,
    “spouse”, value.primaryKey);
  }
}
```

The db.readProperty( ) and db.writeProperty( ) calls may be implemented in various ways, depending on the embodiment.

### Native Property Instructions

In some embodiments, the database engine may natively understand property-level instructions. In such embodiments, db.readProperty( ) may send a data-retrieval instruction comprising the transaction identifier, the subject k-interval set (the data object's primary key), and the property identifier:

```
function readProperty(
  txId: TransactionId,
  subject: KIntervalSet,
  property: string
): KIntervalSet
  // Sends a READ_PROPERTY instruction to the database engine.
  return db.sendInstruction({
    type: “READ_PROPERTY”,
    txId,
    subject,
    property
  });
}
```

The database engine may process such an instruction by constructing a query space, computing its intersection with the stored key-spaces, and returning the result. Similarly, db.writeProperty( ) may send a data-update instruction comprising the transaction identifier, subject, property identifier, and the new value:

```
function writeProperty(
  txId: TransactionId,
  subject: KIntervalSet,
  property: string,
  value: KIntervalSet
): void {
  // Sends a WRITE_PROPERTY instruction to the database engine.
  db.sendInstruction({
    type: “WRITE_PROPERTY”,
    txId,
    subject,
    property,
    value
  });
}
```

The database engine may process such an instruction by first removing any existing values for the given subject and property, then adding the new value.

### Constructed Spaces

In other embodiments, the OKSM library may construct query and update spaces itself, then send them to the database engine as generic read, add, and remove calls. In such embodiments, db.readProperty( ) may construct a query space using the product(function:

```
function readProperty(
  txId: TransactionId,
  subject: KIntervalSet,
  property: string
): KIntervalSet {
  // Construct a query space by combining:
  // - Subject axis: the data object's primary key
  // - Predicate axis: the property identifier
  // - Object axis: the universal space (all possible values)
  // - Time axis: the current time (as a point or small interval)
  let querySpace = product(
    subject,
    propertyToSpace(property),
    universeSpace( ),
    currentTimeSpace( )
  );
  // Read the intersection with stored spaces.
  let result = db.read(txId, querySpace);
  // Project the object dimension to extract the property value(s).
  return project(result, [2]);
}
```

Similarly, db.writeProperty( ) may construct a removal space encompassing all possible values for the property, and an addition space containing the new value:

```
function writeProperty(
  txId: TransactionId,
  subject: KIntervalSet,
  property: string,
  value: KIntervalSet
): void {
  let property Space = propertyToSpace(property);
  // Construct a removal space encompassing all possible values for this property,
  // from the current time onwards.
  let removalSpace = product(subject, propertySpace, universeSpace( ), futureTimeSpace( ));
  // Construct an addition space with the new value, from the current time onwards.
  let additionSpace = product(subject, propertySpace, value, futureTimeSpace( ));
  // Remove any existing value(s), then add the new value.
  db.remove(txId, removalSpace);
  db.add(txId, additionSpace);
}
```

In this approach, the database engine need only provide generic read, add, and remove operations on key-spaces, while property semantics may be handled entirely by the OKSM library.

The foregoing examples illustrate two possible approaches, but embodiments according to this disclosure may use other techniques for implementing property access. For example, in some embodiments, the OKSM may generate query language statements (similar to SQL) for both data-retrieval and data-update operations, rather than sending structured instructions or constructed spaces. In other embodiments, the proxy object (such as a Person instance) may cache property values locally, fetching all properties when the object is first accessed rather than issuing a separate instruction for each property read. Generally, any suitable technique may be used in various embodiments.

### Transaction Management

To group multiple data-retrieval and data-update instructions into atomic units of work, application code may use transaction management primitives exposed by the OKSM library:

```
db.transaction(function( ) {
  let p = new Person(1);
  p.firstName = “Abe”;
  p.lastName = “Lincoln”;
});
```

The OKSM library may translate this into a sequence of primitive instructions. For example, the above code may be expanded into:

```
let txId = db.requestTransaction( );
currentTxId = txId; // Set as the current transaction for subsequent operations.
try {
  (function( ) {
    let p = new Person(1);
    p.firstName = “Abe”;
    p.lastName = “Lincoln”;
  })( );
  db.requestCommit(txId);
} catch (e) {
  db.requestRollback(txId);
  throw e;
} finally {
  currentTxId = null; // Clear the current transaction.
}
```

The OKSM library may automatically inject the current transaction identifier into the data-retrieval and data-update instructions it generates, allowing the database engine to apply visibility and conflict detection rules. If the callback completes without error, the transaction may attempt to commit; otherwise, it may roll back.

If two transactions attempt to modify overlapping key-spaces concurrently, the database engine may detect a conflict at commit time. In such cases, one transaction may succeed while the other receives a conflict error and must retry. This optimistic concurrency approach may allow higher throughput than pessimistic locking in workloads where conflicts are infrequent.

### Distributed Architecture

In some embodiments, the database engine may comprise two components that may be executed in different processes, on different machines, or otherwise separated: a data access component and a transaction validation component. The data access component may maintain data structures (such as indices) through which the contents of the database may be read, and may manage uncommitted changes for transactions in progress, generally as described above with respect to processing queries. The transaction validation component may detect conflicts between concurrent transactions and commit validated transactions to a distributed transaction log, generally as described above in the commit process.

When a transaction is ready to commit, the data access component may send the transaction to the transaction validation component for validation. Data access components may read from the distributed transaction log to update their local data structures. This separation may allow a system to scale out read workloads across many data access components while maintaining strong consistency guarantees (such as ACID properties) through a single transaction validation component. Other embodiments may employ eventually consistent variations, or other distributed architectures as appropriate for their requirements.

Conventional relational, graph, key-value and constraint database engines may represent information as discrete records having atomic primary keys, and may attach quantitative and relational properties to those records as attributes, predicates or edges. Changing quantities or ownership of only a subset of such a record may require splitting rows or nodes, introducing additional tables, or remapping identifiers, and queries may operate over finite sets of tuples or triples rather than over underlying continuous quantities. By contrast, embodiments according to the present disclosure may represent both facts and queries as regions (key-spaces) in a multi-dimensional semantic coordinate system, in which primary keys may be space descriptors recursively divisible into subkeys, quantitative properties may be obtained by measuring the extent of such spaces, and relationships may be expressed as Cartesian products of lower-dimensional spaces along semantic roles such as subject, predicate, object, time and perspective.

### Type Registration and Metadata

In some embodiments, the OKSM library may automatically register new types in the database when corresponding classes are first encountered. For example, when an application defines a class decorated with @DbType, the OKSM may register the type with the database engine before any instances are created.

In embodiments featuring a query language, it may also be possible to define new types explicitly. For example, the MapleSyrup type might be defined using a syntax such as CREATE TYPE MapleSyrup EXTENDS Symp.

Some embodiments may maintain type metadata in a metadata store, which may itself be a key-space database, a relational database, or some other persistent storage mechanism. In embodiments where the metadata store is a key-space database, type definitions may themselves be represented as key-spaces, allowing the same query and update operations to be used for both data and metadata.

### Computing Systems

Embodiments according to this disclosure may comprise various kinds of computing systems. Examples of computing systems include, but are not limited to, personal computers such as desktop or laptop computers; servers; high-performance computing (HPC) clusters; embedded devices such as microcontrollers or industrial control systems; mobile devices such as smartphones or tablets; wearable devices such as smart watches or glasses; programmable logic devices such as FPGAs and CPLDs; and specialized integrated circuits.

A plurality of computing systems may be combined to form computing clusters, and such computing clusters shall also be regarded as computing systems. For example, a plurality of servers may be interconnected in a cluster, which itself constitutes a computing system. Computing clusters may be homogeneous (composed of a plurality of computing systems of similar configuration), or heterogeneous.

Generally, a computing system may comprise a variety of hardware components, including but not limited to processing units such as central processing units (CPUs), graphics processing units (GPUs), or other auxiliary processing units; programmable or fixed-function logic devices such as Field-Programmable Gate Arrays (FPGAs), Application-Specific Integrated Circuits (ASICs) or similar; volatile and non-volatile memory such as Static RAM (SRAM), Dynamic RAM (DRAM), Non-Volatile RAM (NVRAM), Solid-State Drives (SSDs, e.g. NVMe SSD's), Hard Disk Drives (HDDs), etc.; internal and external buses such as PCIe; and Network Interface Cards (NICs) and other devices facilitating communication between computing systems.

A computing system may further comprise a variety of software components, including but not limited to operating systems (OS); software libraries such as BLAS or the Boost C++ libraries; and programming language runtimes such as a Java Virtual Machine (JVM), a JavaScript runtime, etc.

Computing systems may be virtualized. For example, a computing system may comprise one or more virtual machines (VMs), which share hardware resources like processing units, volatile and non-volatile memory, and network interfaces provided by one or more physical computers. Since a virtualized computing system generally offers the same functionality as a physical computing system, we shall, for the purposes of the present disclosure, make no distinction between the two.

As one of ordinary skill in the art realizes, a software component can generally be replaced with an equivalent hardware component, using tools such as Field-Programmable Gate Arrays (FPGAs) or Application-Specific Integrated Circuits (ASICs). Similarly, some hardware components can be replaced with equivalent software components. Consequently, we shall, for the purposes of this disclosure, make no distinction between components defined in software and components defined in hardware. That is to say, embodiments of this disclosure may be implemented exclusively using software or hardware components, or a mix of software and hardware components.

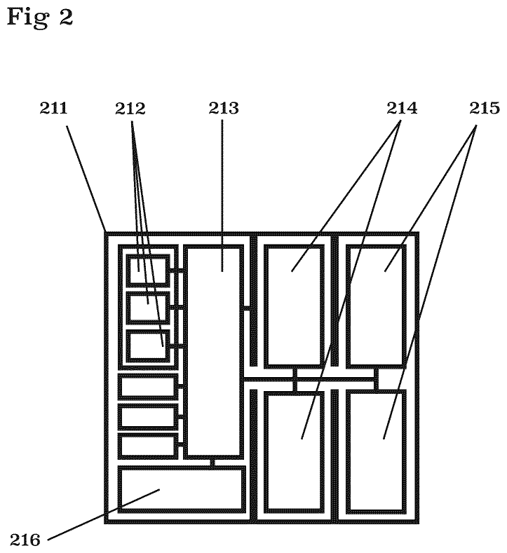

Referring now to FIG. 2, FIG. 2 shows an example of a computing system comprising a server 211, which has a processor 213, volatile memory (DRAM) modules 212, NVMe solid state drives (SSDs) 214, hard-disk drives (HDDs) 215, and a network interface card (NIC) 216.

Referring now to FIG. 1, FIG. 1 shows an example of a computing system comprising three servers 101, 111 and 121, equipped with processors 103 and 113, volatile memory (DRAM) modules 102 and 112, various storage devices including NVMe SSDs 104 and 114 and HDDs 115. The servers are interconnected by a high-speed network fabric 106, and further connected, via an router 152, to an IP network 131. Also connected to this network are end-user devices (workstations, laptops, mobile devices, etc.) 151, and output devices (displays, printers, etc.) 153.

### Traits and Multiple-Typing

In some applications, data objects may need to satisfy multiple unrelated types simultaneously. For example, a horse may be considered both an Animal (it has biological properties like species and diet) and a Vehicle (it can be ridden and has properties like manufacturer and fuel type). Traditional single-inheritance type hierarchies may not accommodate such scenarios naturally, as they require choosing a single parent type.

In embodiments where types are attached as properties (as described above), a data object may satisfy multiple types by asserting multiple isA relationships (an isA lattice). Each type—or trait—may be defined as a class in the usual manner:

```
@DbType
class Animal extends DbObject {
  @DbProperty
  species: string;
  @DbProperty
  diet: string;
}
@DbType
class Vehicle extends DbObject {
  @DbProperty
  manufacturer: string;
  @DbProperty
  fuelType: string;
}
```

A data object may then be created with a type-agnostic primary key, and traits may be asserted or retracted using static methods on the trait class:

// Allocate a type-agnostic data object.
let horse = new DbObject(1);
// Assert traits.
Animal.assign(horse);
Vehicle.assign(horse);
// Later, retract a trait.
Vehicle.unassign(horse);

The base DbObject class may include a traits property that holds the k-interval set of all assigned traits. The OKSM library may expand the static methods to perform unions and differences on this property, preserving any existing trait assignments:

```
class Animal extends DbObject {
  static assign(obj: DbObject): void {
    // Add this trait to the object's existing traits.
    obj.traits = union(obj.traits, Animal.getTrait( ));
  }
  static unassign(obj: DbObject): void {
    // Remove this trait from the object's existing traits.
    obj.traits = difference(obj.traits, Animal.getTrait( ));
  }
}
```

Once a trait is assigned, properties defined by that trait may be accessed by viewing the data object through the lens of that trait:

Animal.assign(horse);
Vehicle.assign(horse);
// Access properties through the appropriate trait.
horse.as(Animal).species = “Equus caballus”;
horse.as(Animal).diet = “herbivore”;
horse.as(Vehicle).manufacturer = “nature”;
horse.as(Vehicle).fuelType = “oats”;

Because each trait assertion is stored as a separate isA property, traits may be assigned or unassigned at any time during the lifetime of a data object.

Queries may filter data objects by trait using the same intersection mechanism as other property queries. For example, a query for “all herbivorous Animals” would intersect the query space with stored spaces where the isA property includes Animal.getTrait( ) and the diet property includes the value “herbivore”.

This approach contrasts with embodiments where type hierarchies are encoded directly in the k-interval structure. In such embodiments, a data object's type is determined by the prefix of its primary key and cannot be changed after allocation. The trait-based approach offers greater flexibility—allowing types to be added, removed, or queried dynamically—at the cost of additional property storage and potentially more complex queries.

### Semantic Feature Axes and Latent-Space Vectors

This section describes embodiments in which a Key-space Database (KEY-SPACE DB) extends its semantic coordinate system with additional feature and latent axes so that each concept represented on a subject axis can also carry a high-dimensional feature vector. These feature vectors may encode both explicit semantic traits (such as person-ness, agent-ness, animal-ness, physical-ness) and unlabeled latent dimensions derived from machine-learned models. In these embodiments, the same non-discrete key-space that already represents propositions such as “abe_lincoln likes maple_syrup” may also act as a non-tuple vector database, without introducing a separate embedding store or tuple-based records.

As described elsewhere, a KEY-SPACE DB represents data as regions (key-spaces) in a multi-dimensional semantic coordinate system whose axes may have mixed symbolic and quantitative components, and where 1-spaces, 2-spaces, 3-spaces and higher-dimensional k-spaces are combined by Cartesian product and manipulated using set-like operations such as union, intersection and difference. In such systems, quantities like “3½ liters of turbine oil” or “2 persons” are obtained by measuring the extent of a space along one or more axes rather than by reading scalar attributes from tuples. Figures in the accompanying drawings illustrate 1-spaces, 2-spaces and 3-spaces as intervals, rectangles and boxes in such coordinate systems.

The present feature adds a structured way to attach feature vectors to the same subject 1-spaces that already participate in subject-predicate-object statements. In one embodiment, each subject 1-space (for example the 1-spaces “abe_lincoln” and “mary_lincoln”) is associated with:
a set of trait axes, one per explicit semantic feature such as person-ness, agent-ness, animal-ness or physical-ness; and
a set of latent axes, one per dimension of a numeric feature vector produced by an embedding or other machine-learned model.

These additional axes coexist with the subject, predicate, object, time, perspective and other semantic axes already defined for key-spaces, and may be combined with them by Cartesian product to form higher-dimensional statements when needed.

Vector databases store dense numeric feature vectors (embeddings) in tuple-like records and provide similarity operations such as k-nearest neighbors over those vectors. While powerful for approximate similarity, such systems are disconnected from structured transactional data: there is typically a separate store for tuples and a separate store for embeddings, and keeping them aligned requires application-level bookkeeping.

In contrast, a KEY-SPACE DB already unifies quantities, identifiers and relationships as regions of a semantic key-space, using k-intervals as storage primitives. Combinatorial trait systems and tiered type systems further allow data objects to carry rich sets of types and traits, including automatically learned traits derived from latent vectors. However, the underlying latent vectors may live in an external model or index.

The feature described here removes this separation by:
representing both discrete traits and continuous feature components as intervals on dedicated feature and latent axes;
letting each subject 1-space occupy a measurable extent on these axes, so that its “feature vector” is just another projection of its key-space; and
enabling queries that combine exact semantic conditions (for example “is a dinghy”, “owned by acme_corp”) with vector-style similarity constraints (for example “close to this embedding within ε in latent space”) using the same geometric operations as other key-space queries.

This yields a design in which, for example:
a subject such as “abe_lincoln” can simultaneously be an instance of types like Person, Agent and Animal via 3-space statements;
the same subject has graded memberships along feature axes such as person-ness, agent-ness, animal-ness and physical-ness; and
the same subject has coordinates along unlabeled latent axes derived from one or more embedding models.

### Coordinate System Extensions

### Trait Feature Axes

In one embodiment, the semantic coordinate system is extended with one 1-dimensional axis per explicit trait feature. As described for mixed coordinate systems, each coordinate along such an axis may comprise a sequence of symbolic and quantitative components, for example [“trait/personness”, 0.0] through [“trait/personness”, 1.0].

For each feature axis:
the symbolic prefix (for example “trait/personness”) identifies the feature;
the final numeric component represents a graded intensity in a chosen range, typically [0.0, 1.0] or [0.0, ∞), but discrete rather than continuous ranges such as [1, 2, 3, 4] may be used in some examples; and
a 1-interval [(“trait/personness”, 0.0); (“trait/personness”, p)]encodes a person-ness measure of p for an entity, with the interval's measure equal to p under the distance definition described for mixed coordinates.

For example, the 1-space for Abe Lincoln might have:
person-ness in the interval [(“trait/personness”, 0.0); (“trait/personness”, 1.0)];
agent-ness in [(“trait/agentness”, 0.0); (“trait/agentness”, 1.0)];
animal-ness in [(“trait/animalness”, 0.0); (“trait/animalness”, 1.0)]; and
physical-ness in [(“trait/physicalness”, 0.0); (“trait/physicalness”, 1.0)].

A partially physical, partially virtual agent might instead have physical-ness [0.0; 0.3] and agent-ness [0.0; 1.0] on their respective axes, with all other semantics identical. We will recognize that the exact numeric ranges are a design choice; the key requirement is that they be expressible as intervals with a well-defined measure.

In some embodiments, these graded axes coexist with trait spaces that represent binary presence or absence as described for combinatorial traits and co-occurring type compression. A single feature such as person-ness may therefore have:
a binary trait space used for logical type membership; and
a graded axis used for similarity and numeric reasoning.

### Latent Feature Axes

In addition to human-named traits, some embodiments define a family of latent axes, one per component of a latent vector learned from text, images or other sources, as in the tiered type system.

For a latent vector of dimension d, the coordinate system may include axes:
latent/0, latent/1, . . . , latent/(d−1),

each of which uses a mixed coordinate scheme such as [“latent”, i, 0.0] to [“latent”, i, v_i], where v_i is the i-th component of the latent vector.

For example, if a learned embedding for “abe_lincoln” is

$$v ( abe ) = [ 0.12 , 1.83 , - 0.7 , … ]$$

an embodiment that restricts to non-negative components may instead store a rectified version max(0, vi) along the latent axes, or use a sign sub-partition such as [“latent”, i, “neg”, |v_i|] for negative values.

As with explicit trait axes, each latent axis is numeric and ordered, allowing the engine to express intervals, measures and distance calculations over these coordinates.

### Representing Feature Vectors as Key-Spaces

Let S be the subject axis, and suppose that a subject such as “abe_lincoln” is represented by a 1-space abe_lincoln_S on S, encoded as a set of disjoint 1-intervals as described for people and maple syrup. Let F_0, . . . , F_{k−1} be trait axes and L_0, . . . , L_{d−1} be latent axes.

In one embodiment, the combined feature vector for Abe is represented as a single (1+k+d)-interval:
dimension 0: Abe's 1-interval on S;
dimensions 1 . . . k: graded trait intervals on each F_i;
dimensions (k+1) . . . (k+d): latent intervals on each L_j.

The KInterval type from earlier sections may be used for this purpose:

$$type S emanticCoordinate = ( string \vert number ) [ ] ;$$

$$type KInternet = \{ min \text{:} SemanticCoordinate [ ] ; max \text{:} SemanticCoordinate [ ] \} ;$$

The KInterval 's min and max arrays each contain 1+k+d coordinates, one per axis.

In another embodiment, each feature dimension is stored in a separate lower-dimensional space, for example as a 2-space S×F_i or S×L_j. This may reduce the maximum dimensionality of individual k-intervals and allow different index structures to be chosen for different subsets of axes, while still preserving the logical interpretation that the union of these spaces represents the full vector.

Both encodings are equivalent up to products and projections. The choice between them may depend on anticipated query patterns and the performance characteristics of the underlying KIntervalSet implementation (arrays, trees, spatial indices, etc.).

### Example: Abe and Mary with Traits and Latent Dimensions

Consider two subjects, “abe_lincoln” and “mary_lincoln”, represented on the subject axis as disjoint 1-intervals within a people partition:
abe: [(“people”, 8); (“people”, 9)];
mary: [(“people”, 11); (“people”, 12)].

These 1-spaces already participate in 3-space statements such as “lincoln_couple made batch_of_syrup” and “abe_lincoln ate some_syrup”.

Extend the coordinate system with four trait axes and two latent axes:
trait/personness in [0.0; 1.0];
trait/agentness in [0.0; 1.0];
trait/animalness in [0.0; 1.0];
trait/physicalness in [0.0; 1.0];
latent/0 in [−3.0; 3.0];
latent/1 in [−3.0; 3.0].

Abe's graded traits might be:
person-ness [0.0; 1.0];
agent-ness [0.0; 1.0];
animal-ness [0.0; 1.0];
physical-ness [0.0; 1.0].

Mary's are identical. A service dog “buddy” might instead have person-ness [0.0; 0.0], agent-ness [0.0; 0.7], animal-ness [0.0; 1.0], physical-ness [0.0; 1.0].

Suppose further that a Tier-3 encoder produces 2-dimensional latent vectors:

$$\cdot v ( abe ) = [ 1.2 , - 0.3 ] ;$$

$$\cdot v ( mary ) = [ 1.1 , - 0.2 ] ;$$

$$\cdot v ( buddy ) = [ 0.3 , - 0.4 ] .$$

An embodiment restricting to non-negative values may map these to:
latent/0 intervals [0.0; max(0, v_0)];
latent/1 intervals [0.0; max(0, v_1)].

Alternatively, a sign sub-partition can preserve negative values without changing the interval machinery.

For Abe, a single 7-dimensional interval (subject+4 traits+2 latents) may then be constructed, and stored in a KIntervalSet that forms his feature vector property.

Mapping to and from Classical Feature Vectors

The following pseudocode shows how we may construct a k-interval encoding for a latent vector attached to a subject key. It assumes that the subject key is represented by a 1-interval on the subject axis.

```
function buildLatentSpaceForSubject(
  subjectInterval: KInterval, // 1-space on subject axis
  latent: number[ ] // v(e) of length d
): KInterval {
  const k = 1 + latent.length;
  const min: SemanticCoordinate[ ] = [ ];
  const max: SemanticCoordinate[ ] = [ ];
  // Dimension 0: subject axis, reuse existing coordinates.
  min.push(subjectInterval.min[0]);
  max.push(subjectInterval.max[0]);
  // Dimensions 1..d: latent axes.
  for (let i = 0; i < latent.length; i++) {
    const v = latent[i];
    // Example: encode as [0; v] with a “latent” prefix.
    min.push([“latent”, i, 0.0]);
    max.push([“latent”, i, v]);
  }
  return { min, max };
}
```

To recover an approximate numeric vector from such a space, the engine may inspect the coordinates on each latent axis and compute the distance between their min and max values, or simply read the terminal numeric component from max. In embodiments that use sign partitions, the sign is recovered from the symbolic component preceding the numeric value.

```
function latentSpaceToVector(latentInterval: KInterval): number[ ] {
  const dims = latentInterval.min.length;
  const result: number[ ] = [ ];
  // Dimensions 1..(dims-1) are latent axes.
  for (let i = 1; i < dims; i++) {
    const maxCoord = latentInterval.max[i];
    const last = maxCoord[maxCoord.length − 1];
    if (typeof last === “number”) {
      result.push(last);
    } else {
      // Fallback: zero or other convention.
      result.push(0.0);
    }
  }
  return result;
}
```

A similar pattern may be used for graded trait axes, with per-axis scaling (for example mapping [0;1] intervals to booleans via thresholds, or to raw floats via measure).

### Querying Over Feature and Latent Axes

Because feature and latent axes are embedded in the same semantic coordinate system as other roles, queries over them are implemented using the same geometric operations as other KEY-SPACE DB queries: intersection, difference, union, projection and measure. This section sketches common query patterns.

### Threshold Queries on Graded Traits

To find all subjects whose person-ness is at least 0.8, a query space is constructed that:
spans all subject 1-spaces of interest on the subject axis (for example the partition [“people”, 0]; [“people”, ∞)), and
restricts the trait/personness axis to [0.8; 1.0].

Intersecting this query space with the stored trait spaces yields the subset of subjects whose graded person-ness overlaps the interval [0.8; 1.0]. Projecting the result onto the subject axis produces the 1-spaces of those subjects, which may then be returned as keys or materialized as objects via the object/key-space mapper.

### Hyperrectangle Similarity Queries in Latent Space

To emulate vector-database-style similarity search, some embodiments interpret a query vector q and tolerance F as a hyperrectangle in latent space:
for each latent axis L_j, construct an interval [q_j−ε; q_j+ε] (clipped to the allowed range),
form the Cartesian product of these intervals with the universal subject space (or a filtered subject subspace),
intersect this query space with stored latent spaces, and
project onto the subject axis.

The result is the set of entities whose latent coordinates fall within an too ball of radius F around q. Other norms may be approximated using nested rectangles, or by combining this geometric filtering with a subsequent numeric scoring step that evaluates cosine or Euclidean distances for the candidates.

### Hybrid Semantic+Vector Queries

Because all roles share the same global key-space, queries may combine semantic conditions with feature constraints. For example:
restrict the subject axis to dinghy 1-spaces owned by acme_corp, via subject-predicate-object statements as in the exchange examples,
restrict trait/physicalness to [0.9; 1.01, and
restrict the latent axes to a hyperrectangle around a query embedding.

The intersection of these constraints yields a k-space whose projection onto the subject axis enumerates exactly those dinghies that are both:
semantically “dinghies owned by ACME Corp”, and
similar in latent space to some query concept, while being highly physical according to the graded trait axis.
   Integration with the Object/Key-Space Mapper

The object/key-space mapper (OKSM) already maps programming-language objects to primary key spaces and resolves property access through key-space read and write operations. In one embodiment, feature and latent vectors are exposed as regular properties on mapped classes, with accessors expanded into space-based read and write instructions.

```
@DbType
class Person extends DbObject {
  @DbProperty
  firstName: string;
  @DbProperty
  lastName: string;
  // High-dimensional latent vector.
  @DbProperty
  latentVector: number[ ];
  // Graded traits.
  @DbProperty
  personness: number;
  @DbProperty
  agentness: number;
}
```

The OKSM may expand these declarations into accessors that:
on write, construct appropriate feature or latent k-intervals using helper functions similar to buildLatentSpaceForSubject, and call db.writeProperty( ) with those spaces; and
on read, call db.readProperty( ) to obtain the relevant k-intervals, convert them back into numeric vectors using functions such as latentSpaceToVector, and return regular language-level values to the caller.

In embodiments that already implement the tiered type system, Tier-2 sparse float trait assignments (for example tier2FloatTraitValues in the illustrative tables for dinghies, yachts, companies, persons and money) can be stored directly on graded trait axes or latent axes, with the schema manager responsible for ensuring that the mapping from trait indices to axes remains consistent across entities and schema versions.

Implementation notes

Implementing this feature may proceed along the following steps:
Extend the semantic coordinate system definition to include named feature and latent axes, using the existing mixed coordinate scheme of symbolic prefixes and numeric suffixes.
Decide, per axis, the numeric range and interpretation (for example [0;1] for graded traits, [−a; a] or [0; a] for latent components).
Define helper functions that map numeric feature vectors to k-intervals and back, using the existing KInterval and KIntervalSet abstractions.
Integrate these helpers with the OKSM so that property reads and writes on feature and latent properties are translated into key-space data-retrieval and data-update instructions.
Implement index structures or spatial indices that can efficiently handle the additional axes, reusing R-trees, kD-trees or other spatial structures where appropriate.
Expose query-language constructs or library functions that let callers specify thresholds, hyperrectangles or other constraints over the new axes, which are then compiled into query spaces intersected with the stored key-space.

Because all feature information is represented as key-spaces rather than as separate tuple fields, the invariance properties of the KEY-SPACE DB extend naturally to feature vectors. The number of conceptual entities, their granularity, and the evolution of the type and trait system over time do not require schema migrations in the traditional sense; instead, new axes and spaces may be introduced as needed, while older applications continue to see projections that are compatible with their expectations.

### Predicate Axes for Feature Families

In many applications there may be multiple families of features. For example:
ontological types (Person, Company, Vehicle, Boat, Money, . . . );
physical traits (physical-ness, weight-range, size-range, . . . );
legal traits (legal-entity-ness, jurisdiction, . . . );
behavioral traits (risk-score, credit-score, . . . );
latent traits (dimensions extracted from a neural model).

There are two implementation strategies, both compatible with the existing coordinate system.

Strategy A: Single hasFeature Predicate Axis

Use a single predicate 1-space hasFeature and encode the feature family on the object axis:
john hasFeature types/person
john hasFeature traits/agent
john hasFeature traits/physical
dinghy_001 hasFeature types/boat
dinghy_001 hasFeature latent/tier2/trait_0

Here:
the subject axis carries the entity 1-spaces;
the predicate axis is usually a single space hasFeature;
the object axis is partitioned into feature families using symbolic prefixes such as types/ . . . , traits/ . . . , latent/tier2/ . . .

This keeps the dimensionality small (still a 3-space: subject×predicate×feature) while allowing arbitrarily many features.

### Strategy B: Dedicated Axes Per Feature Family

Alternatively, each feature family may be given its own axis:
subject axis: entity 1-spaces;
type axis: spans 1-spaces such as person_ness, company_ness, boat_ness;
physical axis: spans physical_ness and numeric ranges like “mass in kg”;
latent axis: spans coordinates of a latent vector, for example 512 dimensions.

A particular entity is then a region that occupies:
some 1-interval on the subject axis;
one or more intervals on each feature axis.

For example, a particular dinghy instance may occupy:
subject: [dinghy_partition/100 . . . 101)
type axis: [boat_ness/1 . . . 2)
latent axis: a small hyperrectangle [dimo/0.12 . . . 0.13)× . . . ×[dim511/−0.4 . . . −0.39).

This strategy makes some queries more direct (e.g. projecting onto a latent dimension is a simple project( ) call), at the cost of higher raw dimensionality.

Both strategies may be mixed in the same system.

### Unified View: Keys, Traits, and Vectors

With feature axes and latent spaces in place, a single entity may have:
1-space identity: e.g. [“people/<partition>/<offset . . . offset+1)”].
Tier 1 explicit types: 3-spaces like john isA Person, john isA Agent.
Tier 2 traits: 3-spaces like john hasFeature trait/tier2/3.
Tier 3 latent vector: coordinates along a latent axis.
Quantitative properties: for example “mass 70 kg” as the measure of an interval on a mass axis.
Relational propositions: john owns dinghy_001, john likes maple_syrup.

$$AGENT = \{ spaces where object = traits / agent \}$$

$$PERSON = \{ spaces where object = types / person \}$$

$$ANIMAL = \{ spaces where object = traits / animal \} .$$

All of these live in the same global key-space. Queries and updates over them are just geometric operations:
intersection( ) to match features and relations;
union( ) and difference( ) to add or remove traits;
project( ) to recover a particular feature or latent dimension;
measure( ) to convert a coordinate difference back into a numeric value.

### Query Examples

### Example 1: “Find all Agents that are Persons and Animals”

Using 3-space feature statements with Strategy A:

$$subject \times hasFeature \times feature .$$

Let:

To find subject 1-spaces that have all three traits:
1. Compute:
2. AGENT_PERSON_ANIMAL=intersection(AGENT, intersection(PERSON, ANIMAL))
1. Project onto the subject axis:

$$resultSubjects = project ( AGENT\_PERSON \_ANIMAL , [ subjectDim ] )$$

1. Return resultSubjects as keys or as ORM objects.

### Example 2: “Find Entities Similar to John in Latent Space”

Assume we stored latent coordinates in a latent axis.
1. Read John's latent space:

$$let johnLatent = db . readLatentVector ( johnKey ) ;$$

Internally, this might intersect the subject×latent axes and project onto the latent axis.
1. Construct a query latent region, for example a hypersphere or hyperrectangle around John's vector:

$$let neighborhood = makeLatentNeighborhood ( johnLatent , epsilon ) ;$$

1. Intersect this query region with the global latent key-space and project back to the subject axis:

| | |
|---|---|
| 2. | let candidates = project( |
| 3. | intersection(globalLatentSpace, neighborhood), |
| 4. | [subjectDim] |
| | ); |

1. The result is a 1-space of subject intervals representing “entities whose latent coordinates are within ε of John”.

We can implement this using the same k-interval operations as for other geometric queries; the only additional work is choosing how to approximate spheres with hyperrectangles (or using a spatial tree like an R-tree over latent dimensions).

### Example 3: “Count how Many Dinghies are Small Personal Watercraft”

From the tiered type example, suppose trait index 0 corresponds to “small personal watercraft”, and its trait type ID is trait/tier2/n (called small_personal_watercraft).

To count them:
1. Let DINGHY be the 1-space of all dinghy entities (for example via an isA Dinghy type or a type interval).
2. Let SPW be the 3-space of hasFeature small_personal_watercraft.
3. Intersect DINGHY with SPW in subject dimension:

$$DINGHY\_SPW = intersection ( DINGHY\_SUBJECTS , SPW\_SUBJECTS )$$

where *_SUBJECTS denotes the projections onto the subject axis.
1. Measure the result:

$$count = measure ( DINGHY\_SPW , subjectDim ) ;$$

Because the subject axis is numeric and each dinghy has measure 1, the measure equals the number of dinghies matching the trait.

### Additional Implementation Notes

### Coordinate Design

A straightforward and robust coordinate scheme is:
Subject axis: “entity/<uuid>/<offset>” (1-person measure, 1-dinghy measure, etc.).
Feature axis (Strategy A): “feature/<family>/<name>/<value>” where <value> is numeric and encodes strength; or “feature/<family>/<name>/present” for binary features.
Latent axis: “latent/<model>/<dim>/<value>”.

These components are compatible with the mixed symbolic/numeric coordinate model described in the specification and allow measures to be computed from numeric suffixes.

### Data Structures

No new index structures are required:
feature and latent intervals are encoded as standard k-intervals;
they can be stored in the same KIntervalset and indexed by any of the existing choices (arrays, trees, skip lists, or spatial indices such as R-trees).

If latent dimensionality is high, we may:
either keep the latent axes in a separate KIntervalSet indexed by an R-tree or kD-tree; or
apply the co-occurring type compression feature to recurring trait combinations, reducing the number of intervals.

### Transactions and Feature Updates

Feature updates participate in transactions exactly like other properties:
Assigning a new feature (for example setting a risk score or adding a latent trait) corresponds to adding intervals to a feature or latent axis.
The conflict detection logic remains based on overlapping read and write spaces; nothing is special about feature axes.

We can therefore treat “update feature vector” as “update property” in the existing object-to-key-space framework.

### Summary

By giving each type, trait, and latent dimension a home in the global semantic coordinate system, a key-space database can:
represent discrete types, continuous attributes, and latent vectors uniformly as key-spaces;
support both exact, transactional queries over quantities and rich, AI-style similarity or trait queries;
remain invariant under schema changes, because feature semantics live in the geometry, not in fixed table layouts.

The implementation uses only the existing primitives of the specification:
1-spaces, k-intervals, and mixed symbolic/numeric coordinates;
union, intersection, difference, product, project, and measure;
transactional reads and writes with conflict detection based on overlapping spaces.

No new core mechanism is required; feature axes and latent spaces are straightforward extensions of the same key-space paradigm.

### Tiered Type System and Automatic Generation Pipeline

This document describes how a tiered type system is implemented on top of a subject-predicate-object key-space where all data is represented as 1-spaces and k-spaces (k-intervals) in a continuous semantic coordinate system.

The focus is:
how tier 1, tier 2 and tier 3 types are represented as 1-spaces,
how type membership is always expressed as a 3-space [subject][isA][type],
how a subscription pipeline watches new 1-spaces on the subject axis, consults an unstructured corpus, generates a latent embedding and then autolabels traits,
how tier-3 embeddings can be stored either as latent type objects or as coordinates on latent feature axes (or both), and
how the resulting traits and latent coordinates are exposed back as tier 2 types and/or feature axes that client code can query.

In the base KEY-SPACE DB, there are no fixed “rows” or “records”. Instead, everything that exists is a space in a coordinate system. A “person”, “5 dinghies” or “3.5 liters of maple syrup” is represented as a 1-space whose measure is 1, 5 or 3.5 along some semantic axis.

Statements such as “Abe Lincoln likes maple syrup” are represented as a 3-space in a subject-predicate-object key-space, as illustrated by the diagrams with the subject, predicate and object axes in the main specification.

This works very well for exact queries and updates, but we also want:
automatic discovery of traits (“is a US president”, “is a sweet food”),
flexible, overlapping multiple types per subject,
latent feature vectors that capture fine-grained similarity, and
a bridge between those latent features and the key-space itself.

If we try to bake all those traits directly into a single, static type hierarchy, we either:
over-design the schema up front, or
keep adding new columns/tables/enums forever as new traits appear.

The tiered type system solves this by separating concerns:
Tier 1—a small, curated set of stable base types (e.g. Person, Company, Product, Dinghy, MapleSyrup).
Tier 2—explicit trait types that can be created automatically (e.g. SyrupLover, HighValueCustomer, InflatableBoat, BreakfastFood).
Tier 3—latent representations derived from embeddings. A tier-3 state for a subject may be materialized either:
   as one or more latent type objects (discrete on/off traits such as type/latent/ModelX/abc123), and/or
   as coordinates on dedicated latent axes in the key-space, as described in the Semantic Feature Axes and Latent-Space Vectors section of the main specification.

All three tiers are represented uniformly in the key-space as type objects (1-spaces) and all type membership uses the same 3-space pattern:
[subject][isA][type].

When latent vectors are also embedded into feature/latent axes, they are additionally visible as coordinates in the same global key-space; tier 3 is then a view over those latent coordinates plus any discrete latent types derived from them.

### 1. Types in a Subject-Predicate-Object Key-Space

### 1.1 Recap: 1-Spaces, 3-Spaces and Axes

In a KEY-SPACE DB the global coordinate system can include axes such as:
subject axis
predicate axis
object axis
time axis
perspective/believer axis
version axis
feature/trait axes
latent axes

A 1-space is a set of 1-intervals along one axis (e.g. “abe_lincoln”, “all_people”, “some_syrup”). A 3-space is a Cartesian product of three 1-spaces, one per axis. The statement:
“presidents like maple_syrup”

is represented as:
subject dimension: 1-space presidents
predicate dimension: 1-space like
object dimension: 1-space maple_syrup

combined via product(presidents, like, maple_syrup).

### 1.2 Types as 1-Spaces and isA Statements

A type object is just another 1-space, but we reserve a semantic region for them. Examples:
type/Person
type/Product
type/Dinghy
type/MapleSyrup
type/SyrupLover (a trait)
type/latent/ModelX/ . . . (a latent type object)

Type membership is expressed with a distinguished predicate 1-space isA on the predicate axis: [subject][isA][type].

For example, “Abe Lincoln is a Person” is:
subject: abe_lincoln (1-space on the subject axis)
predicate: isA
object: type/Person

→a 3-space: person_membership=product(abe_lincoln, isA, typePerson).

The same pattern is used for:
Tier 1 base types (e.g. Person, Dinghy),
Tier 2 trait types (e.g. SyrupLover, InflatableBoat),
Tier 3 latent types (e.g. discrete latent type objects, or meta-types that mark latent coordinates).

### 1.3 Tier Markers

We treat tiers themselves as traits of the type objects.

For each TypeSpace we have another 3-space saying which tier it belongs to:
[type/Person][isA][type/Tier1Type]
[type/SyrupLover][isA][type/Tier2Type]
[type/latent/ModelX/abc123][isA][type/Tier3Type]

This lets us:
query “all tier-2 types” as a 1-space on the object axis,
constrain the pipeline to subjects that already have at least one tier-1 type, and
keep all tier metadata inside the same subject-predicate-object geometry.

### 2. Tier-3 Representations

Tier-3 exists to capture high-dimensional similarity patterns that are not yet named traits. There are two complementary storage strategies, which can be used alone or together.

### 2.1 Tier-3 as Latent Type Objects (Discrete Representation)

This is the representation used by the original tiered type design:
1. The pipeline computes an embedding v:number[ ] for a subject.
2. A latent type repository maps v to an identifier such as type/latent/ModelX/abc123.
3. The system asserts:
   [subject][isA][type/latent/ModelX/abc123]
      [type/latent/ModelX/abc123][isA][type/Tier3Type].

From the key-space's point of view this is just another trait: a subject either has that latent type or not. The actual numeric vector can be stored:
out-of-band (e.g. in an external vector index),
in a sidecar column in the type catalog, or
projected into latent axes as described next.

### 2.2 Tier-3 as Latent Axes (Continuous Representation)

The Semantic Feature Axes and Latent-Space Vectors feature extends the coordinate system with:
trait feature axes, one per explicit graded feature such as person-ness, agent-ness, animal-ness, and
latent axes, one per dimension of a numeric embedding vector.

In that design, the feature vector of a subject is literally another slice of the global key-space: the subject occupies an interval on each feature or latent axis, so that its latent coordinates can be queried using the same product, intersection, project and measure operations as other spaces.

When we enable latent axes, attaching a tier-3 embedding can proceed as follows:
1. For each dimension i of the embedding, allocate a latent axis (for example, coordinates with prefix [“latent/ModeX/dim_i”, . . . ]) if it does not already exist.
2. For the subject, create a 1-space whose extent along each latent axis encodes the value of that component.
3. Optionally, create or update a corresponding latent type object so that discrete queries such as [subject][isA][someLatentType] continue to work.

Conceptually, the tier-3 state of a subject is then:
its coordinates on the latent axes, plus
any tier-3 type objects that reference those coordinates or the original embedding.

### 2.3 Tier-3 Derived Discrete Traits

Latent axes give us continuous coordinates. Tier-2 traits give us discrete, human-meaningful labels. There is a useful middle ground: derived traits based on thresholds in latent space.

Examples:
a cluster of dinghy embeddings in latent space might correspond to “starter dinghies for lakes”,
a region of the person latent space might correspond to “high chum-risk customers”.

The autolabeler can:
1. detect such regions (by clustering, nearest neighbours, or prompts to a language model),
2. assign a new trait type (tier 2) such as type/auto/StarterDinghy,
3. attach that trait to all subjects whose latent coordinates fall into the region, and
4. keep using the underlying coordinates for more fine-grained similarity search.

In other words:
Tier-3 is where the raw vector lives (as latent type objects, latent axes, or both),
Tier-2 traits are thresholded/clustered/named subsets of that latent space plus other structured signals.

### 3. High-Level Pipeline

The pipeline hangs off the subject axis and listens for new 1-spaces that have been typed with at least one tier-1 type.

We describe the steps informally, then give interfaces.

### 3.1 Step 0—Preconditions

We assume:
a set of human-curated tier-1 types (e.g. Person, Company, Product, Dinghy, MapleSyrup),
an unstructured corpus (documents, logs, web pages, descriptions),
a way to locate documents about a subject (e.g. hasText, mentionedIn relations stored as 3-spaces),
an embedding model that maps text→a vector in Rⁿ, and
an autolabeling service that can propose trait labels given embedding+context.

### 3.2 Step 1—Subscribe to New isA Edges for Tier-1 Types

Whenever a new 3-space of the form:
[new subject][isA][someTier1Type]

is added, the pipeline receives an event.

Intuitively: “Something new has appeared that is at least a Person Product Dinghy etc. Let's enrich it.”

The subject component of that 3-space is a 1-space on the subject axis. That 1-space is what the pipeline tracks.

### 3.3 Step 2—Collect Unstructured Text for the Subject

The pipeline then looks up unstructured text for the subject:
text fields directly attached to it: [subject][hasText][someTextBlob],
documents where it is mentioned: [subject][mentionedIn][doc123].

The union of those text snippets becomes the context for the subject.

### 3.4 Step 3—Compute a Latent Vector

The context is embedded into a latent vector v:number[ ].

This vector captures semantic similarity; for example:
“Abe Lincoln” and “Mary Lincoln” will end up closer than “Abe Lincoln” and “Yacht”.
Dinghies that are “inflatable”, “two-seat “and” for lakes “will be close to each other.

### 3.5 Step 4—Attach the Tier-3 Representation

Given the embedding v, the pipeline may attach tier-3 state in one or both forms.

### 4A. Latent Type Object

Use a LatentTypeRepository to map v to a LatentTypeSpace (creating it if needed).
Assert:
[subject][isA][latentType]
   [latentType.space][isA][type/Tier3Type].

### 4B. Latent Axes Coordinates

If latent axes are enabled:
write or update the subject's coordinates on the latent axes for the embedding's model,
optionally maintain a pointer from the latent type object to those coordinates.

In both cases, from a client's perspective the subject “has a tier-3 embedding”.

3.6 Step 5—Run the autolabeling pipeline

Using:
the subject's tier-I types,
the latent vector (and/or its latent-axis coordinates),
the context text, and
any previously known trait types,

the autolabeler proposes trait assignments:
existing trait types: SyrupLover, HighValueCustomer, InflatableBoat, . . .
possibly new trait types if many similar subjects are unlabeled.

### Step 5A—Attach Traits as Tier-2 Types

For each accepted trait type T:
[subject][isA][T]
[T][isA][type/Tier2Type].

Multiple traits are simply multiple isA 3-spaces.

Step 5B—Create New Trait Type(s) when Thresholds are Met

If the autolabeler detects that many subjects share a common pattern in latent space, but no explicit trait reflects it, it may:
1. allocate a new type 1-space, e.g. type/Customer/ChurnRiskHigh,
2. generate a human-readable description,
3. attach that type to all matching subjects via [subject][isA][newType], and
4. mark the new type itself as tier 2: [newType][isA][type/Tier2Type].

Then we can go back to Step 5A and re-run trait assignment with this new type in the candidate set for future subjects.

### 3.7 Step 6—Expose Traits as the Tier-2 View

From a client's perspective, the set of traits attached via isA edges to tier-2 type objects is the subject's “tier-2 type”. It can be queried as:

$$subjectTier 2 Types = \{ T \vert [ subject ] [ isA ] [ T ] ∧ [ T ] [ i s A ] [ type / Tier 2 Type ] \}$$

In deployments that also store latent axes, a subject additionally has:
a vector of tier-3 coordinates on latent axes, and
graded feature coordinates on any explicit trait axes.
4. Formal Data Model (pseudo TypeScript)

### 4.1 Core Types

We reuse the KIntervalSet abstraction from the main specification for key-space descriptors.

```
// A 1-space or k-space descriptor in the global key-space.
type KIntervalSet = { }; // Placeholder - see main spec for details.
enum TypeTier {
  Tier1 = 1,
  Tier2 = 2,
  Tier3 = 3,
}
```

Each type object is represented as a 1-space on the object axis (and may also have its own subject-axis identity if we talk about the type as a subject in meta-statements).

```
interface TypeSpace {
  id: string; // Stable identifier, e.g. “type/Person”
  tier: TypeTier; // 1, 2 or 3
  space: KIntervalSet; // 1-space on the object axis
  label?: string; // Human readable “Person”, “Syrup lover”
  description?: string;
}
```

We treat isA itself as a 1-space on the predicate axis:
const isASpace: KIntervalSet; // 1-space on predicate axis for “isA”

To encode a type assertion:

```
function mkIsAStatement(subject: KIntervalSet, type: TypeSpace): KIntervalSet {
  // 3-space: subject × “isA” × type.space
  return product3(subject, isASpace, type.space);
}
```

Here product3 is the 3-dimensional special case of the general product( ) operator described in the main specification.

### 4.2 Tier Universe Spaces

We keep 1-spaces that represent “the set of all tier-X types”:

// union of all tier-X type spaces:
const tier1TypeUniverse: KIntervalSet;
const tier2TypeUniverse: KIntervalSet;
const tier3TypeUniverse: KIntervalSet;

These are derived from the meta-statements:

// For every type T:
mkIsAStatement(T.space, tier1TypeMarker); // or tier2TypeMarker, etc.

and projecting them onto the object axis.

### 4.3 Pipeline Events

The pipeline subscribes to writes that add 3-spaces matching:
[subject][isA][type] where type E tier1TypeUniverse.

We model this as a stream of events:

```
interface NewTier1TypeAssignmentEvent {
  subject: KIntervalSet; // 1-space on subject axis
  type: TypeSpace; // tier 1 type
  transactionId: string;
}
interface TypeSubscription {
  onNewTier1(event: NewTier1TypeAssignmentEvent): void;
}
function subscribeToTier1Assignments(sub: TypeSubscription): void {
  // Implementation-dependent: hooks into transaction log or index.
}
```

### 4.4 Text Retrieval

A TextRetriever abstracts away how we get unstructured text for a subject.

```
interface SubjectContext {
  subject: KIntervalSet;
  tier1Types: TypeSpace[ ];
  textSnippets: string[ ];
}
interface TextRetriever {
  collectContext(subject: KIntervalSet, tier1Types:
  TypeSpace[ ]): SubjectContext;
}
```

A typical implementation:
queries for 3-spaces [subject][hasText][blob],
queries for [subject][mentionedIn][doc],
concatenates and normalizes.

### 4.5 Embedding and Latent Types (Tier 3)

The Embedder maps context→vector:

```
interface Embedding {
  modelId: string;
  vector: number[ ]; // latent coordinates
}
interface Embedder {
  embed(ctx: SubjectContext): Embedding;
}
```

To represent the embedding as a latent type object:

```
interface LatentTypeSpace extends TypeSpace {
  tier: TypeTier.Tier3;
  embedding: Embedding; // may also reference latent axes
}
interface LatentTypeRepository {
  lookupOrCreate(embedding: Embedding):
  LatentTypeSpace;
}
```

A simple strategy:

```
class SimpleLatentTypeRepository implements LatentTypeRepository {
  lookupOrCreate(emb: Embedding): LatentTypeSpace {
    const id = hashEmbedding(emb);
    let existing = findTypeById(id);
    if (existing) return existing as LatentTypeSpace;
    const space: KIntervalSet = allocate1Space([“latent”,
    emb.modelId, id], 1);
    const type: LatentTypeSpace = {
      id: “type/latent/” + emb.modelId + “/” + id,
      tier: TypeTier.Tier3,
      space,
      label: “Latent(“ + emb.modelId + ”, “ +
      id.slice(0, 8) + ”)”,
      description: “Auto-generated latent type”,
      embedding: emb,
    };
    persistType(type);
    // Mark as tier 3:
    db.add(mkIsAStatement(type.space, tier3TypeMarker));
    return type;
  }
}
```

If the deployment also uses latent axes, the embedding field can be interpreted as a convenience view over the subject's coordinates on those axes, and the LatentTypeSpace can act as a shared handle for similar subjects.

### 4.6 Autolabeler (Tier-2 Traits)

The autolabeler produces:
a set of existing types to assign, and
optionally, description(s) of new types to be created.

```
interface ProposedTrait {
  type: TypeSpace;
  score: number; // confidence
}
interface ProposedNewType {
  label: string;
  description: string;
  // Optional: seed subjects for which this new type should be assigned.
  seedSubjects: KIntervalSet[ ];
}
interface AutolabelResult {
  traits: ProposedTrait[ ];
  newTypes: ProposedNewType[ ];
}
interface Autolabeler {
  label(input: {
    context: SubjectContext;
    embedding: Embedding;
  }): AutolabelResult;
}
```

The autolabeler may internally:
perform nearest-neighbor search in embedded trait space,
use a language model to generate candidate names,
cluster embeddings to detect unlabeled groups, etc.

The tiered type system does not assume a particular ML architecture; it only requires that output is expressed in terms of type objects and confidence scores.

### 4.7 Orchestrator

The orchestrator ties everything together:

```
class TieredTypePipeline implements TypeSubscription {
  constructor(
    private db: KeySpaceDatabase,
    private textRetriever: TextRetriever,
    private embedder: Embedder,
    private autolabeler: Autolabeler,
    private latentRepo: LatentTypeRepository,
  ) { }
  onNewTier1(event: NewTier1TypeAssignmentEvent): void {
    const subject = event.subject;
    // 1. Collect context.
    const ctx = this.textRetriever.collectContext(subject, [event.type]);
    // 2. Compute embedding and attach tier 3 type.
    const emb = this.embedder.embed(ctx);
    const latentType = this.latentRepo.lookupOrCreate(emb);
    this.db.add(mkIsAStatement(subject, latentType));
    // Optionally: 2b. Update latent axes for this subject from emb.vector.
    // 3. Autolabel traits (tier 2).
    const labels = this.autolabeler.label({ context: ctx,
    embedding: emb });
    // 4. Attach existing traits over threshold.
    const THRESHOLD = 0.7;
    for (const trait of labels.traits) {
      if (trait.score < THRESHOLD) continue;
      this.ensureTier2Marker(trait.type);
      this.db.add(mkIsAStatement(subject, trait.type));
    }
    // 5. Create new trait types if thresholds are met.
    for (const nt of labels.newTypes) {
      const newType = this.createNewTier2Type(nt);
      // Attach to seed subjects, including the current one if desired.
      const seeds = nt.seedSubjects.length > 0 ?
      nt.seedSubjects : [subject];
      for (const seed of seeds) {
        this.db.add(mkIsAStatement(seed, newType));
      }
    }
  }
  private ensureTier2Marker(type: TypeSpace): void {
    if (type.tier === TypeTier.Tier2) return;
    type.tier = TypeTier.Tier2;
    this.db.add(mkIsAStatement(type.space, tier2TypeMarker));
    persistType(type);
  }
  private createNewTier2Type(nt: ProposedNewType): TypeSpace {
    const typeId = allocateTypeId(nt.label);
    const space = allocate1Space([“type”, “auto”, typeId], 1);
    const type: TypeSpace = {
      id: “type/auto/” + typeId,
      tier: TypeTier.Tier2,
      space,
      label: nt.label,
      description: nt.description,
    };
    persistType(type);
    this.db.add(mkIsAStatement(type.space, tier2TypeMarker));
    return type;
  }
}
```

Here KeySpaceDatabase exposes generic add(operations that merge spaces into the stored key-spaces as described in the main specification.

### 5. Examples

### 5.1 Abe Lincoln and Maple Syrup (Revisited)

From the base spec we already have 1-spaces:
abe_lincoln—one person
mary_lincoln—one person
presidents—many persons
maple_syrup—all maple syrup
some_syrup—0.25 liters of syrup
etc.

and 3-spaces such as:
presidents_like_maple_syrup=product(presidents, like, maple_syrup)
abe_ate_some_syrup=product(abe_lincoln, ate, some_syrup)

We define tier-1 types:
typePerson.space—covers all persons
typeFood.space—covers edible items
typeSyrup.space—covers all syrups
typeEvent.space—covers events

and mark them as tier 1 via [typeX][isA][type/Tier1Type].

We attach base types:
[abe_lincoln][isA][typePerson]
[maple_syrup][isA][typeSyrup]
etc.

This triggers the pipeline for abe_lincoln.

### Context and Embedding

Text context might include:
“Abe Lincoln likes maple syrup.”
“Abe Lincoln ate some syrup between 3 pm and 4 pm Jan. 15 1860.”

The embedder turns this context into a vector v. The latent repo creates a latent type:
type/latent/HistoricalFigureFlavor/abc123

and asserts:
[abe_lincoln][isA][type/latent/HistoricalFigureFlavor/abc123].

If latent axes are used, we also write v as coordinates along the appropriate latent axes for abe_lincoln.

### Autolabel Traits

Assume the autolabeler knows about existing trait types:
type/SyrupLover (tier 2),
type/HistoryFigure,
type/USPresident,

and finds high scores for those traits. It outputs these traits and the orchestrator asserts:
[abe_lincoln][isA][type/SyrupLover]
[abe_lincoln][isA][type/USPresident]
[abe_lincoln][isA][type/HistoryFigure]

All of these are 3-spaces created via product(abe_lincoln, isA, typex.space).

### New Trait Type

Across many historical figures, the autolabeler may notice a cluster of people who:
are US presidents,
have many ate relations with maple_syrup or corn syrup,
have strong positive sentiment toward sweets.

It proposes a new type:

```
ProposedNewType {
  label: “SweetToothedPresident”,
  description: “US presidents with a strong preference for sweet foods.”,
  seedSubjects: [abe_lincoln, some_other_president_1, ...]
}
```

The pipeline allocates type/auto/SweetToothedPresident and attaches:
[abe_lincoln][isA][type/auto/SweetToothedPresident].

Now queries such as:
“Which sweet-toothed presidents liked maple syrup?”

become simple intersections of
the 3-space [subject][isA][type/auto/SweetToothedPresident], and
the 3-space [subject][like][maple_syrup]projected onto the subject axis.

### 5.2 New Dinghy SKU

Consider the warehouse examples from the main specification, with dinghies, motor oil and bow dock line.

### Tier-1 Base

We already have:
type/Product (tier 1),
type/Dinghy (tier 1, a subtype of Product),
type/MotorOil (tier 1),
etc.

When a new dinghy SKU EcoLake 3000 arrives, the object mapper creates a 1-space:

$$e c o L ake 3000 = [ “ Product / Dinghy / EcoLake 3000 ” , offset … offset + 1 )$$

and attaches:
[ecoLake3000][isA][type/Product]
[ecoLake3000][isA][type/Dinghy]

The second statement triggers the pipeline (new dinghy subject with a tier-1 type).

### Context and Latent Type

Text context might include:
“An inflatable lake dinghy for two adults.”
“Includes oars, pump and repair kit.”
“Maximum load 200 kg, for freshwater use.”

The embedder produces v_dinghy. The latent repo creates type/latent/MarineProducts/xyz777 and asserts:
[ecoLake3000][isA][type/latent/MarineProducts/xyz777].

If latent axes are configured, we additionally place ecoLake3000 at coordinates given by v_dinghy on the corresponding latent axes.

### Existing Traits

Suppose we already have tier-2 traits:
type/InflatableBoat
type/TwoPersonVessel
type/FreshwaterOnly
type/LowPriceSegmentBoat

The autolabeler scores them, for example:
InflatableBoat 0.98
TwoPersonVessel 0.95
FreshwaterOnly 0.92
LowPriceSegmentBoat 0.68 (below threshold 0.7)

The orchestrator attaches:
[ecoLake3000][isA][type/InflatableBoat]
[ecoLake3000][isA][type/TwoPersonVessel]
[ecoLake3000][isA][type/FreshwaterOnly]

Each again is a 3-space on subject×predicate×object.

### New Trait Type: StarterDinghy

Across many SKUs, a cluster of cheap, beginner-friendly dinghies is detected in latent space. The autolabeler proposes StarterDinghy. The pipeline creates type/auto/StarterDinghy and attaches it to the corresponding subjects.

Now queries become easy:
“How many StarterDinghy units are in stock in Miami?”
“What is the total revenue for InflatableBoat+StarterDinghy traits?”

These are just intersections and measures over:
inventory spaces (subject=dinghy portions),
trait membership spaces (subject=same dinghy portions, predicate=isA, object in the trait set),
and, if desired, latent-space neighborhoods defined on the dinghy latent axes.
   6. Accessing Tiered Types and Latent Space from Client Code

### 6.1 Reading Tier-2 Types for a Subject

```
function getTier2Types(subject: KIntervalSet): TypeSpace[ ] {
  // 3-space: subject × isA × (all tier 2 types)
  const query3 = product3(subject, isASpace, tier2TypeUniverse);
  const result3 = db.read(query3);
  // Project object axis to get the 1-spaces of the types.
  const typeSpaces1 = project(result3, [OBJECT_DIMENSION]);
  return resolveTypesFromSpaces(typeSpaces1);
}
```

### 6.2 Searching by Traits, Latent Types and Latent Axes

To find “all inflatable boats”: query [subject][isA][type/InflatableBoat].
To find “things similar to ecoLake3000 in embedding space”:
1. read its tier-3 representation (either the LatentTypeSpace or its latent-axis coordinates),
   construct a neighborhood region in latent space (e.g. a hyperrectangle around the vector), and
   intersect that region with the global latent key-space, then project back to the subject axis.

Because both trait memberships and latent type attachments are encoded as 3-spaces using the same isA predicate, mixing symbolic and latent criteria in a single query is straightforward: intersect the corresponding spaces. When latent axes are present, those intersections can also incorporate exact geometric conditions on the latent coordinates.

### 7. Summary

The tiered type system lives entirely inside the same semantic key-space as “normal” facts.
All type membership is encoded as 3-spaces [subject][isA][type].
Tier-1 types are curated, stable base types.
Tier-3 captures latent representations, which may be materialized as latent type objects, as coordinates on latent axes, or both.
Tier-2 types are explicit traits inferred by an autolabeling pipeline from tier-1 assignments, text context, other structured properties, and tier-3 embeddings.
The pipeline:
   subscribes to new 1-spaces on the subject axis having tier-1 types,
   collects unstructured text,
   computes a latent vector and attaches a tier-3 representation,
   autolabels traits and possibly creates new trait types,
   exposes the traits as the subject's tier-2 type set, while keeping the underlying latent coordinates available for similarity queries.

Because everything is represented as spaces, axes and 3-space statements, the system retains the invariance and exactness of the underlying KEY-SPACE DB while supporting rich, overlapping, automatically generated type systems and integrated vector-style search.

### Co-Occurring Type Compression

A key-space database is aimed at providing performant and power-efficient processing and invariant representation of structured semantic data. In some embodiments, each concept represented by a spatial descriptor may have a plurality of types, features, or traits (i.e., predicate axes). A predicate axis may bind a concept in lower-dimensional space to a plurality of isA or hasFeature concepts, forming a type lattice.

For example, concepts represented in 1-space may have 3-space statements relating those 1-spaces to types such as agent-ness, person-ness, or company-ness. In addition to 1-space concepts and 3-space statements, propositions and statements of higher dimensionality may in some embodiments be employed (by using more semantic dimensions or additional dimensions for subject, predicate, and/or object semantic roles).

The purpose of the co-occurring type compression feature is to reduce:
the number of semantic dimensions and/or
the number of k-intervals

needed to describe the types of a concept represented by a spatial descriptor, with the technical effect of improving query performance, memory efficiency, and power consumption.

A clear condition for “always together and only together” is used to determine when several types can safely be replaced by a single synthetic combined type without affecting observable semantics. For users of the key-space database, the internal reduction of spatial descriptors and/or semantic dimensions can be hidden, because the engine rewrites both input queries (data-retrieval instructions) and data-update instructions through a mapping layer.

This section describes an optimisation that reduces the storage and query cost of large trait sets by introducing compressed types for frequently co-occurring Tier-2 trait combinations. The optimisation is purely representational: all semantics continue to be expressed as 3-space statements of the form [subject][isA][type].

### 1. Recap: Traits as 3-Spaces

As in the multiple-typing section, each trait or type is a 1-space on the type axis, and type membership is expressed in a subject×predicate×object key-space using the isA predicate:
[subject][isA][TraitA]
[subject][isA][TraitB]
[subject][isA][TraitC]

For a subject 1-space S, the set of all traits currently attached to S is the union of all such 3-spaces with S on the subject axis.

Tier-2 trait types themselves are marked using meta-types, for example:
[TraitA][isA][Tier2Type]
[TraitB][isA][Tier2Type]
[TraitC][isA][Tier2Type]

### 2. Compressed Type Objects

A compressed type represents a frequently occurring trait bundle such as {TraitA, TraitB, TraitC}. It is itself a type object, i.e. a 1-space C on the type axis. We represent its semantics using additional isA statements:
[C][isA][TraitA]
[C][isA][TraitB]
[C][isA][TraitC]
[C][isA][Tier2CompressedType]

The last statement marks C as a Tier-2 compressed type so that it can be recognised and handled specially at query time.

Attaching the compressed type to a subject S is done with the familiar 3-space:
[S][isA][C]

From these statements alone it already follows that S is also an instance of TraitA, TraitB and TraitC by the usual transitive reading of isA (subject types are closed upwards along the isA relation). The optimisation therefore never removes information; it only changes which isA statements are materialised in the stored key-space.

### 3. Discovering Co-Occurring Trait Bundles

A background job periodically scans existing Tier-2 assignments and discovers frequently co-occurring bundles. Conceptually:
1. Read all Tier-2 isA statements:
[S][isA][T]

where T satisfies [T][isA][Tier2Type].
1. Group 3-spaces by their subject 1-space, obtaining for each subject S a finite set of trait types:

```
type SubjectSpace = KIntervalSet; // 1-space on subject axis
type TraitType = KIntervalSet; // 1-space on type axis
interface SubjectTraits {
  subject: SubjectSpace;
  traits: TraitType[ ];
}
```

1. For each subject, normalise the trait set into a sorted, duplicate-free key:

```
function keyOfTraitSet(traits: TraitType[ ]): string {
  const ids = traits.map(t => encodeIntervalSet(t)); // canonical string
  ids.sort( );
  return ids.join(“|”);
}
      1. Aggregate support counts per trait bundle:
interface BundleStats {
  support: number; // number of subjects (or total measure)
  exampleSubjects: SubjectSpace[ ]; // optional sample for debugging
}
const bundles = new Map<string, BundleStats>( );
for (const st of scanAllSubjectTraits( )) {
  const key = keyOfTraitSet(st.traits);
  const stats = bundles.get(key) ?? { support: 0, exampleSubjects: [ ] };
  stats.support += 1;
  if (stats.exampleSubjects.length < 10) {
    stats.exampleSubjects.push(st.subject);
  }
  bundles.set(key, stats);
}
```

1. Select bundles whose support exceeds a configurable minimum:

```
const candidates: TraitType[ ][ ] = [ ];
for (const [key, stats] of bundles) {
  if (stats.support >=
  MIN_SUPPORT_FOR_COMPRESSED_TYPE &&
      key.split(“|”).length > 1) {
    candidates.push(decodeTraitSetKey(key));
  }
}
```

The scanning step scanAllSubjectTraits( ) is implemented as a single key-space query:

```
function scanAllSubjectTraits( ): Iterable<SubjectTraits> {
  const allSubjects = subjectUniverseSpace( );
  const isA = isAPredicateSpace( );
  const tier2Universe = allTier2TypeSpaces( );
  const q = product(allSubjects, isA, tier2Universe);
  const assignments = db.read(currentTx, q);
  // Group by subject 1-space.
  const map = new Map<string, SubjectTraits>( );
  for (const ki of assignments.enumerate( )) {
    const subject = project(ki, [0]); // subject axis
    const type = project(ki, [2]); // object axis
    const key = encodeIntervalSet(subject);
    const entry = map.get(key) ?? { subject, traits: [ ] };
    entry.traits.push(type);
    map.set(key, entry);
  }
  return map.values( );
}
```

Here encodeIntervalSet creates a canonical string representation of a 1-space so it can be used as a map key; it does not change the underlying geometric representation.

### 4. Creating a Compressed Type

For every selected bundle B={T₁, . . . . , Tₖ}, the compressor creates a new compressed type object C_B:

```
interface CompressedTypeDefinition {
  id: KIntervalSet; // 1-space for the compressed type
  members: TraitType[ ]; // {T₁, ..., Tₖ}
}
function createCompressedType(members: TraitType[ ]):
CompressedTypeDefinition {
  const id = allocateType1Space({
    kind: “tier2-compressed”,
    label: makeBundleLabel(members)
  });
  const isA = isAPredicateSpace( );
  // Mark C_B as a Tier-2 compressed type.
  const meta = tier2CompressedMetaTypeSpace( );
  db.add(currentTx, product(id, isA, meta)); //
  [C_B][isA][Tier2CompressedType]
  // Record that C_B is a subtype of each member trait.
  for (const t of members) {
    db.add(currentTx, product(id, isA, t)); // [C_B][isA][T_i]
  }
  return { id, members };
}
```

The function makeBundleLabel may construct a stable human-readable identifier, e.g. “Animal+Vehicle+Herbivore”.

### 5. Rewriting Subject Assignments

Given a compressed type C_B for the bundle B={T₁, . . . , Tₖ}, the compressor can now replace explicit trait assignments for subjects that have exactly this bundle (or a superset containing it).

For each such subject S:
1. Add the compressed assignment:

### [S][isA][C_B]

1. Optionally remove the individual trait assignments for the bundle:

[S][isA][T₁] (removed)
...
[S][isA][Tₖ] (removed)

This is implemented using standard key-space operations:

```
function compressSubjectTraits(
  subject: SubjectSpace,
  def: CompressedTypeDefinition
): void {
  const isA = isAPredicateSpace( );
  // 1. Add [subject][isA][C_B].
  db.add(currentTx, product(subject, isA, def.id));
  // 2. Remove [subject][isA][T_i] for each member of the bundle.
  for (const t of def.members) {
    const space = product(subject, isA, t);
    db.remove(currentTx, space);
  }
}
```

Whether step 2 is executed depends on the desired trade-off between storage and redundancy. Even if the individual trait assignments are removed, the semantics remain unchanged because S can still be inferred to have each member trait via the transitive closure of isA:

$$[ S ] [ i s A ] [ C\_B ] ∧ [ C\_B ] [ i sA ] [ T\_i ] ⇒ [ S ] [ isA ] [ T\_i ]$$

### 6. Query-Time Expansion

Most queries are written in terms of the original traits (“find all subjects that are Animal and Vehicle”), not in terms of compressed bundle types. To preserve invariance, the query processor must treat compressed types transparently.

### 6.1 Expanding Types for a Single Subject

A helper function expands all types for a subject by following isA edges from compressed types to their member traits:

```
function expandedTypesForSubject(subject: SubjectSpace): TraitType[ ] {
  const isA = isAPredicateSpace( );
  const typeUniverse = allType1Spaces( );
  const q = product(subject, isA, typeUniverse);
  const direct = db.read(currentTx, q);
  const stack: TraitType[ ] = [ ];
  for (const ki of direct.enumerate( )) {
    stack.push(project(ki, [2])); // object axis
  }
  const result = new Set<string>( ); // canonical encodings
  const types: TraitType[ ] = [ ];
  while (stack.length > 0) {
    const t = stack.pop( )!;
    const key = encodeIntervalSet(t);
    if (result.has(key)) continue;
    result.add(key);
    types.push(t);
  if (isCompressedType(t)) {
      // Follow [t][isA][member] for all member traits.
      const members = memberTraitsOfCompressedType(t);
      stack.push(...members);
    }
  }
  return types;
}
```

Here isCompressedType(t) checks whether [t][isA][Tier2CompressedType]holds, and memberTraitsOfCompressedType(t) reads all T such that [t][isA][T] and [T][isA][Tier2Type] are true.

### 6.2 Rewriting Trait Predicates in Queries

A predicate such as “S has trait T” is implemented by intersecting the stored key-space with the 3-space
[subjectUniverse][isA][T]

To include compressed types, the query processor rewrites this into
[subjectUniverse][isA][T]∪
[subjectUniverse][isA][C] where [C][isA][T]

In pseudocode:

```
function traitPredicateSpace(trait: TraitType): KIntervalSet {
  const allSubjects = subjectUniverseSpace( );
  const isA = isAPredicateSpace( );
  // Direct matches: [S][isA][trait].
  const direct = product(allSubjects, isA, trait);
  // Compressed matches: [S][isA][C] where [C][isA][trait].
  const compressedTypes = typesWithIsASupertype(trait); // { C |
  [C][isA][trait] }
  let compressed: KIntervalSet = emptySpace( );
  for (const c of compressedTypes) {
    compressed = union(compressed, product(allSubjects, isA, c));
  }
  return union(direct, compressed);
}
```

Any query that previously intersected with [subjectUniverse][isA][trait] simply replaces that space with traitPredicateSpace(trait), thereby making compressed types invisible at the semantic level.

### 7. Traversing the Subject Axis Correctly

All the algorithms above treat the subject axis as a genuine 1-space:
Subjects are always represented as 1-spaces S on the subject axis.
All trait assignments are 3-spaces product(S, isA, T).
Grouping is done by projecting 3-spaces onto the subject dimension and using the resulting 1-spaces as grouping keys.

No algorithm assumes that subjects are discrete rows or integer identifiers. When the measure of a subject 1-space is greater than 1 (for example a batch of 100 dinghies represented by a single 1-interval), the algorithms treat that entire 1-space as a single subject entity whose traits apply uniformly.

If an application needs to operate at unit granularity—for example, iterate over each individual dinghy in a batch—it may first slice the subject 1-space along the subject axis using the existing slice( ) operation, and then run the same compression or expansion logic for each slice separately.

### 8. Decompression and Maintenance

Because compressed types are expressed entirely in terms of isA statements, decompression is straightforward:
For each subject S, compute expandedTypesForSubject(S) and materialise any missing [S][isA][T] 3-spaces if the application desires a fully expanded representation.
To retire a compressed type C_B, add the member trait assignments back for all subjects that have [S][isA][C B], then remove [S][isA][C_B] and the definitional [C_B][isA][T_i] statements.

Periodic re-mining of co-occurring bundles may add or remove compressed types without changing query results. The only observable effect is a change in how much information is stored directly versus inferred via the isA relation.

### Invariance of Combinatorial Traits

In previous sections, it was described how a KEY-SPACE DB may represent propositions as regions in a semantic coordinate system, and how quantities, times, options and other aspects of those propositions may be handled as dimensions of that system rather than as fixed columns or attributes. It was also described how combinatorial types or traits may be attached to type-agnostic keys, allowing data objects to acquire and lose types over time by adding or removing trait spaces, as in the examples of Animal and Vehicle traits in the section on combinatorial types.

In the field of machine learning, a well-known illustration of combinatorial semantics is the vector-space analogy “king−male+female≈queen”. In a latent feature space, each word is represented by a vector whose components encode semantic features such as “person”, “royal”, “male”, “female”, “adult”, “ruler”, and so on. The analogy expresses that the concept of “king” can be decomposed into a combination of such features, and that by removing the “male” feature and adding the “female” feature, while leaving the remaining features invariant, one arrives near the concept “queen”. However, these latent vector spaces are typically approximate and opaque: their feature axes are not explicit components of a data model, and they are not directly suitable for exact querying, counting or transactional updates.

In embodiments according to this disclosure, an analogous combinatorial structure may be realized in an explicit semantic key-space. Instead of representing “king” and “queen” as unlabelled points in a numerical vector space, their semantics may be expressed as combinations of labelled trait spaces in a semantic coordinate system. This preserves the attractive invariance properties of vector representations—small changes in meaning correspond to adding or removing traits—while retaining the exactness, composability and transactional behaviour of the KEY-SPACE DB.

### Trait Spaces for Semantic Features

In one embodiment, each semantic feature relevant to the example may be represented as a trait comprising a key-space. For instance, there may be trait spaces representing at least the following features:
a person trait, representing that something is a person;
an adult trait, representing that something is an adult;
a royal trait, representing that something is a member of royalty;
a ruler trait, representing that something exercises the role of a ruler;
a male trait and a female trait, representing sex or gender.

Each of these traits may be encoded as a key-space in the sense described in the section on combinatorial types. For example, there may be a 1-space trait/person, a 1-space trait/royal, a 1-space trait/male, and so on, each defined by one or more 1-intervals on a trait axis of the coordinate system. The set of traits attached to a particular entity may then be represented as a union of these trait spaces restricted to the 1-space representing that entity, for example by intersecting the entity's identity space with the spaces representing the traits that apply to it.

Let king_trait denote the key-space representing the concept “king”, and queen_trait denote the key-space representing the concept “queen”. In one embodiment, these may be defined as intersections of more primitive trait spaces:

$$king\_trait = person ⋂ adult ⋂ royal ⋂ ruler ⋂ male$$

$$queen\_traint = person ⋂ adult ⋂ royal ⋂ ruler ⋂ female$$

where person, adult, royal, ruler, male and female denote the corresponding trait spaces lifted to the same dimensionality, for example by forming Cartesian products with appropriate neutral spaces in the remaining dimensions. Thus, in such an embodiment, a data object is a king precisely when its identity space overlaps the king_trait space, and a data object is a queen precisely when its identity space overlaps the queen_trait space.

The trait operations described in the combinatorial types section—assigning or unassigning traits by taking unions and differences of trait spaces—then become an explicit analogue of adding or removing components in a latent feature vector. For example, if a data object o represents a particular person, an operation that “demotes” o from king to non-king may be expressed as:

$$o . traits = difference ( o . traits , king\_trait ) .$$

Similarly, an operation that “promotes” o to king may be expressed as:

$$o . traits = union ( o . traits , king\_trait ) .$$

Such operations may be implemented by unions and differences over the traits key-space attached to the object, as illustrated by the assign( ) and unassign(methods in the combinatorial types embodiment.

### Encoding Traits as Feature Axes

In some embodiments, one or more trait spaces may be encoded as dedicated axes of the semantic coordinate system. For example, there may be an axis whose coordinates represent the presence or absence of the male feature, another axis for the female feature, and further axes for royal, adult, ruler, and so on. In such embodiments, the “neutral” state of a feature (that is, the state where no particular value is asserted for the feature) may be represented by a designated subspace of the corresponding axis, for example an interval [“feature/male/0”; “feature/male/0”) of measure zero, or a reserved region such as [“feature/male/none”; “feature/male/E”). The presence of the feature may be represented by a non-zero interval, such as [“feature/male/1”; “feature/male/2”).

Under this encoding, a king may be represented as a key-space occupying the “present” region on the person, adult, royal, ruler and male axes simultaneously, and the “neutral” region on any other feature axes, while a queen occupies the same region except that it occupies the “present” region on the female axis and the “neutral” region on the male axis. The combinatorial structure “king−male+female” then corresponds to a geometric transformation in which the intervals on the male and female axes are modified while leaving the intervals on the remaining feature axes invariant.

More formally, if we denote by KING the key-space representing all kings and by MALE and FEMALE the key-spaces representing the presence of the male and female traits, respectively, then one way to express the relationship between kings and queens is:

$$QUEEN = union ( difference ( KING , MALE ) , FEMALE ⋂ PERSON ⋂ ADULT ⋂ ROYAL ⋂ RULER ) .$$

Here, the difference( ) operation removes any portion of the KING space that occupies the male feature region, and the union( ) with the intersection of FEMALE and the remaining traits adds back a space occupying the female feature region while preserving the person, adult, royal and ruler dimensions. In embodiments where features are encoded as axes, this transformation may be implemented by modifying only the intervals on the affected axes.

Encoding Traits as hasFeature Propositions

In other embodiments, or in addition to feature axes, traits may be encoded as propositions along semantic roles such as subject, predicate and object, as described in the section on coordinate systems and as used for the “Abe Lincoln likes Mary's maple syrup” example. Instead of representing a feature as a dedicated coordinate axis, the presence of a feature may be expressed as a 3-space in a subject×predicate×object key-space, for example using a proposition of the form:
hasFeature(henry_viii, person)
hasFeature(henry_viii, adult)
hasFeature(henry_viii, royal)
hasFeature(henry_viii, ruler)
hasFeature(henry_viii, male).

In such embodiments, each feature is represented by a 1-space on an axis of feature identifiers, such as feature/person, feature/royal, feature/male, and so on. The identity of an entity such as henry_viii may be represented by a 1-space on an axis of entity identifiers. A 3-space representing a hasFeature fact may then be formed as the Cartesian product of the entity's identity space, a 1-space representing the predicate hasFeature, and the 1-space representing the feature in question. Each such 3-space may be considered to “stretch” between a neutral partition representing the entity's mere existence and a region representing the asserted feature.

Under this encoding, the concept “king” may again be defined as the intersection of trait spaces, but now those trait spaces are derived from hasFeature propositions. For example, the key-space representing “all kings” may be obtained by intersecting the projections of the hasFeature 3-spaces for the features person, adult, royal, ruler and male onto the subject dimension:

$$KING\_SUBJECTS = project ( intersection ( hasFeature\_person , hasFeature\_adult , hasFeature\_royal , hasFeature\_ruler , hasFeature\_male ) , [ subjectDimension ] ) .$$

In practice, this may be implemented by intersecting the 3-spaces representing each hasFeature proposition and then projecting onto the subject axis, yielding a 1-space whose measure along the subject axis represents the set of entities that are kings. An analogous construction yields the set of queens by replacing hasFeature_male with hasFeature_female. The transformation “king−male+female” then corresponds to an operation on the hasFeature spaces: remove those hasFeature_male 3-spaces whose subjects are in KING_SUBJECTS, and add corresponding hasFeature_female 3-spaces, while leaving the remaining hasFeature propositions unchanged.

Because the underlying semantic coordinate system is shared, embodiments may freely move between these encodings. For example, a library may materialize feature axes derived from hasFeature propositions for optimization purposes, or it may re-express axis-based feature memberships as hasFeature 3-spaces when exporting data to an external system. In both cases, the combinatorial structure of traits and the identity of which entities are kings or queens remain invariant, as they are determined by geometric relationships between spaces rather than by any particular choice of schema.

### Invariance Properties

Using the king-queen example, several invariance properties of the KEY-SPACE DB may be illustrated:
1. Invariance to schema representation. Whether traits are encoded as separate axes, as hasFeature propositions, or as trait key-spaces attached to objects via an object/key-space mapping, the definition of “king” and “queen” as combinations of traits remains the same. Applications may change their internal representation (for example, migrating from columns to trait objects or vice versa) without changing the semantic regions corresponding to kings and queens.
2. Invariance to the addition of new traits. New traits such as “ghost”, “robot” or “digital_entity” may be introduced as additional trait spaces or features on the feature axis without disturbing existing definitions. For example, adding a ghost trait and asserting hasFeature(henry_viii, ghost) does not change whether henry_viii is in the king_trait space, as that space only depends on the intersection of person, adult, royal, ruler and male. Similarly, a “robot king” may be represented by adding a robot trait while leaving the existing traits for kings unchanged.
3. Invariance to time and versioning. By including time or version axes, embodiments may represent that an entity was once a king and is now a former king, or that succession has occurred, without altering the definition of the king_trait space itself. Instead, different time slices or versions of the same entity occupy different regions along the time or version axis, and the measure of their overlap with king_trait at each time point indicates whether they are kings at that time.
4. Invariance to quantity and granularity. As described earlier for other kinds of information, the use of measurable intervals allows the same trait system to represent fractions or aggregates of entities. For example, a hypothetical proposition about “half a person” or “n out of m eligible queens” may be encoded as partial intervals along an axis of identity portions, while their trait spaces remain defined in terms of feature combinations. The operations by which traits are added or removed do not depend on whether a subject is represented as a whole or as a collection of parts.
5. Invariance across applications. Once the combinatorial type “king” has been given a home in the global key-space—as an explicit intersection of trait spaces—multiple applications may reuse that definition without reinventing their own schema-specific encodings of kings and queens. Some applications may work directly with trait objects in an object-oriented language, others may issue SQL-like queries over trait columns, and yet others may manipulate trait spaces directly for analytical purposes. All these uses ultimately refer to the same underlying spatial regions.

By grounding combinatorial traits such as “king” and “queen” in explicit, measurable key-spaces, embodiments according to this disclosure combine the expressive, invariant feature composition familiar from latent vector models with the exact, transactional semantics of classical database engines. The same geometric machinery—unions, intersections, differences, products, projections and measures—used elsewhere in the KEY-SPACE DB may thus be used to model and query rich, overlapping type systems without sacrificing representation invariance when schemas, applications or requirements change.

### Example Method

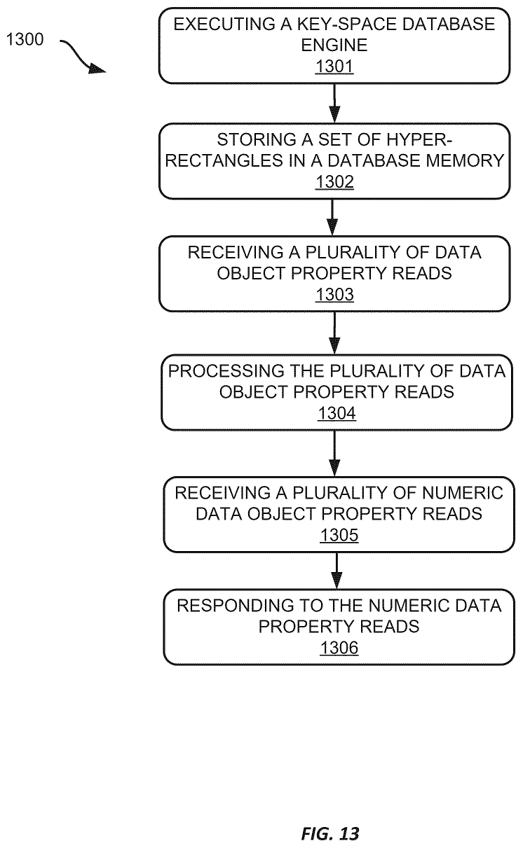

Referring now to FIG. 13, FIG. 13 shows an example method 1300 for database management, the method comprising:
At block 1301, executing, by a computing system, a database engine, said database engine storing semantic propositions using hyperrectangles as its fundamental unit of data storage. This is the key-space database used by ACME Corp's ERP system.;
At block 1302, storing, by said database engine, a set of stored hyperrectangles in a database memory, each of said stored hyperrectangles spanning at least two dimensions (in this case four dimensions corresponding to the semantic roles subject, predicate, object, and time) sharing a common coordinate domain (such that e.g. a dinghy may appear as the subject in one hyperrectangle and as the object in another);
wherein each of said dimensions comprises at least
   one symbolic component (e.g. “Person”, “John”, “f4d56a7b”, etc.); and
   one quantitative component (e.g. 5, 101.85, 1764795283, etc.);
At block 1303, receiving a plurality of data object property reads, each for an object value;
At block 1304, processing said data object property reads, the processing comprising
   determining, for each of said data object property reads, a first intersection between
      said stored hyperrectangles; and
      a set of at least one hyperrectangle obtained from said data object property read for an object value; and
   responding with object values each comprising the hyperrectangles from said first intersection corresponding to each of said data object property reads
wherein a plurality of said data object property reads each reference an object that was comprised in one of said responses;
At block 1305, receiving a plurality of numeric data object property reads, each for a numeric value; and
At block 1306, responding to said numeric property reads with a response comprising a measure of at least one interval of intervals received in response to a data object property read.
   This example involves events transpiring at ACME Corp. over three consecutive days in mid-December 2025.
   On Monday, December 15th, Alice, a warehouse worker at ACME's main warehouse, registers some arriving goods into the ERP system. The shipment from The Dinghy Company includes 2 dinghies and some other items. Alice uses his tablet to access the ERP system and creates a new purchase order:

let mondayTimestamp = 1734220800; // Monday Dec 15, 2025
let mondayOrder = new Order(mondayTimestamp, mondayTimestamp +
0.1);
let items = new OrderItem(3);
items.order = mondayOrder;
items.buyer = acmeCorp;
items.seller = dinghyCompany;
items.to = denverWarehouse;
let mondayDinghies = new Dinghy(2);
let item1 = items.subset(0, 1);
item1.bought = mondayDinghies;
item1.paid = new USD(400);
let item2 = items.subset(1, 1);
item2.bought = new MotorOil(12.34);
item2.paid = new USD(55);
let item3 = items.subset(2, 1);
item3.bought = new BowDockLine(7.5);
item3.paid = new USD(100);
db.transaction(function( ) {
receiveGoods(mondayOrder);
});

The next day, Tuesday, December 16th, an additional delivery of 10 dinghies arrives from the same supplier. Although they are the same type of dinghy, market conditions have changed and this batch costs significantly more. Alice registers the delivery:

let tuesdayTimestamp = 1734307200; // Tuesday Dec 16, 2025
let tuesdayOrder = new Order(tuesdayTimestamp,
tuesdayTimestamp + 0.1);
let tuesdayItem = new OrderItem(1);
tuesdayItem.order = tuesdayOrder;
tuesdayItem.buyer = acmeCorp;
tuesdayItem.seller = dinghyCompany;
tuesdayItem.to = denverWarehouse;
let tuesdayDinghies = new Dinghy(10);
tuesdayItem.bought = tuesdayDinghies;
tuesdayItem.paid = new USD(3000);
db.transaction(function( ) {
receiveGoods(tuesdayOrder);
});

As part of the purchase order processing, the dinghies become the property of ACME Corp.:

tuesdayDinghies.owner = acmeCorp;
denverWarehouse.available =
denverWarehouse.available.union(tuesdayDinghies);

After Tuesday's registration, the Denver warehouse has 12 dinghies in stock: 2 from Monday's delivery and 10 from Tuesday's.
Alice prints a dinghy ownership record report for the dinghies delivered on Tuesday, among other things. During report generation the ERP system reads:
tuesday_dinghies.owner /=>ACME Corp
On Wednesday, December 17th, Bob, a sales representative, sells 3 dinghies to a customer, John. The ERP system applies a first-in-first-out (FIFO) policy to determine which specific dinghies to allocate to the sale—goods received earlier are sold first. To do this, it queries the available dinghies sorted by purchase time:

```
let availableDinghies = db.query(‘
  SELECT d
  FROM Dinghy d, Warehouse w, OrderItem i
  WHERE w.available INCLUDES d
    AND w = denverWarehouse
    AND i.bought INCLUDES d
  SLICE d BY 1
  ORDER BY i.order.timestamp
‘);
```

The ERP system then registers the sale, taking the first 3 dinghies from the sorted list (2 from Monday's delivery, 1 from Tuesday's):

let soldDinghies = availableDinghies.subset(0, 3);
let wednesdayTimestamp = 1734393600; // Wednesday Dec 17, 2025
let saleOrder = new Order(wednesdayTimestamp, wednesdayTimestamp +
0.1);
let saleItem = new OrderItem(1);
saleItem.order = saleOrder;
saleItem.buyer = john;
saleItem.seller = acmeCorp;
saleItem.bought = soldDinghies;
saleItem.paid = new USD(900);
db.transaction(function( ) {
processSale(saleOrder);
});

John is now the owner of the 3 sold dinghies, and they are removed from the warehouse's available inventory:

soldDinghies.owner = john;
denverWarehouse.available =
denverWarehouse.available.difference(soldDinghies);

To keep track o warranties, ACME Corp. also records the Hull Identification Number (HIN) of each sold dinghy:

let hullIds = [“AC-DEN-1001”, “AC-DEN-1002”, “AC-DEN-1003”];
for (let [dinghy, i] of soldDinghies.oneByOne( )) {
dinghy.hullId = hullIds[i];
}

After the order has been processed an order confirmation is printed as a PDF with the following content:

Order Confirmation: Customer: John Smith Delivery
Address: 123 Maple St, Springfield, USA

| Product | Ordered Qty. | Unit Price | Total Price |
|---|---|---|---|
| Dinghy | 3 | $300 | $900 |

To generate this PDF, the ERP system executes code such as the following:

```
function printOrderConfirmation(order: Order) {
  let doc = new PDFDocument( );
  doc.add(“Order Confirmation:”);
  doc.add(“Customer: ” + order.item.buyer.name);
  doc.add(“Delivery Address: ” +
  order.items.buyer.postalAddress.toString( ));
  let table = doc.addTable([“Product”, “Ordered Qty.”, “Unit Price”,
  “Total Price”]);
  for (let item of order.items.oneByOne( )) {
    let row = table.createRow( );
    row.set(“Product”, item.product.name);
    row.set(“Order Qty.”, item.bought.quantity);
    row.set(“Unit Price”, item.paid.quantity / item.bought.quantity);
    row.set(“Total Price”, item.paid.quantity);
  }
  doc.printPDF( );
}
db.transaction(function( ) {
  printOrderConfirmation(order);
});
```

Alice prints a dinghy ownership record report for the dinghies delivered on Tuesday, among other things. During report generation the ERP system reads:
tuesday_dinghies.owner //=>ACME & John

In this embodiment example, the database engine is:
executing, by one or more processors of a computing system, a database engine;
storing, by said database engine, a first stored space descriptor in a data store memory, said first stored space descriptor in reference to a coordinate system comprising a plurality of coordinate axes each comprising both
   a symbolic component; and
   a quantitative component;
receiving a first data-update instruction, on said tuesday, to set a first property owner of a first data object dinghies_tuesday to a first property value acme
   dinghies_tuesday.owner=acme;
processing said first data-update instruction comprising
   obtaining, from said first data object, dinghies_tuesday (defined in a base class to the Dinghy class) a first subject space descriptor {[“Dinghy”, “f6de3c”, 2 . . . 12]};
   obtaining, from said first property value acme, a first object space descriptor; and
   determining a first update space descriptor describing a product space comprising
      the space described by said first subject space descriptor; and
      the space described by said first object space descriptor;
updating, in a first update, said data store memory to store a second stored space descriptor describing a space comprising the union of:
   the space described by said first stored space descriptor; and
   the space described by said first update space descriptor
      (On the subject axis, the k-interval set describing the dinghies for which the property is being written is {[“Dinghy”, “f6de3c”, 2 . . . 12]1.)
receiving, after said first update, a first data-retrieval instruction to read said first property owner of said first data object dinghies_tuesday
   The ERP system reads the owner property of the dinghies tuesday:
   dinghies_tuesday.owner//=>ACME Corp;
processing said first data-retrieval instruction, the processing comprising
   generating a query space descriptor using said first subject space descriptor;
   determining a first result space descriptor describing the intersecting space between:
      the space described by said second stored space descriptor; and
      the space described by said query space descriptor,
   the space described by said first result space descriptor comprising the intersecting space between:
      the space described by said first update space descriptor; and
      the space described by said query space descriptor
         (The database engine reads the owner property of dinghies_tuesday by constructing a query space descriptor and intersecting it with the stored space. The result is projected to extract the owner value.

```
▪ let ownerSpace = db.readProperty(txId, dinghies_tuesday.key,
“owner”);
  // Returns: {[“Company”, “acme”, 0..1]}
  )
```

and
responding to said first data-retrieval instruction with a value based on said first result space descriptor;
receiving, after said processing said first data-retrieval instruction, a second data-update instruction to set said first property owner of a second data object soldDinghies to a second property value john
soldDinghies.owner=john;
processing said second data-update instruction comprising
   obtaining, from said second data object dinghies_tuesday (defined in a base class to the Dinghy class) a second subject space descriptor, {[“Dinghy”, “f6de3c”, 2 . . . 12]} the space described by said second subject space descriptor different from but sharing an intersection with the space described by said first subject space descriptor;
   obtaining, from said second property value john a second object space descriptor; and
   determining a second update space descriptor describing a product space comprising
      the space described by said second subject space descriptor; and
      the space described by said second object space descriptor;
updating, in a second update, said data store memory to store a third stored space descriptor describing a space comprising the union of:
   the space described by said second stored space descriptor; and
   the space described by said second update space descriptor;
receiving, after said second update, a second data-retrieval instruction to read said first property owner of said first data object dinghies tuesday; and
processing said second data-retrieval instruction, the processing comprising
   determining a second result space descriptor describing the intersecting space between:
      the space described by said third stored space descriptor; and
      the space described by said query space descriptor,
   the space described by said second result space descriptor comprising the intersecting space between:
      the union of:
         the space described by said first update space descriptor; and
         the space described by said second update space descriptor; and
      the space described by said query space descriptor;
   determining a second response value based on said second result space descriptor
      (The database engine reads the owner property of dinghies_tuesday by constructing a query space descriptor and intersecting it with the stored space. The result is projected to extract the owner value.

```
▪ let ownerSpace = db.readProperty(txId, dinghies_tuesday.key,
“owner”);
▪ // Returns: {
▪ // [“Company”, “acme”, 0..1],
▪ // [“Agent”, “Person”, “f6de3c”, 456..457]
  // }
  )
```

and
responding to said second data-retrieval instruction with a value based on said second result space descriptor.

The method of claim 2 further comprising
creating, after said first update, a following transaction comprising
   a read list comprising a read space descriptor; and
   a write list comprising
      an added space descriptor; and
      a removed space descriptor;
receiving a third data-retrieval instruction to read said first property of a third data object in the context of said following transaction;
processing, in the context of said following transaction, said third data-retrieval instruction, the processing comprising
   obtaining, from said third data object, a third subject space descriptor, the space described by said third subject space descriptor sharing an intersection with the space described by said first subject space descriptor;
   o generating a third query space descriptor using said third subject space descriptor;
   updating the read list of said following transaction to comprise said third query space descriptor;
   determining a committed result space descriptor describing the intersecting space between:
      the space described by said third stored space descriptor; and
      the space described by said third query space descriptor;
   determining a third result space descriptor describing the space described by said committed result space descriptor modified to account for uncommitted changes in said write list; and
   responding to said third data-retrieval instruction with a value based on said third result space descriptor;
receiving a third data-update instruction to set a second property of a fourth data object to a third property value in the context of said following transaction;
processing, in the context of said following transaction, said third data-update instruction, the processing comprising
   obtaining, from said fourth data object a fourth subject space descriptor;
   obtaining, from said third property value a third object space descriptor;
   determining a third update space descriptor describing a product space comprising
      the space described by said fourth subject space descriptor; and
      the space described by said third object space descriptor; and
   updating a space descriptor of said write list to comprise said third update space descriptor;
detecting a transaction conflict by determining a non-empty intersection between
   the space described by the read space descriptor of said following transaction; and
   the space described by an updated space descriptor of a preceding transaction, said updated space descriptor selected from the group consisting of
      the added space descriptor of said preceding transaction; and
      the removed space descriptor of said preceding transaction; and
   executing a transaction conflict action.

The following is an example of a computer implemented method for database runtime management, said method executed on one computing system and comprising
maintaining, by a database engine executing on said one or more processors, in a data store memory, a global key-space comprising
   a first axis (such as for example a subject axis);
   a second axis (such as for example a predicate axis);
   a third axis (such as for example an object axis); and
   a fourth axis (such as for example a time axis);
maintaining, by said database engine, an object-to-key-space mapping comprising
   a plurality of programming language objects;
   a plurality of object spatial descriptors;
   a plurality of object key-spaces in said global key-space;
   for a first programming language object of said plurality of programming language objects, a first object key-space of said plurality of object key-spaces comprising on said first axis, a first object interval descriptor; and
   storing said plurality of object spatial descriptors;
receiving, by said database engine, a first property-write instruction;
obtaining, by said database engine based on said first property-write instruction, a first property space descriptor comprising
   on said first axis said first object interval descriptor associated with said first programming language object;
   on said second axis a first property interval descriptor associated with said first property identifier;
   on said third axis a first value interval descriptor associated with said first property value descriptor; and
   on said fourth axis a first time interval descriptor;
updating, in a first update, said data store memory to a first updated global key-space comprising combining said first property space descriptor with a previous global key-space such as for example adding or replacing propositions about said first programming language object having said first property value;
receiving, by said database engine after said first update, a first property-read instruction;
obtaining, by said database engine based on said first property-read instruction, a first query space descriptor comprising
   on said first axis said first object interval descriptor associated with said first programming language object;
   on said second axis said first property interval descriptor associated with said first property identifier;
   on said third axis a query value interval descriptor that encompasses possible values for said first property value descriptor; and
   on said fourth axis a query time interval descriptor;
determining a first overlapping space descriptor between
   said first updated global key-space; and
   said first query space descriptor;
generating, by said database engine, a first response value based on said first overlapping space descriptor; and
responding, by said database engine, to said first property-read instruction with said first response value.

A method comprising
executing, by one or more processors of a computing system, a database engine;
storing, by said database engine, a first stored space descriptor in a data store memory, said first stored space descriptor in reference to a coordinate system comprising a plurality of coordinate axes each comprising both
   a symbolic component; and
   a quantitative component;
receiving, by said database engine, a data-update instruction to set a property bought of a first data object saleItem to a property value soldDinghies, said first data object comprising a first primary key space descriptor;
obtaining an additional space descriptor based on
   said first data object saleItem;
   said property bought; and
   said property value soldDinghies;
updating said data store memory to store an updated stored space descriptor comprising a union of
   said first stored space descriptor; and
   said additional space descriptor;
receiving, by said database engine, a data-retrieval instruction to get a quantitative value from said property bought of a second data object saleItem, said second data object comprising a second primary key space descriptor, said second primary key space descriptor overlapping with said first primary key space descriptor;
obtaining a query space descriptor based on
   said second data object saleItem; and
   said property bought;
determining an overlapping space descriptor between
   said query space descriptor; and
   said updated stored space descriptor;
measuring an extent of said overlapping space descriptor along at least one of said coordinate axes (the object axis) to obtain a measure 3;
determining said quantitative value based on said measure;
generating a response comprising said quantitative value 3; and
responding to said data-retrieval instruction with said response (thus producing the number 3 in the printed PDF).

The method of claim 5 wherein said space descriptors each comprise a set of disjoint k-intervals.

The method of claim 6 wherein said data store memory comprises at least one index structure storing said k-intervals of
said first stored space descriptor; and
said updated stored space descriptor,
   said index structure selected from the group consisting of
B-trees;
R-trees;
kD-trees;
skip lists; and
balanced binary trees.

The method of claim 5 wherein
said property value comprises a property value space descriptor;
said additional space descriptor is obtained by a product operation combining
   said first primary key space descriptor; and
   said property value space descriptor; and
said query space descriptor is obtained by a product operation combining said second primary key space descriptor with at least one other space descriptor.

A method comprising
executing, by one or more processors of a computing system, a database engine;
storing, by said database engine, a stored space descriptor in a data store memory, said stored space descriptor defined by a coordinate system comprising
   a subject axis; and
   an object axis
wherein said subject axis shares a common coordinate domain with said object axis;
receiving, by said database engine, a first data-retrieval instruction to read a first property owner of a first data object order.items, said first data object comprising a first primary key space descriptor;
obtaining a first query space descriptor based on said first primary key space descriptor;
determining a first overlapping space descriptor between
   said first query space descriptor; and
   said stored space descriptor
in reference to said first property;
projecting said first overlapping space descriptor onto said object axis to obtain a second primary key space descriptor;
generating a first response comprising said second primary key space descriptor;
responding to said first data-retrieval instruction with said first response;
receiving, by said database engine, a second data-retrieval instruction to read a second property postalAddress of said second primary key space descriptor;
   obtaining a second query space descriptor based on said second primary key space descriptor;
determining a second overlapping space descriptor between
   said second query space descriptor; and
   said stored space descriptor
in reference to said second property;
projecting said second overlapping space descriptor onto said object axis to obtain a third primary key space descriptor;
generating a second response comprising said third primary key space descriptor; and
responding to said second data-retrieval instruction with said second response (providing the address printed on the order confirmation).

The method of claim 9 wherein said space descriptors each comprise a set of disjoint k-intervals along said common coordinate domain.

The method of claim 10 wherein said k-intervals are recursively divisible into sub-intervals. The method of claim 10 wherein said data store memory comprises at least one index structure storing said k-intervals of said space descriptors, said index structure selected from the group consisting of
multi-way trees;
balanced binary trees; and
skip lists.
   The following example involves a series of events that transpire on the morning of Tuesday, Dec. 2, 2025, at ACME Corp.'s main warehouse in Miami. A shipment from one of ACME Corp.'s suppliers arrives at the warehouse. The shipment contains 1000 meters of bow dock line, 100 dinghies, 10 motorboats and 1 yacht.
   When the shipment arrives, Alice, a warehouse worker, uses her mobile device to access the ERP system and register a new purchase order, to which she adds the received goods. The ERP system executes code similar to the following:

// Create an order event, with a timestamp representing the current time.
let timestamp = now( );
let order = new Order(timestamp, timestamp+0.1);
// Create the order items and set common properties.
let items = new OrderItem(4);
items.order = order;
items.seller = ernestsBoatingSupplies;
items.buyer = acmeCorp;
items.from = ernestsBoatingSuppliesWarehouse;
items.to = acmeCorpMiamiWarehouse;
// Add the individual items.
let item1 = items.subset(0, 1);
item1.bought = new BowDockLine(1000); // 1000 meters of bow dock
line

| | |
|---|---|
| item1.paid = new USD(5000); | // $5 per meter |

let item2 = items.subset(1, 1);

| | |
|---|---|
| item2.bought = new Dinghy(100); | // 100 dinghies |
| item2.paid = new USD(200000); | // $2000 per dinghy |

let item3 = items.subset(2, 1);

| | |
|---|---|
| item3.bought = new Motorboat(10); | // 10 motorboats |
| item3.paid = new USD(150000); | // $15,000 per motorboat |

let item4 = items.subset(3, 1);

| | |
|---|---|
| item4.bought = new Yacht(1); | // 1 yacht |
| item4.paid = new USD(5000000); | // $5,000,000 for the yacht |

Although a real-world ERP system would typically work with separate purchase order and goods receipt documents, for the sake of simplicity, we will assume that the ERP system works with purchase orders as its primary document type, and that the receipt of goods is implicitly handled as part of the purchase order processing.
After Alice has finished entering the order items into the ERP system, she presses the “Receive Goods” button on her mobile device. This action triggers the ERP system to update the inventory levels in the warehouses involved in the transaction. To do this the ERP system executes application code similar to the following:

```
function receiveGoods(order: Order) {
  for (let item of order.items.oneByOne( )) {
    let from = item.from, to = item.to, bought = item.bought;
    // Decrease inventory in the warehouse the goods are coming from.
    from.available = from.available.difference(bought);
    // Increase inventory in the warehouse the goods are going to.
    to.available = to.available.union(bought);
  }
}
// Execute a transaction to receive the goods.
db.transaction(function( ) {
  receiveGoods(order);
});
```

After the goods have been received, the ERP system generates a goods receipt confirmation screen on Alice's mobile device, showing the order items as well as the final inventory levels in the warehouse after the receipt. To do this, the ERP system executes the following application code:

```
function showReceiptConfirmation(order: Order) {
  let table = new UITable([
    “Product Name”,
    “Order Qty”,
    “Total Price”,
    “Final Inventory”
  ]);
  for (let item of order.items.oneByOne( )) {
    table.set(“Product Name”, item.bought.name);
    table.set(“Order Qty”, item.bought.measure( ));
    table.set(“Total Price”, item.paid.measure( ));
    // Get the final inventory of the given product type in the receiving warehouse.
    let productType = item.bought.type; // e.g. BowDockLine
    let available = item.to.available.filterByType(productType);
    table.set(“Final Inventory”, available.measure( ));
  }
  table.show( );
}
// Execute a read-only transaction to show the receipt confirmation.
db.readonlyTransaction(function( ) {
  showReceiptConfirmation(order);
});
```

This results in the following goods receipt confirmation table being displayed on Alice's mobile device:

| Product | Order Qty. | Total Price | Final Inventory |
|---|---|---|---|
| Bow Dock Line | 1000 | 500 | 4000 |
| Dinghy | 100 | 200,000 | 400 |
| Motorboat | 10 | 150,000 | 40 |
| Yacht | 1 | 5,000,000 | 4 |

At the same time as Alice is receiving the shipment in the warehouse, Bob, a sales representative working for ACME Corp., gets a call from a customer who is interested in purchasing some bow dock line. While on the phone with the customer, Bob opens the ERP application using the web browser on his workstation. He creates a new sales order draft, enters the customer's details, and adds an order item for 7.5 metres of bow dock line—the quantity requested by the customer. The ERP application shows him the following table:

Draft Sales Order:

| Product | Order Qty. | Available Qty. | Unit Price | Total Price |
|---|---|---|---|---|
| Bow Dock Line | 7.5 | 3000 | 5 | 37.5 |

Since the table above only shows 3,000 meters of dock line available, we can infer that the events thus far have taken place prior to Alice's goods receipt, which saw the available quantity increase by 1,000 meters to 4,000 meters. Now, just as Alice finishes registering the received goods, Bob comes to an agreement with his customer on the pricing and delivery terms of the order. Thus, by coincidence, Bob presses the “Approve Order” button at virtually the same instant as Alice presses the “Receive Goods” button on her mobile device. The approval of Bob's sales order triggers the following application logic:

```
function approveOrder(order: Order) {
  for (let item of order.items.oneByOne( )) {
    let from = item.from, bought = item.bought;
    // ... check availability, etc. ...
    // Move the bought goods from ‘available’ to ‘reserved’ in the warehouse that
    // the order is being fulfilled from.
    from.available = from.available.difference(bought);
    from.reserved = from.reserved.union(bought);
  }
  order.status = “Approved”;
}
// Execute a transaction to approve the order.
db.transaction(function( ) {
  approveOrder(salesOrder);
});
```

Both Alice's and Bob's button presses result in transactions being started in the database engine. Due to the timing of their actions, these transactions both start at the same time, leading to them being assigned the same starting database generation number, and therefore observing the same version of the database state.
By chance, Alice's transaction completes its work slightly faster than Bob's transaction. Since there were no other concurrently executing transaction, Alice's transaction is able to commit successfully, updating the database state to reflect the received goods.
However, when the ERP system attempts to commit Bob's transaction, the database engine detects a conflict with Alice's transaction. This is because:
   Alice's and Bob's transactions started concurrently, meaning that neither was able to observe the changes made by the other—they both saw the same initial database state, due to the isolation guarantees provided by the example database engine.
   Alice's transaction updated the available property of ACME Corp.'s Miami warehouse to reflect the receipt of 1,000 meters of bow dock line. This update was recorded in Alice's transaction's write list.
   Bob's transaction read the value of the available property of ACME Corp.'s Miami warehouse when determining whether there was sufficient stock to fulfill the sales order. This read was recorded in Bob's transaction's read list.
   An overlap therefore exists between Bob's transaction's read list, and the write list of at least one transaction that was committed after Bob's transaction started (i.e. Alice's transaction). This overlap indicates that Bob's transaction has read data that has been modified by another transaction that has committed since Bob's transaction started, violating the consistency guarantees provided by the example database engine.
As a result of the detected conflict, the database engine rejects the ERP system's commit instruction for Bob's transaction. In this case, since the conflict was related to an order approval, which may require user intervention to resolve, the ERP system notifies Bob of the conflict, prompting him to review the order and take appropriate action. Bob, upon receiving the notification, verifies the current inventory, and then presses “Approve” again—this time, the transaction is able to commit successfully, and the order is approved.

The following is an example of a computer implemented method for database runtime management, said method executed on one or more processors in a computing system and comprising:
executing, by one or more processors of a computing system, a database engine;
storing, by said database engine, a first stored space descriptor in a data store memory, said first stored space descriptor in reference to a coordinate system comprising a plurality of coordinate axes wherein coordinates along at least one of said coordinate axes comprise both
   symbolic components; and
   quantitative components;
receiving, by said database engine, a first data-update instruction
   (In this example, when Alice presses the “Receive Goods” button, the ERP system executes the receiveGoods(order) function within a database transaction. For each order item, this function updates the available property of the receiving warehouse. For instance, when processing the bow dock line item, the statement to.available=to.available.union(bought) increases the Miami warehouse's available inventory by 1,000 meters.
   As described above, the Object/Key-space Mapper (OKSM) library in this example translates such property assignments into data-update instructions. In this case, the assignment may be translated into a call similar to db.writeProperty(txId, miamiWarehouse.key, “available”, newAvailable.key), which sends a WRITE_PROPERTY data-update instruction to the database engine. In this example, the instruction comprises:
      The instruction type (WRITE_PROPERTY)
      The transaction identifier for Alice's goods receipt transaction
      The k-interval set describing the warehouse data object, in this case {[“Warehouse”, “f6de3c”, 4 . . . 5]} for ACME Corp.'s Miami warehouse
      The property identifier “available”
      The k-interval set describing the updated inventory value, comprising the union of the previously available 3,000 meters and the newly received 1,000 meters, e.g. {[“DockLine”, “BowDockLine”, “f6de3c”, 5500 . . . 8500]; [“DockLine”, “BowDockLine”, “f6de3c”, 12200 . . . 13200]}. In this example, since the received goods originate from a different source (Ernest's Boating Supplies), they may occupy a different numeric range (12200 . . . 13200) than the existing inventory (5500 . . . 8500), resulting in a k-interval set comprising two disjoint intervals whose measures sum to 4,000.)
obtaining a first additional space descriptor based on said first data-update instruction
   (In this example, the database engine obtains the first additional space descriptor by using the product(function to combine the following 1-dimensional k-interval sets into a 4-dimensional k-interval set:
      On the subject axis, the k-interval set describing the data object for which the property is being written, obtained from the instruction: {[“Warehouse”, “f6de3c”, 4 . . . 5]}
      On the predicate axis, a k-interval set describing the property being written, resolved from the property identifier in the instruction: {[“Property”, “available”]}
      On the object axis, the k-interval set describing the new inventory value, obtained from the instruction: {[“DockLine”, “BowDockLine”, “f6de3c”, 5500 . . . 8500]; [“DockLine”, “BowDockLine”, “f6de3c”, 12200 . . . 13200}
      On the time axis, a k-interval set starting at the current time and extending without bound: {[“Time”, 1733011200 . . . ∞]}, where 1733011200 represents Tuesday, Dec. 2, 2025 in seconds since the UNIX epoch
   The resulting 4-dimensional k-interval set (space descriptor) represents the proposition that, as of the current time and going forward, the Miami warehouse has 4,000 meters of bow dock line available.)
updating said data store memory to store a second stored space descriptor comprising a union of
   said first stored space descriptor; and
   said first additional space descriptor
(in our example, said updating is done when the ERP application decides to issue a commit instruction to a write transaction together with the other updates for other received items);
receiving, by said database engine, a first data-retrieval instruction
   (After Alice's goods receipt transaction commits, the ERP system starts a new read-only transaction to generate a confirmation screen showing the updated inventory. For each received item, the code calls item.to.available.filterByType(productType) to read only the inventory of the relevant product type. The OKSM library translates this into a READ_PROPERTY_FILTERED instruction. Unlike READ_PROPERTY, which returns the entire property value, READ_PROPERTY_FILTERED includes an additional k-interval set that constrains the property value space of interest. The instruction comprises:
      The instruction type (READ_PROPERTY_FILTERED)
      The transaction identifier for Alice's read-only transaction, TXN456
      The k-interval set {[“Warehouse”, “f6de3c”, 4 . . . 5]} describing the Miami warehouse
      The property identifier “available”
      A filter k-interval set {[“DockLine”, “BowDockLine”, MIN . . . MAX]} constraining the property value space to bow dock line inventory only);
and
processing said first data-retrieval instruction, the processing comprising
   obtaining a first query space descriptor based on said first data-retrieval instruction
      (As with Bob's read instruction, the database engine uses the product(function construct a 4-dimensional query space. The key difference is that on the object axis, instead of using the universal range {[MIN . . . MAX]}, the engine uses the filter k-interval set from the instruction: {[“DockLine”, “BowDockLine”, MIN . . . MAX]}. The resulting query space is:

| | |
|---|---|
| ▪ | {[“Warehouse”, “f6de3c”, 4..5]} |
| ▪ | × {[“Property”, “available”]} |
| ▪ | × {[“DockLine”, “BowDockLine”, MIN..MAX]} |
| | × {[“Time”, 1733011200..1733011200.1]} |

This query may only match bow dock line inventory, rather than all available inventory.)
determining an first overlapping space descriptor between
   said second stored space descriptor; and
   said first query space descriptor
      (The database engine computes the intersection of the query space with the stored key-space. Since Alice's goods receipt transaction has now committed, the stored space includes her updates. The relevant excerpt of the stored key-spaces is:

| | |
|---|---|
| ▪ | {[“Warehouse”, “f6de3c”, 4..5]} |
| ▪ | × {[“Property”, “available”]} |
| ▪ | × {[“DockLine”, “BowDockLine”, “f6de3c”, 5500..8500]; |
| ▪ | [“DockLine”, “BowDockLine”, “f6de3c”, 12200..13200]} |
| | × {[“Time”, 1733011200..∞]} |

The intersection of this with the query space above yields:

```
  {[“Warehouse”, “f6de3c”, 4..5]}
× {[“Property”, “available”]}
× {[“DockLine”, “BowDockLine”, “f6de3c”, 5500..8500];
  [“DockLine”, “BowDockLine”, “f6de3c”, 12200..13200]}
× {[“Time”, 1733011200..1733011200.1]}
```

This represents the updated inventory of 4,000 meters of bow dock line.)
generate a first response based on said first overlapping space descriptor
   (As before, the database engine uses project( . . . , [2]) to extract the object dimension, yielding:

| | |
|---|---|
| ▪ | {[“DockLine”, “BowDockLine”, “f6de3c”, 5500..8500]; |
| | [“DockLine”, “BowDockLine”, “f6de3c”, 12200..13200]} |

This represents the 4,000 meters of bow dock line now available.)
; and
responding to said first data-retrieval instruction with said first response
   (The database engine sends the response back to the ERP system. The OKSM library creates a DockLine instance whose key is set to the returned k-interval set, and the application code calls available.measure( ) to display the final inventory of 4,000 meters on Alice's confirmation screen.)

The method may include that said space descriptor is a set of at least one hyper-rectangle in one or more dimensions including:
one-dimensional intervals;
two-dimensional rectangles;
three-dimensional cuboids; and
k-dimensional hyper-rectangles.

The method may include that
said first data-update instruction comprises data expressing an asserted semantic proposition; and
said first data-retrieval instruction comprises data expressing an query semantic proposition.

The method may include that said first stored, first additional, second stored and first query space descriptor comprise at least two dimensions in said coordinate system collectively expressing at least two semantic roles selected from the group consisting of:
a subject semantic role;
a predicate semantic role;
a object semantic role;
a time semantic role;
a believer semantic role;
a branch semantic role;
a version semantic role;
a theory semantic role; and
a universe semantic role.

The method may include that
said first data-update instruction specifies
   a first data object;
   a first property; and
   an first updated property value; and
said obtaining a first additional space descriptor comprises obtaining a space descriptor by combining:
   a space descriptor in one or more dimensions is based on said first data object; and
   a space descriptor in one or more dimensions is based on said first updated property value.

The method may include that
said first data-retrieval instruction specifies
   a second data object; and
   a second property; and
said obtaining a first query space descriptor comprises obtaining a space descriptor by combining:
   a space descriptor in one or more dimensions is obtained based on said second data object; and
   a space descriptor in one or more dimensions is generated based on said second property.

The method may further comprise:
creating a transaction
   (When Bob presses the “Approve Order” button, the ERP system in this example calls db.transaction(to execute the approveOrder(salesOrder) function within a transactional context. The OKSM library translates this into a call to db.createTransaction( ), which sends a transaction creation request to the database engine. The database engine responds by creating a new transaction and returning a transaction identifier, such as TXN123. This identifier will be used to associate subsequent data-retrieval and data-update instructions with Bob's transaction, allowing the database engine to track what Bob's transaction has read and written, and to detect conflicts with other concurrently executing transactions, such as Alice's goods receipt transaction.);
receiving, by said database engine, a preceding data-retrieval instruction
   (As Bob's transaction executes the approveOrder( ) function, it needs to move the purchased goods from available inventory to reserved inventory. To do this, the application code reads from.available to obtain the current available inventory, so that it can compute the difference after reserving the purchased quantity. The OKSM library translates this property access into a call to db.readProperty(“TXN123”, miamiWarehouse.key, “available”), which sends a READ_PROPERTY data-retrieval instruction to the database engine. In this example, the instruction comprises:
      The instruction type (READ_PROPERTY)
      The transaction identifier for Bob's order approval transaction (TXN123)
      The k-interval set describing the warehouse data object, in this case {[“Warehouse”, “f6de3c”, 4 . . . 5]} for ACME Corp.'s Miami warehouse
      The property identifier “available”);
processing said preceding data-retrieval instruction, in reference to said transaction, the processing comprising
   obtaining a preceding space descriptor based on said preceding data-retrieval instruction
      (In this example, the database engine obtains the preceding space descriptor by using the product(function to combine the following 1-dimensional k-interval sets into a 4-dimensional k-interval set:
         On the subject axis, the k-interval set describing the data object for which the property is being read, obtained from the instruction: {[“Warehouse”, “f6de3c”, 4 . . . 5]}
         On the predicate axis, a k-interval set describing the property being read, resolved from the property identifier in the instruction: {[“Property”, “available”]}
         On the object axis, the k-interval set encompassing all possible values: {[MIN . . . MAX]}
         On the time axis, a k-interval set describing the current time: {[“Time”, 1733011200 . . . 1733011200.1]}
      The resulting 4-dimensional k-interval set is:

{[“Warehouse”, “f6de3c”, 4..5]}
× {[“Property”, “available”]}
× {[MIN..MAX]}
× {[“Time”, 1733011200..1733011200.1]}

This represents a query for all values of the available property of the Miami warehouse at the current time.);
determining an preceding overlapping space descriptor between
   said first stored space descriptor; and
   said preceding space descriptor
      (In this example, the database engine uses the transaction-aware read( ) function to compute the intersection of the preceding space descriptor with the stored key-space. First, the read is recorded in Bob's transaction's read list for later conflict detection. Then, the intersection is computed using Bob's transaction's snapshot generation, ensuring that Bob sees a consistent view of the database as it existed when his transaction started. Since Bob's transaction has not yet made any writes, the result is simply the intersection with the stored snapshot.
      Since both Alice's and Bob's transactions started at the same database generation, Bob's snapshot does not include Alice's goods receipt. The relevant excerpt of the stored key-space is:

{[“Warehouse”, “f6de3c”, 4..5]}
× {[“Property”, “available”]}
× {[“DockLine”, “BowDockLine”, “f6de3c”, 5500..8500]}
× {[“Time”, 1732406400..∞]}

The intersection of this stored space with the preceding space descriptor above yields the 4-dimensional k-interval set:

{[“Warehouse”, “f6de3c”, 4..5]}
× {[“Property”, “available”]}
× {[“DockLine”, “BowDockLine”, “f6de3c”, 5500..8500]}
× {[“Time”, 1733011200..1733011200.1]}

This represents the proposition that t e Miami warehouse has 3,000 meters of bow dock line available at the queried time.);
generating a preceding response based on said preceding overlapping space descriptor
   (The database engine generates the preceding response by using project(precedingOverlappingSpace, [2]) to extract the object dimension (dimension 2) from the preceding overlapping space descriptor. This yields the 1-dimensional k-interval set:
   {[“DockLine”, “BowDockLine”, “f6de3c”, 5500 . . . 8500]}
   This represents the value of the available property: 3,000 meters of bow dock line.);
and
responding to said preceding data-retrieval instruction with said preceding response
   (The database engine sends the preceding response back to the ERP system in a network message. The OKSM library receives this response and creates a DockLine instance whose key is set to the returned k-interval set. Bob's transaction now has the current available inventory value, which it will use to compute the new value after reserving the purchased quantity.);
receiving, by said database engine, a second data-update instruction in reference to said transaction
   (Having read the available property and computed the difference, Bob's transaction now writes to the reserved property to reserve the purchased quantity. The statement from.reserved=from.reserved.union(bought) is translated by the OKSM library into a WRITE_PROPERTY data-update instruction, similar to Alice's write instruction described above.);
obtaining a second additional space descriptor based on said second data-update instruction
   (As with Alice's write instruction, the database engine uses product(to construct a 4-dimensional space descriptor from the instruction's components, representing the updated reserved property value for the Miami warehouse.);
determining an overlapping space descriptor between
   said preceding space descriptor; and
   said first additional space descriptor
      (When Bob's transaction attempts to commit, the database engine runs detectConflicts( ) to check for overlaps between Bob's transaction's read list and the write lists of transactions that have committed since Bob's transaction started. In this case, Alice's transaction has already committed.
      Bob's read list includes the preceding space descriptor:

{[“Warehouse”, “f6de3c”, 4..5]}
× {[“Property”, “available”]}
× {[MIN..MAX]}
× {[“Time”, 1733011200..1733011200.1]}

Alice's write list includes the first additional space descriptor:

```
  {[“Warehouse”, “f6de3c”, 4..5]}
× {[“Property”, “available”]}
× {[“DockLine”, “BowDockLine”, “f6de3c”, 5500..8500];
  [“DockLine”, “BowDockLine”, “f6de3c”, 12200..13200]}
× {[“Time”, 1733011200..∞]}
```

The intersection of these two space descriptors yields:

```
  {[“Warehouse”, “f6de3c”, 4..5]}
× {[“Property”, “available”]}
× {[“DockLine”, “BowDockLine”, “f6de3c”, 5500..8500];
  [“DockLine”, “BowDockLine”, “f6de3c”, 12200..13200]}
× {[“Time”, 1733011200..1733011200.1]}
```

This non-empty overlapping space descriptor indicates a conflict: Bob's transaction read data that Alice's transaction subsequently modified.);
and
executing a transaction conflict action
   (As a result of the detected conflict, the database engine rejects the commit instruction for Bob's transaction and responds with a conflict error to the ERP system. Bob's transaction is rolled back, and the ERP system notifies Bob of the conflict, prompting him to review the order and retry.)

A method comprising:
executing, by one or more processors of a computing system, a database engine;
processing, by said database engine, a first data-retrieval instruction to obtain a result space descriptor;
slicing said result space descriptor along an axis by a slice measure to obtain a plurality of slice space descriptors; and
for each slice space descriptor in said slice space descriptors, processing, by said database engine, a data-access instruction comprising said slice space descriptor, said data-access instruction selected from the group consisting of
   a data-retrieval instruction; and
   a data-update instruction.

The method may further include that said slice measure is 1.

The method may further include that said result space descriptor comprises a set of disjoint k-intervals wherein
each a k-interval comprises, along said axis, a minimum coordinate and a maximum coordinate
   said minimum coordinate comprising
      a common prefix comprising at least one symbolic component; and
      a first quantitative component; and
   said maximum coordinate comprising
      said common prefix; and
      a second quantitative component; and
the difference between
   said second quantitative component; and
   said first quantitative component
is divisible by said slice measure.

### OTHER EXAMPLES

### Example 1

A method comprising:
executing, by a computing system, a database engine, said database engine storing semantic propositions using hyperrectangles as its fundamental unit of data storage (in the same way that a rows and tables are the fundamental units of storage in a relational database; nodes and edges are the fundamental units of storage in a graph database; and a geometric entity is the main unit of storage in a GIS);
storing, by said database engine, a set of stored hyperrectangles in a database memory, each of said stored hyperrectangles spanning at least two dimensions sharing a common coordinate domain;
wherein each of said dimensions comprises at least
   one symbolic component; and
   one quantitative component;
receiving a plurality of data object property reads, each for an object value;
processing said data object property reads, the processing comprising:
   determining, for each of said data object property reads, a first intersection between
      said stored hyperrectangles; and
      a set of at least one hyperrectangle obtained from said data object property read for an object value; and
   responding with object values each comprising the hyperrectangles from said first intersection corresponding to each of said data object property reads
   wherein a plurality of said data object property reads each reference an object that was comprised in one of said responses;
receiving a plurality of numeric data object property reads, each for a numeric value; and
responding to said numeric property reads with a response comprising a measure of at least one interval of intervals received in response to a data object property read.

### Example 2

A method comprising:
executing, by one or more processors of a computing system, a database engine;
storing, by said database engine, a first stored space descriptor in a data store memory, said first stored space descriptor in reference to a coordinate system comprising a plurality of coordinate axes each comprising both
   a symbolic component; and
   a quantitative component
   (comprising such as for example RAM and NVRAM or some other computer memory suited for database use);
receiving a first data-update instruction to set a first property of a first data object to a first property value
   (such as for example setting a property using:
      a programming language
         motoroil.owner=acme;
      a database language

UPDATE company acme, product motoroil
SET motoroil.owner = acme
AND motoroil.name == “Motor oil”
AND acme.name == “Acme Corp”

or some other database access means);
processing said first data-update instruction comprising
   obtaining, from said first data object, a first subject space descriptor for example using endpoints comprising a GUID coordinate component and two numeric coordinate components [“asdQsSAg512GsqwWaG”,412,85.5] or a using a categorical coordinate component and numeric components [“oil”,“motoroil”,412,500] or some other way to express an interval descriptor);
   obtaining, from said first property value, a first object space descriptor; and
   determining a first update space descriptor describing a product space comprising
      the space described by said first subject space descriptor; and
      the space described by said first object space descriptor;
updating, in a first update, said data store memory to store a second stored space descriptor describing a space comprising the union of:
   the space described by said first stored space descriptor; and
   the space described by said first update space descriptor;
receiving, after said first update, a first data-retrieval instruction to read said first property of said first data object;
processing said first data-retrieval instruction, the processing comprising
   generating a query space descriptor using said first subject space descriptor;
   determining a first result space descriptor describing the intersecting space between:
      the space described by said second stored space descriptor; and
      the space described by said query space descriptor,
      the space described by said first result space descriptor comprising the intersecting space between:
      the space described by said first update space descriptor; and
      the space described by said query space descriptor; and
   responding to said first data-retrieval instruction with a value based on said first result space descriptor;
receiving, after said processing said first data-retrieval instruction, a second data-update instruction to set said first property of a second data object to a second property value;
processing said second data-update instruction comprising
   obtaining, from said second data object a second subject space descriptor, for example using endpoints comprising a GUID coordinate component and two numeric coordinate components [“asdQsSAg512GsqwWaG”,412,85.5] or a using a categorical coordinate component and numeric components [“oil”,“motoroil”,412,500] or some other way to express an interval descriptor) the space described by said second subject space descriptor different from but sharing an intersection with the space described by said first subject space descriptor;
   obtaining, from said second property value a second object space descriptor; and
   determining a second update space descriptor describing a product space comprising
      the space described by said second subject space descriptor; and
      the space described by said second object space descriptor;
updating, in a second update, said data store memory to store a third stored space descriptor describing a space comprising the union of:
   the space described by said second stored space descriptor; and
   the space described by said second update space descriptor;
receiving, after said second update, a second data-retrieval instruction to read said first property of said first data object; and
processing said second data-retrieval instruction, the processing comprising
   determining a second result space descriptor describing the intersecting space between:
      the space described by said third stored space descriptor; and
      the space described by said query space descriptor,
      the space described by said second result space descriptor comprising the intersecting space between:
      the union of:
         the space described by said first update space descriptor; and
         the space described by said second update space descriptor; and
      the space described by said query space descriptor;
   determining a second response value based on said second result space descriptor; and
   responding to said second data-retrieval instruction with a value based on said second result space descriptor.

### Example 3

The method of example 2 (or any of the above example methods) further comprising:
creating, after said first update, a following transaction comprising
   a read list comprising a read space descriptor; and
   a write list comprising
      an added space descriptor; and
      a removed space descriptor;
receiving a third data-retrieval instruction to read said first property of a third data object in the context of said following transaction;
processing, in the context of said following transaction, said third data-retrieval instruction, the processing comprising:
   obtaining, from said third data object, a third subject space descriptor, the space described by said third subject space descriptor sharing an intersection with the space described by said first subject space descriptor;
   generating a third query space descriptor using said third subject space descriptor;
   updating the read list of said following transaction to comprise said third query space descriptor;
   determining a committed result space descriptor describing the intersecting space between:
      the space described by said third stored space descriptor; and
      the space described by said third query space descriptor;
   determining a third result space descriptor describing the space described by said committed result space descriptor modified to account for uncommitted changes in said write list; and
   responding to said third data-retrieval instruction with a value based on said third result space descriptor;
receiving a third data-update instruction to set a second property of a fourth data object to a third property value in the context of said following transaction;
processing, in the context of said following transaction, said third data-update instruction, the processing comprising:
   obtaining, from said fourth data object a fourth subject space descriptor;
   obtaining, from said third property value a third object space descriptor;
   determining a third update space descriptor describing a product space comprising
      the space described by said fourth subject space descriptor; and
      the space described by said third object space descriptor; and
   updating a space descriptor of said write list to comprise said third update space descriptor;
detecting a transaction conflict by determining a non-empty intersection between
   the space described by the read space descriptor of said following transaction; and
   the space described by an updated space descriptor of a preceding transaction, said updated space descriptor selected from the group consisting of
      the added space descriptor of said preceding transaction; and
      the removed space descriptor of said preceding transaction; and
executing a transaction conflict action.

### Example 4

A computer implemented method for database runtime management, said method executed on one computing system and comprising:
maintaining, by a database engine executing on said one or more processors, in a data store memory, a global key-space comprising:
   a first axis;
   a second axis;
   a third axis; and
   a fourth axis;
maintaining, by said database engine, an object-to-key-space mapping comprising:
   a plurality of programming language objects;
   a plurality of object spatial descriptors;
   a plurality of object key-spaces in said global key-space;
   for a first programming language object of said plurality of programming language objects, a first object key-space of said plurality of object key-spaces comprising on said first axis, a first object interval descriptor; and
   storing said plurality of object spatial descriptors;
receiving, by said database engine, a first property-write instruction;
obtaining, by said database engine based on said first property-write instruction, a first property space descriptor comprising:
   on said first axis said first object interval descriptor associated with said first programming language object;
   on said second axis a first property interval descriptor associated with said first property identifier;
   on said third axis a first value interval descriptor associated with said first property value descriptor; and
   on said fourth axis a first time interval descriptor;
updating, in a first update, said data store memory to a first updated global key-space comprising combining said first property space descriptor with a previous global key-space such as for example adding or replacing propositions about said first programming language object having said first property value;
receiving, by said database engine after said first update, a first property-read instruction;
obtaining, by said database engine based on said first property-read instruction, a first query space descriptor comprising:
   on said first axis said first object interval descriptor associated with said first programming language object;
   on said second axis said first property interval descriptor associated with said first property identifier;
   on said third axis a query value interval descriptor that encompasses possible values for said first property value descriptor; and
   on said fourth axis a query time interval descriptor;
determining a first overlapping space descriptor between
   said first updated global key-space; and
   said first query space descriptor;
generating, by said database engine, a first response value based on said first overlapping space descriptor; and
responding, by said database engine, to said first property-read instruction with said first response value.

### Example 5

A method comprising:
executing, by one or more processors of a computing system, a database engine;
storing, by said database engine, a first stored space descriptor in a data store memory, said first stored space descriptor in reference to a coordinate system comprising a plurality of coordinate axes each comprising both
   a symbolic component; and
   a quantitative component;
receiving, by said database engine, a data-update instruction to set a property of a first data object to a property value, said first data object comprising a first primary key space descriptor;
obtaining an additional space descriptor based on
   said first data object;
   said property; and
   said property value;
updating said data store memory to store an updated stored space descriptor comprising a union of
   said first stored space descriptor; and
   said additional space descriptor;
receiving, by said database engine, a data-retrieval instruction to get a quantitative value from said property of a second data object, said second data object comprising a second primary key space descriptor, said second primary key space descriptor overlapping with said first primary key space descriptor;
obtaining a query space descriptor based on
   said second data object; and
   said property;
determining an overlapping space descriptor between
   said query space descriptor; and
   said updated stored space descriptor;
measuring an extent of said overlapping space descriptor along at least one of said coordinate axes to obtain a measure;
determining said quantitative value based on said measure;
generating a response comprising said quantitative value; and
responding to said data-retrieval instruction with said response.

### Example 6

The method of example 5 (or any of the above example methods), wherein said space descriptors each comprise a set of disjoint k-intervals.

### Example 7

The method of example 6 (or any of the above example methods), wherein said data store memory comprises at least one index structure storing said k-intervals of
said first stored space descriptor; and
said updated stored space descriptor,
said index structure selected from the group consisting of
B-trees;
R-trees;
kD-trees;
skip lists; and
balanced binary trees.

### Example 8

The method of example 5 (or any of the above example methods), wherein
said property value comprises a property value space descriptor;
said additional space descriptor is obtained by a product operation combining
   said first primary key space descriptor; and
   said property value space descriptor; and
said query space descriptor is obtained by a product operation combining said second primary key space descriptor with at least one other space descriptor.

### Example 9

A method comprising:
executing, by one or more processors of a computing system, a database engine;
storing, by said database engine, a stored space descriptor in a data store memory, said stored space descriptor defined by a coordinate system comprising:
   a subject axis (corresponding to the subject semantic role of a proposition, storing e.g. data objects having properties, which may themselves be property values in other propositions); and
   an object axis (corresponding to the object semantic role of a proposition, storing e.g. property values, including data objects which themselves may be subjects in other propositions),
   wherein said subject axis shares a common coordinate domain (such that an interval on the subject axis is also a valid interval on the object axis) with said object axis;
receiving (e.g. via a network message or procedure call, including internal procedure calls in said database engine), by said database engine, a first data-retrieval instruction to read a first property of a first data object, said first data object comprising a first primary key space descriptor (e.g. a 1-dimensional k-interval set); obtaining a first query space descriptor based on said first primary key space descriptor (e.g. by taking the product of the primary key space descriptor with a k-interval set describing said property, a k-interval set describing the universe of possible values, etc.);
determining a first overlapping space descriptor by finding the intersection between
   said first query space descriptor; and
   said stored space descriptor
   in reference to said first property (e.g. where said first property occupies a predicate dimension in said first query space descriptor, or where said stored space descriptor is looked up in a table mapping property identifiers a stored space per property);
obtaining the property value, which is also a data object, by projecting said first overlapping space descriptor onto said object axis to obtain a second primary key space descriptor;
generating a first response comprising said second primary key space descriptor (which may be wrapped in a data object);
responding to said first data-retrieval instruction (e.g. through a network message or return value, including returns from procedure calls internal to said database engine) with said first response;
receiving, by said database engine, a second data-retrieval instruction to read a second property of said second primary key space descriptor;
obtaining a second query space descriptor based on said second primary key space descriptor;
determining a second overlapping space descriptor between
   said second query space descriptor; and
   said stored space descriptor
   in reference to said second property;
projecting said second overlapping space descriptor onto said object axis to obtain a third primary key space descriptor;
generating a second response comprising said third primary key space descriptor; and
responding to said second data-retrieval instruction with said second response.

### Example 10

The method of example 9 (or any of the above example methods), wherein said space descriptors each comprise a set of disjoint k-intervals along said common coordinate domain.

### Example 11

The method of example 10 (or any of the above example methods), wherein said k-intervals are recursively divisible into sub-intervals (such that said sub-intervals may be used as primary keys for further data objects).

### Example 12

The method of example 10 (or any of the above example methods), wherein said data store memory comprises at least one index structure storing said k-intervals of said space descriptors, said index structure selected from the group consisting of
multi-way trees (e.g. B-trees, R-trees, kD-trees, etc.);
balanced binary trees (e.g. Red-black trees, AVL trees, etc.); and
skip lists.

### Example 13

A computer implemented method for database runtime management, said method executed on one or more processors in a computing system and comprising:
executing, by one or more processors of a computing system, a database engine;
storing, by said database engine, a first stored space descriptor in a data store memory, said first stored space descriptor in reference to a coordinate system comprising a plurality of coordinate axes wherein coordinates along at least one of said coordinate axes comprise both
   symbolic components; and
   quantitative components;
receiving, by said database engine, a first data-update instruction;
obtaining a first additional space descriptor based on said first data-update instruction;
updating said data store memory to store a second stored space descriptor comprising a union of
   said first stored space descriptor; and
   said first additional space descriptor
      (in some embodiments, updating said stored memory is done in two steps, one in the context of a transaction scope and later commit step, into a shared persistent state

```
let t = new Transaction( );
function write( ) {
  using( t, ( ) => {
    abe.likes = union(abe.likes,mary);
    ceasar.likes = ceasar;
  }
}
}
function my_commit( ) {
  t.commit( )
      }
      )
```

receiving, by said database engine, a first data-retrieval instruction; and
processing said first data-retrieval instruction, the processing comprising:
   obtaining a first query space descriptor based on said first data-retrieval instruction;
   determining an first overlapping space descriptor between
      said second stored space descriptor; and
      said first query space descriptor;
   generating a first response based on said first overlapping space descriptor; and
   responding to said first data-retrieval instruction with said first response.

### Example 14

The method of example 13 (or any of the above example methods), wherein said space descriptor are a set of at least one hyper-rectangles in one or more dimensions including
one-dimensional intervals;
two-dimensional rectangles;
three-dimensional cuboids; and
k-dimensional hyper-rectangles.

### Example 15

The method of example 14 (or any of the above example methods) or the method of example 13, wherein
said first data-update instruction comprises data expressing an asserted semantic proposition; and
said first data-retrieval instruction comprises data expressing an query semantic proposition.

### Example 16

The method of example 15 (or any of the above example methods), wherein said first stored, first additional, second stored and first query space descriptor comprise at least two dimensions in said coordinate system collectively expressing at least two semantic roles selected from the group consisting of:
a subject semantic role;
a predicate semantic role;
a object semantic role;
a time semantic role;
a believer semantic role;
a branch semantic role;
a version semantic role;
a theory semantic role; and
a universe semantic role.

### Example 17

The method of example 14 (or any of the above example methods), wherein
said first data-update instruction specifies
   a first data object;
   a first property; and
   a first updated property value; and
said obtaining a first additional space descriptor comprises obtaining a space descriptor by combining:
   a space descriptor in one or more dimensions is based on said first data object; and
   a space descriptor in one or more dimensions is based on said first updated property value.

### Example 18

The method of example 14 (or any of the above example methods), wherein
said first data-retrieval instruction specifies
   a second data object; and
   a second property; and
said obtaining a first query space descriptor comprises obtaining a space descriptor by combining:
   a space descriptor in one or more dimensions is obtained based on said second data object; and
   a space descriptor in one or more dimensions is generated based on said second property.

### Example 19

The method of example 13 (or any of the above example methods), further comprising:
creating a transaction;
receiving, by said database engine, a preceding data-retrieval instruction;
processing said preceding data-retrieval instruction, in reference to said transaction, the processing comprising:
   obtaining a preceding space descriptor based on said preceding data-retrieval instruction;
   determining a preceding overlapping space descriptor between
      said first stored space descriptor; and
      said preceding space descriptor;
   generating a preceding response based on said preceding overlapping space descriptor; and
   responding to said preceding data-retrieval instruction with said preceding response;
receiving, by said database engine, a second data-update instruction in reference to said transaction;
obtaining a second additional space descriptor based on said second data-update instruction;
determining an overlapping space descriptor between
   said preceding space descriptor; and
   said first additional space descriptor;
executing a transaction conflict action;
executing, if said overlapping space descriptor is not empty, a transaction conflict action; and
updating, if said overlapping space descriptor is empty, said database memory to store a third stored space descriptor.

### Example 20

A method comprising:
executing, by one or more processors of a computing system, a database engine;
processing, by said database engine, a first data-retrieval instruction to obtain a result space descriptor;
slicing for example, using the slice( ) function described above said result space descriptor along an axis by a slice measure to obtain a plurality of slice space descriptors; and
for each slice space descriptor in said slice space descriptors, processing, by said database engine, a data-access instruction comprising said slice space descriptor, said data-access instruction selected from the group consisting of
   a data-retrieval instruction; and
   a data-update instruction.

### Example 21

The method of example 20 (or any of the above example methods), wherein said slice measure is 1.

### Example 22

The method of example 20 (or any of the above example methods), wherein said result space descriptor comprises a set of disjoint k-intervals, wherein
each a k-interval comprises, along said axis, a minimum coordinate and a maximum coordinate
   said minimum coordinate comprising:
      a common prefix comprising at least one symbolic component; and
      a first quantitative component; and
   said maximum coordinate comprising:
      said common prefix; and
      a second quantitative component; and
the difference between
   said second quantitative component; and
   said first quantitative component
is divisible by said slice measure.

What is claimed is:

1. A method comprising:
executing, by a computing system, a database engine, said database engine storing semantic propositions using hyperrectangles as its fundamental unit of data storage;
storing, by said database engine, a set of stored hyperrectangles in a database memory, each of said stored hyperrectangles spanning at least two dimensions sharing a common coordinate domain;
wherein each of said dimensions comprises at least
one symbolic component; and
one quantitative component;
receiving a plurality of data object property reads, each for an object value;
processing said data object property reads, the processing comprising:
determining, for each of said data object property reads, a first intersection between
said stored hyperrectangles; and
a set of at least one hyperrectangle obtained from said data object property read for an object value; and
responding with object values each comprising the hyperrectangles from said first intersection corresponding to each of said data object property reads,
wherein a plurality of said data object property reads each reference an object that was comprised in one of said responses;
receiving a plurality of numeric data object property reads, each for a numeric value; and
responding to said numeric property reads with a response comprising a measure of at least one interval of intervals received in response to a data object property read.

2. A method comprising:
executing, by one or more processors of a computing system, a database engine;
storing, by said database engine, a first stored space descriptor in a data store memory, said first stored space descriptor in reference to a coordinate system comprising a plurality of coordinate axes each comprising both
a symbolic component; and
a quantitative component;
receiving a first data-update instruction to set a first property of a first data object to a first property value;
processing said first data-update instruction comprising:
obtaining, from said first data object, a first subject space descriptor;
obtaining, from said first property value, a first object space descriptor; and
determining a first update space descriptor describing a product space comprising:
the space described by said first subject space descriptor; and
the space described by said first object space descriptor;
updating, in a first update, said data store memory to store a second stored space descriptor describing a space comprising the union of:
the space described by said first stored space descriptor; and
the space described by said first update space descriptor;
receiving, after said first update, a first data-retrieval instruction to read said first property of said first data object;
processing said first data-retrieval instruction, the processing comprising:
generating a query space descriptor using said first subject space descriptor;
determining a first result space descriptor describing the intersecting space between:
the space described by said second stored space descriptor; and
the space described by said query space descriptor,
the space described by said first result space descriptor comprising the intersecting space between:
the space described by said first update space descriptor; and
the space described by said query space descriptor; and
responding to said first data-retrieval instruction with a value based on said first result space descriptor;
receiving, after said processing said first data-retrieval instruction, a second data-update instruction to set said first property of a second data object to a second property value;
processing said second data-update instruction comprising
obtaining, from said second data object a second subject space descriptor, the space described by said second subject space descriptor different from but sharing an intersection with the space described by said first subject space descriptor;
obtaining, from said second property value a second object space descriptor; and
determining a second update space descriptor describing a product space comprising:
the space described by said second subject space descriptor; and
the space described by said second object space descriptor;
updating, in a second update, said data store memory to store a third stored space descriptor describing a space comprising the union of:
the space described by said second stored space descriptor; and
the space described by said second update space descriptor;
receiving, after said second update, a second data-retrieval instruction to read said first property of said first data object; and
processing said second data-retrieval instruction, the processing comprising:
determining a second result space descriptor describing the intersecting space between:
the space described by said third stored space descriptor; and
the space described by said query space descriptor,
the space described by said second result space descriptor comprising the intersecting space between:
the union of:
the space described by said first update space descriptor; and
the space described by said second update space descriptor; and
the space described by said query space descriptor;
determining a second response value based on said second result space descriptor; and
responding to said second data-retrieval instruction with a value based on said second result space descriptor.

3. The method of claim 2, further comprising
creating, after said first update, a following transaction comprising:
a read list comprising a read space descriptor; and
a write list comprising
an added space descriptor; and
a removed space descriptor;
receiving a third data-retrieval instruction to read said first property of a third data object in the context of said following transaction;
processing, in the context of said following transaction, said third data-retrieval instruction, the processing comprising:
obtaining, from said third data object, a third subject space descriptor, the space described by said third subject space descriptor sharing an intersection with the space described by said first subject space descriptor;
generating a third query space descriptor using said third subject space descriptor;
updating the read list of said following transaction to comprise said third query space descriptor;
determining a committed result space descriptor describing the intersecting space between:
the space described by said third stored space descriptor; and
the space described by said third query space descriptor;
determining a third result space descriptor describing the space described by said committed result space descriptor modified to account for uncommitted changes in said write list; and
responding to said third data-retrieval instruction with a value based on said third result space descriptor;
receiving a third data-update instruction to set a second property of a fourth data object to a third property value in the context of said following transaction;
processing, in the context of said following transaction, said third data-update instruction, the processing comprising:
obtaining, from said fourth data object a fourth subject space descriptor;
obtaining, from said third property value a third object space descriptor;
determining a third update space descriptor describing a product space comprising:
the space described by said fourth subject space descriptor; and
the space described by said third object space descriptor; and
updating a space descriptor of said write list to comprise said third update space descriptor;
detecting a transaction conflict by determining a non-empty intersection between
the space described by the read space descriptor of said following transaction; and
the space described by an updated space descriptor of a preceding transaction, said updated space descriptor selected from the group consisting of
the added space descriptor of said preceding transaction; and
the removed space descriptor of said preceding transaction; and
executing a transaction conflict action.

4. A computer implemented method for database runtime management, said method executed on one computing system and comprising:
maintaining, by a database engine executing on said one or more processors, in a data store memory, a global key-space comprising:
a first axis;
a second axis;
a third axis; and
a fourth axis;
maintaining, by said database engine, an object-to-key-space mapping comprising:
a plurality of programming language objects;
a plurality of object spatial descriptors;
a plurality of object key-spaces in said global key-space;
for a first programming language object of said plurality of programming language objects, a first object key-space of said plurality of object key-spaces comprising on said first axis, a first object interval descriptor; and
storing said plurality of object spatial descriptors;
receiving, by said database engine, a first property-write instruction;
obtaining, by said database engine based on said first property-write instruction, a first property space descriptor comprising:
on said first axis said first object interval descriptor associated with said first programming language object;
on said second axis a first property interval descriptor associated with said first property identifier;
on said third axis a first value interval descriptor associated with said first property value descriptor; and
on said fourth axis a first time interval descriptor;
updating, in a first update, said data store memory to a first updated global key-space comprising combining said first property space descriptor with a previous global key-space;
receiving, by said database engine after said first update, a first property-read instruction;
obtaining, by said database engine based on said first property-read instruction, a first query space descriptor comprising:
on said first axis said first object interval descriptor associated with said first programming language object;
on said second axis said first property interval descriptor associated with said first property identifier;
on said third axis a query value interval descriptor that encompasses possible values for said first property value descriptor; and
on said fourth axis a query time interval descriptor;
determining a first overlapping space descriptor between
said first updated global key-space; and
said first query space descriptor;
generating, by said database engine, a first response value based on said first overlapping space descriptor; and
responding, by said database engine, to said first property-read instruction with said first response value.

5. A method comprising:
executing, by one or more processors of a computing system, a database engine;
storing, by said database engine, a first stored space descriptor in a data store memory, said first stored space descriptor in reference to a coordinate system comprising a plurality of coordinate axes each comprising both
a symbolic component; and
a quantitative component;
receiving, by said database engine, a data-update instruction to set a property of a first data object to a property value, said first data object comprising a first primary key space descriptor;
obtaining an additional space descriptor based on
said first data object;
said property; and
said property value;
updating said data store memory to store an updated stored space descriptor comprising a union of
said first stored space descriptor; and
said additional space descriptor;
receiving, by said database engine, a data-retrieval instruction to get a quantitative value from said property of a second data object, said second data object comprising a second primary key space descriptor, said second primary key space descriptor overlapping with said first primary key space descriptor;
obtaining a query space descriptor based on
said second data object; and
said property;
determining an overlapping space descriptor between
said query space descriptor; and
said updated stored space descriptor;
measuring an extent of said overlapping space descriptor along at least one of said coordinate axes to obtain a measure;
determining said quantitative value based on said measure;
generating a response comprising said quantitative value; and
responding to said data-retrieval instruction with said response.

6. The method of claim 5, wherein said space descriptors each comprise a set of disjoint k-intervals.

7. The method of claim 6, wherein said data store memory comprises at least one index structure storing said k-intervals of
said first stored space descriptor; and
said updated stored space descriptor,
said index structure selected from the group consisting of
B-trees;
R-trees;
kD-trees;
skip lists; and
balanced binary trees.

8. The method of claim 5, wherein
said property value comprises a property value space descriptor;
said additional space descriptor is obtained by a product operation combining
said first primary key space descriptor; and
said property value space descriptor; and
said query space descriptor is obtained by a product operation combining said second primary key space descriptor with at least one other space descriptor.

9. A method comprising:
executing, by one or more processors of a computing system, a database engine;
storing, by said database engine, a stored space descriptor in a data store memory, said stored space descriptor defined by a coordinate system comprising:
a subject axis; and
an object axis
wherein said subject axis shares a common coordinate domain with said object axis;
receiving, by said database engine, a first data-retrieval instruction to read a first property of a first data object, said first data object comprising a first primary key space descriptor;
obtaining a first query space descriptor based on said first primary key space descriptor;
determining a first overlapping space descriptor between
said first query space descriptor; and
said stored space descriptor
in reference to said first property;
projecting said first overlapping space descriptor onto said object axis to obtain a second primary key space descriptor;
generating a first response comprising said second primary key space descriptor;
responding to said first data-retrieval instruction with said first response;
receiving, by said database engine, a second data-retrieval instruction to read a second property of said second primary key space descriptor;
obtaining a second query space descriptor based on said second primary key space descriptor;
determining a second overlapping space descriptor between
said second query space descriptor; and
said stored space descriptor
in reference to said second property;
projecting said second overlapping space descriptor onto said object axis to obtain a third primary key space descriptor;
generating a second response comprising said third primary key space descriptor; and
responding to said second data-retrieval instruction with said second response.

10. The method of claim 9, wherein said space descriptors each comprise a set of disjoint k-intervals along said common coordinate domain.

11. The method of claim 10, wherein said k-intervals are recursively divisible into sub-intervals.

12. The method of claim 10, wherein said data store memory comprises at least one index structure storing said k-intervals of said space descriptors, said index structure selected from the group consisting of:
multi-way trees;
balanced binary trees; and
skip lists.

13. A computer implemented method for database runtime management, said method executed on one or more processors in a computing system and comprising:
executing, by one or more processors of a computing system, a database engine;
storing, by said database engine, a first stored space descriptor in a data store memory, said first stored space descriptor in reference to a coordinate system comprising a plurality of coordinate axes wherein coordinates along at least one of said coordinate axes comprise both
symbolic components; and
quantitative components;
receiving, by said database engine, a first data-update instruction;
obtaining a first additional space descriptor based on said first data-update instruction;
updating said data store memory to store a second stored space descriptor comprising a union of
said first stored space descriptor; and
said first additional space descriptor;
receiving, by said database engine, a first data-retrieval instruction; and
processing said first data-retrieval instruction, the processing comprising:
obtaining a first query space descriptor based on said first data-retrieval instruction;
determining a first overlapping space descriptor between
said second stored space descriptor; and
said first query space descriptor;
generating a first response based on said first overlapping space descriptor; and
responding to said first data-retrieval instruction with said first response.

14. The method of claim 13 wherein said space descriptor is a set of at least one hyper-rectangle in one or more dimensions including
one-dimensional intervals;
two-dimensional rectangles;
three-dimensional cuboids; and
k-dimensional hyper-rectangles.

15. The method of claim 14, wherein
said first data-update instruction comprises data expressing an asserted semantic proposition; and
said first data-retrieval instruction comprises data expressing a query semantic proposition.

16. The method of claim 15, wherein said first stored, first additional, second stored and first query space descriptor comprise at least two dimensions in said coordinate system collectively expressing at least two semantic roles selected from the group consisting of:
a subject semantic role;
a predicate semantic role;
an object semantic role;
a time semantic role;
a believer semantic role;
a branch semantic role;
a version semantic role;
a theory semantic role; and
a universe semantic role.

17. The method of claim 14, wherein
said first data-update instruction specifies
a first data object;
a first property; and
a first updated property value; and
said obtaining a first additional space descriptor comprises obtaining a space descriptor by combining:
a space descriptor in one or more dimensions is based on said first data object; and
a space descriptor in one or more dimensions is based on said first updated property value.

18. The method of claim 14, wherein
said first data-retrieval instruction specifies
a second data object; and
a second property; and
said obtaining a first query space descriptor comprises obtaining a space descriptor by combining:
a space descriptor in one or more dimensions is obtained based on said second data object; and
a space descriptor in one or more dimensions is generated based on said second property.

19. The method of claim 13, further comprising
creating a transaction;
receiving, by said database engine, a preceding data-retrieval instruction;
processing said preceding data-retrieval instruction, in reference to said transaction, the processing comprising
obtaining a preceding space descriptor based on said preceding data-retrieval instruction;
determining a preceding overlapping space descriptor between
said first stored space descriptor; and
said preceding space descriptor;
generating a preceding response based on said preceding overlapping space descriptor; and
responding to said preceding data-retrieval instruction with said preceding response;
receiving, by said database engine, a second data-update instruction in reference to said transaction;
obtaining a second additional space descriptor based on said second data-update instruction;
detecting a non empty overlapping space descriptor between
said preceding space descriptor; and
said first additional space descriptor;
executing a transaction conflict action; and
executing a transaction conflict action.

20. A method comprising:
executing, by one or more processors of a computing system, a database engine;
processing, by said database engine, a first data-retrieval instruction to obtain a result space descriptor;
slicing said result space descriptor along an axis by a slice measure to obtain a plurality of slice space descriptors; and
for each slice space descriptor in said slice space descriptors, processing, by said database engine, a data-access instruction comprising said slice space descriptor, said data-access instruction selected from the group consisting of
a data-retrieval instruction; and
a data-update instruction.

21. The method of claim 20, wherein said slice measure is 1.

22. The method of claim 20, wherein said result space descriptor comprises a set of disjoint k-intervals wherein
each a k-interval comprises, along said axis, a minimum coordinate and a maximum coordinate,
said minimum coordinate comprising:
a common prefix comprising at least one symbolic component; and
a first quantitative component; and
said maximum coordinate comprising:
said common prefix; and
a second quantitative component; and
the difference between
said second quantitative component; and
said first quantitative component
is divisible by said slice measure.
